(19) United States
(12) Patent Application Publication
(10) Pub. No.: US 2008/0109306 A1
(43) Pub. Date: May 8, 2008

(54) MEDIA MARKETPLACES

(76) Inventors: Robert Joseph Maigret, Los Angeles, CA (US); Kevin Cosgrave Wells, Pacific Palisades, CA (US)

Correspondence Address: STRATEGIC PATENTS P.C.., C/O PORTFOLIOIP, P.O. BOX 52050, MINNEAPOLIS, MN, 55402, US

(21) Appl. No.: 11/838,860

(22) Filed: Aug. 14, 2007

Related U.S. Application Data
(63) Continuation-in-part of application No. 11/670,713, filed on Feb. 2, 2007.
Application No. 11/670,713 is a continuation-in-part of application No. 11/424,484, filed on Jun. 15, 2006.
(60) Provisional application No. 60/690,634, filed on Jun. 15, 2005.
(60) Provisional application No. 60/761,555, filed on Jan. 23, 2006.
(60) Provisional application No. 60/775,644, filed on Feb. 22, 2006.
(60) Provisional application No. 60/822,483, filed on Aug. 15, 2006.

(51) Int. Cl. G06Q 30/00; G06Q 20/00

(52) U.S. Cl. 705/14; 705/39

(57) ABSTRACT

Aspects of the present invention include methods and systems that involve enabling content item generators to present content items for association of advertisements; enabling an advertiser to request association of an advertisement with at least one of the presented content items; and associating the content items with advertising, tracking, and user interaction instructions so that and upon a subsequent user interaction with the content advertising will be displayed and an action is automatically taken to facilitate payment of a share of revenue for the associated advertisement to an account of the content item generator.

### RELATED APPLICATIONS

This application is a continuation-in-part of the following commonly owned U.S. patent applications, each of which is hereby incorporated by reference in its entirety:

U.S. patent application Ser. No. 11/670,713 filed on Feb. 2, 2007; and U.S. patent application Ser. No. 11/424,484 filed on Jun. 15, 2006 which claims the benefit of the following commonly-owned U.S. Provisional Applications, U.S. Provisional Application 60/690,634 filed on Jun. 15, 2005; U.S. Provisional Application 60/761,555 filed Jan. 23, 2006; and U.S. Provisional Application 60/775,644 filed on Feb. 22, 2006, each of which is hereby incorporated by reference in its entirety.

This application also claims the benefit of the following commonly-owned U.S. Provisional Application, which is hereby incorporated by reference in its entirety:

U.S. Provisional App. No. 60/822,483, filed on Aug. 15, 2006.

### BACKGROUND

1. Field

This disclosure relates to the field of media content distribution, and more particularly to improved methods of distributing media content with associated advertisements.

2. Background

There has been a significant surge in the Internet distribution of video content. Creators of video content record it with their phones, web cams, digital recorders and the like and then publish the content to a website or transmit it through email, instant messaging, or through their phone mail system. Once the creator distributes the video, it can be redistributed over and over again by third parties without any attribution or compensation to the creator. There exists a need to improve the distribution system for media content.

### SUMMARY

An aspect of the present invention relates to publishing and distributing media segments in an online marketplace where creators meet advertisers in order to associate advertisements with the media segments. Compensation may follow the association of an advertisement with a media segment to motivate the creator to allow for the distribution of the media, and distributors to distribute the media. In embodiments, a bidding platform may be used to facilitate various advertiser bids for placement of its advertisement with certain media segments. An advertiser's bid may include information relating to a media segment, segment category, media segment rating, or other parameter associated with the media segment. Various instructions may be associated with media segment's distribution such that the various instructions remain associated with the media through distribution (e.g. downloading, emailing, instant messaging, syndication, etc.). The associated instructions may feed information back to an activity monitoring facility and the monitored activity may result in revenue and/or revenue sharing. Likewise, the instructions may be associated with the media segment to facilitate the dynamic association of advertisements with the media segment. Such instructions may include a dynamic playlist or other systems of associating content, advertisements, user actions, and tracking actions. The dynamic association may be created at the time of the request based on parameters associated with the media file, generator, distributor, advertiser, viewer and the like. The instructions may also direct the “player” as to how and when to display the advertisement relative to the content. In embodiments, upon request, the video distribution system determines these various combinations and transmits them through instructions. The video, and information, may be transmitted in an encrypted XML or other file format file. For example, a persistent tag may be used to track the location of the media segment to facilitate the attachment of advertisements throughout distribution.

Another aspect of the invention relates to a business method that utilizes a syndication enabling platform such as RSS or ATOM to store, manage, retrieve, label, host, and use persistent revenue tagged media segments. The syndicated method of distributing the persistent revenue tagged media segments may be used to facilitate distribution from publishers, to subscribers, or to others that interact with the media through syndicated techniques. Such methods may include a revenue generating and distribution system for the calculation and payment of affiliate revenue to, for example, a search engine based on the inclusion of the media segment in the results of a search conducted with said search engine. Another embodiment of the invention enables syndication clients to place a media segment in a page media unit with an attached revenue scheme, such as commission revenue, or to place in-page media unit segments onto an arbitrage site to capture enhanced revenues. Other aspects of the invention relate to business methods where the distribution occurs through downloading from a facilitator's site, transferring a media segment to an affiliate and downloading from said affiliate's site, email, instant messaging, and/or systems for providing voice over IP such as SKYPE.

In embodiments, a tagged media segment is transmitted through syndication wherein the media segment is published and collected through a syndication platform while preserving the nature of the revenue tag and the dynamic advertising tag. In embodiments, the revenue tag and the dynamic advertising tag may be the same tag or they may be different tags.

In embodiments, the tags or instructions may be physically embedded in the file containing the video/media/content. In embodiments, the tags or instructions may be sent in a separate file that is referenced by the video file. In embodiments, the tag or instructions are created dynamically when the video is requested. The tag or instructions may include information pertaining to how to display advertising, what to do when a user takes an action related to such advertising (such as clicking for example) and how to track such advertising through the distributor, the advertiser, or third party systems.

In embodiments, the communication may be secured by encryption or otherwise communicated. In embodiments, the associations and instructions may be determined dynamically (i.e. generally at the time a user requests video/content/media based on a number of factors (described further below). These associations and instructions may then transmitted to player/viewer software, which then executes them autonomously and/or in response to user actions. The player/viewer software may be a component integrated into another 3^{rd} party player/viewer. This component plays an integral role in delivery of the overall system.

In embodiments, the revenue sharing/split occurs based on configurable parameters in the back-end based on tracking actions at a server and such parameters may not be included in the instructions or tags.

Another aspect of the invention relates to a business method for the utilization of the tagged (e.g. revenue tagged, advertisement tagged) media segments by search engines. In embodiments, a search engine may access and distribute tagged media segments by using a distribution platform such as syndication to upload and store media segment content. In other embodiments, the search engine may access tagged media segments from an index of such media segments. For example, a user may search for a media segment using keyword searching and the search engine may retrieve tagged media segments from the index and produce the tagged media segments in a search results list. The tags may be persistent, enabling search engines to index the tagged media segments, distribute media segments in response to search inquiries and/or search variables and be compensated through the use of the revenue module based upon the distribution of the media segment. In other embodiments, the search engine may retrieve media segments and then attach such tags to the media segments prior to delivering such media segments to the end user.

Another aspect of the invention enables the uploading of media segments by end users to create and/or participate in social networks. The media segments can be accessed by clients or end users. A syndication platform facilitator may interact with the syndication platform through a syndication facilitator user interface. The syndication facilitator user interface may provide a facilitator with options relating to the media segment and other parameters within the syndication platform. For example, it may be able to establish rules, compensation split requirements, status, placement requirements, establish compensation models and the like.

In embodiments, a system uses a distribution data feed such as syndication data feed or instant messaging software to upload content such as media segments. Clients are able to affiliate themselves with the system with access to all of the content inside the payload of the syndication platform such as RSS or ATOM or as transmitted by the instant messaging software. Customers of the clients are able to locate content by conducting an advanced search including, for example, inclusions, exclusions, and Boolean variables, on the syndication system for media segments. Media segments are programmable by their creator/owner/publisher with regard to such factors as visual elements and/or content targeting. Searches may return content by category, tags, author, performer, play list, age rating and/or other factors.

Another aspect of the present invention is a business method for a web-based marketplace where self-publishing media creators meet advertisers in order to associate advertisements with media segments. Another aspect of the present invention relates to a technology providing tags within the media segments that allow the media segments to be traced through a series of communications and/or transactions. Another aspect of the present invention relates to hyperlinked media tags enabling a digital rights management revenue model, such as to facilitate revenue sharing to media publishers when advertisements that are associated with their videos are viewed by end users. Another aspect of the present invention relates to dynamically inserting different advertisements in real time into media segments as the segments travel through a series of communications and/or transactions. Another aspect of the present invention relates to a method for dynamically inserting different advertisements in real time into media segments. In embodiments, the method may involve tracking of events leading to revenue generation and/or allocation. Another aspect of the present invention relates to using an adaptive learning algorithm or collaborative filtering algorithm to select advertisements for dynamic insertion in real time into media segments as they travel through a series of communications and/or transactions. Another aspect of the present invention relates to facilitating, through a network enabled platform, the publishing and distribution of online media content and providing incentives, such as economic incentives, to content providers, publishers, distributors and advertisers to encourage such publishing and distribution, without limiting the accessibility of such content to users. In embodiments, an author of video content who wishes to publish such content uses a media distribution platform to associate the content with advertisements through a facilitated, dynamic bidding process.

Another aspect of the present invention relates to publishing and distributing media segments in an online marketplace where creators can obtain information about the performance of an advertiser or advertisement in order to select specific advertisements or advertisements created by certain advertisers to associate with the media segments the creator creates and/or publishes.

Another aspect relates to the collection of data for use in the creation of a metric; the metric being presented to advertisers to enable the advertisers to select placements for advertisements across the fields of said metric. The metric may be displayed through the use of a dashboard or other user interface.

In embodiments, creators and/or publishers of media segment would be able to review the performance of each media segment, i.e., how and where the advertisement is associated with a media segment, and to alter future performances of said media segment. The review may be conducted through the use of a dashboard or other user interface.

Another aspect relates to the use of a display component such as a dashboard or other such user interface.

Another aspect of the invention relates to the determination and insertion of meta-information such as metadata and/or keywords.

Another aspect of the invention relates to the collection of data relating to the demographics for each party utilizing the system such as advertisers, users, affiliates, and or search engines.

Another aspect relates to the prevention and/or detection of fraudulent use of the system and/or uses of the system that may constitute acts of infringement of intellectual property rights.

An aspect of the invention relates to equipment, such as a video recorder/player, and/or software which enables the direct upload of media segments to a media segment database. In embodiments, software contained in the hardware would insert the appropriate tags and identifiers. In embodiments, software would enable editing of media segments and direct upload of the edited media segment to the media server.

Another aspect of the invention relates to the ability of an affiliate to directly upload media segment to the media segment server. In embodiments, a media segment will be tagged with a unique identifier identifying the affiliate uploading said media segments. Media segments may be aggregated for uploading by an affiliate.

An aspect of the invention relates to the use of an expiration based subscription.

Another aspect relates to the administration and monetization of methods of use of the collection of media segments. In embodiments, the media segments uploaded by creators and/or publishers are entered into a media segment database. Contents of the database may be licensed for use by third parties for distribution through offline channels such as cell phones, pod casts, cable television, satellite television, and/or broadcast television. In embodiments, content could be licensed for reproduction on DVDs, videotapes and/or other formats for sale by the licensee. In embodiments, a creator and/or publisher would be able to opt-in to any licensing program.

Another aspect of the invention relates to the ability of the system to notify parties, such as users or advertisers of additional content. In embodiments, parties would opt-in to receive notifications, such as emails, from the system of media segments that comply with the rules 124 established by said party. In embodiments, a party could elect to receive such media segment directly through the use of a link, feed, pod cast, syndication platform, and/or video.

Systems and methods of the present invention may relate to enabling content item generators to present content items for association of advertisements; enabling an advertiser to request association of an advertisement with at least one of the presented content items; and tagging the content items so that upon a subsequent user interaction with a content item that has an associated advertisement, an action may be automatically taken to facilitate payment of a share of revenue for the associated advertisement to an account of the content item generator. The content may encompass video content, audio content, audiovisual content, interactive content, a webpage, and so forth. The content may be suitable for viewing on the worldwide web. In embodiments, a plurality of advertisements may be dynamically linked to a content item, thereby presenting different advertisements in the course of different user interactions with the content items. The subsequent user interaction may include sending the content item to another user, viewing a portion of the content item, downloading the content item, viewing a portion of the advertisement, viewing all of the advertisement, and so forth. The automatic action to facility payment of a share of revenue may persist through a plurality of user interactions with the content item, through user interactions with the content item at a plurality of domains at which a user may interaction with the content item, and so on.

An interface may be provided or included whereby advertisers may bid for association of advertisements with content items. In embodiments, the interface may allow an advertiser to select a category of content item. In embodiments, the interface may encompass a bidding interface that presents a price for associating with a content item and the price reflects the extent of past user interactions with the content item.

Systems and methods of the present invention may relate to providing an advertisement revenue sharing tag for a content item that is generated by a content item generator and that has an associated advertisement, wherein upon a user interaction with a content item, an action may be automatically taken to facility payment of a share of revenue for the associated advertisement to an account of the content item generator. The content item may encompass video content, audio content, audiovisual content, interactive content, a webpage, and so forth. The content item may be suitable for viewing on the worldwide web. A plurality of advertisements may be dynamically linked to a content item, thereby presenting different advertisements in the course of different user interactions with the content item. The subsequent user interaction may encompass sending the content item to another user, viewing a portion of the content item, downloading the content item, viewing a portion of the advertisement, viewing all of the advertisement, clicking on the advertisement, and so on. The automatic action to facility payment of a share of revenue may persist through a plurality of user interactions with the content item, through user interactions with the content item at a plurality of domains at which a user may interact with the content item, and so forth.

An interface may be provided or included whereby advertisers may bid for association of advertisements with content items. The interface may allow an advertiser to select a category of content item. The interface may encompass a bidding interface that presents a price for associating with a content item and the price reflects the extent of past user interactions with the content item.

A Flash media serving architecture may comprise a number of servers, a number of operational data files, a web browser containing a Flash player, and a number of communications between the servers and the web browser and/or the Flash player. The operational data files may encompass a Flash player SWF (i.e. a Macromedia Flash file in the SWF file format) in association with a JavaScript file and one or more skin files. One of the servers may be a media server that contains and/or serves a plurality of video files.

A Flash media serving process may comprise the following steps: providing JavaScript; receiving communication from a Flash player; providing an XML file to the Flash player; and so on.

The JavaScript may encompass a process comprising the following steps: embedding a Flash player in a web browser; activating the Flash player with information about media; and so on. The media may be associated with an end-user request.

The XML file may encompass a URL reference to a video file, a URL reference to one or more reference to SWF advertisements, and one or more tracking URLs. Any and all of the URLs may be associated with the media server; may be subject to authentication at the media server; may be valid only when provided to the media server from a particular IP address; may be valid for a limited time only; and so on.

These and other systems, methods, objects, features, and advantages of the present invention will be apparent to those skilled in the art from the following detailed description of the preferred embodiment and the drawings.

### BRIEF DESCRIPTION OF THE FIGURES

The invention and the following detailed description of certain embodiments thereof may be understood by reference to the following figures:

FIG. 1A illustrates a media platform.

FIG. 1B illustrates a media platform.

FIG. 2 illustrates a media owner's perspective on the media platform.

FIG. 3 illustrates an affiliate user interface.

FIG. 4 depicts a customer support screen of a facilitator user interface.

FIG. 4A depicts a content owner screen of a facilitator user interface.

FIG. 4B depicts an affiliate screen of a facilitator user interface.

FIG. 4C depicts an advertiser screen of a facilitator user interface.

FIG. 4D depicts a revenue model screen of a facilitator user interface.

FIG. 4E depicts a bid screen of a facilitator user interface.

FIG. 4F depicts a system involving a facilitator user interface.

FIG. 5 depicts a web browser view of a user interface.

FIG. 6 depicts a visualization map of advertising market data.

FIG. 7 depicts a detailed view of the visualization map of FIG. 6.

FIG. 8 depicts a tagged media segment type visualization map.

FIG. 9 depicts a detailed view of the visualization map of FIG. 8.

FIG. 10 depicts a tagged media segment nature of content visualization map.

FIG. 11 depicts a detailed view of the visualization map of FIG. 10.

FIG. 12 depicts an audience demographic visualization map.

FIG. 13 depicts a detailed view of the visualization map of FIG. 13.

FIG. 14 depicts a completed template for an automatically generated advertisement.

FIG. 15A is one screenshot of a sequence of screenshots illustrating an example of an automatically created advertisement.

FIG. 15B is another screenshot of a sequence of screenshots illustrating an example of an automatically created advertisement.

FIG. 15C is yet another screenshot of a sequence of screenshots illustrating an example of an automatically created advertisement.

FIG. 15D is still another screenshot of a sequence of screenshots illustrating an example of an automatically created advertisement.

FIG. 16 depicts a self-published webpage.

FIG. 17 depicts a logical view of super distribution.

FIG. 18 is a block diagram depicting logical components and a logical flow, all of which are of systems and methods for providing Flash media.

FIG. 19 is a logical flow diagram depicting a process embodied in JavaScript.

FIG. 20 is a logical block diagram depicting an XML file.

FIG. 21 illustrates a general instruction file structure.

### DESCRIPTION OF PREFERRED EMBODIMENT(S)

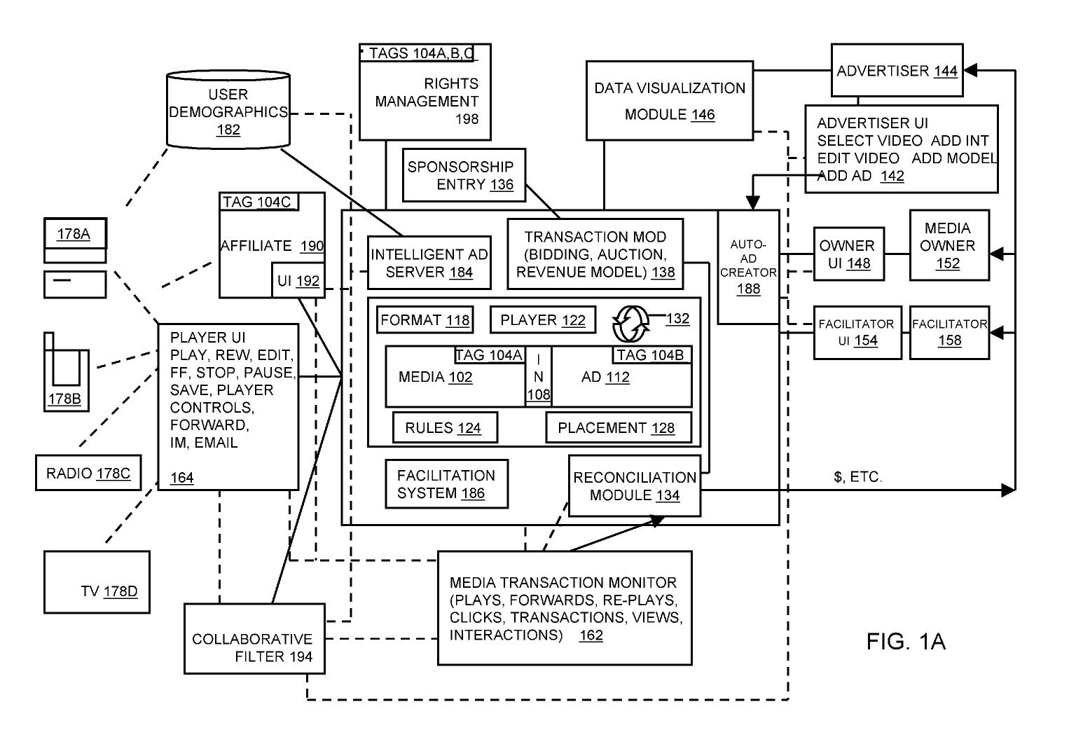

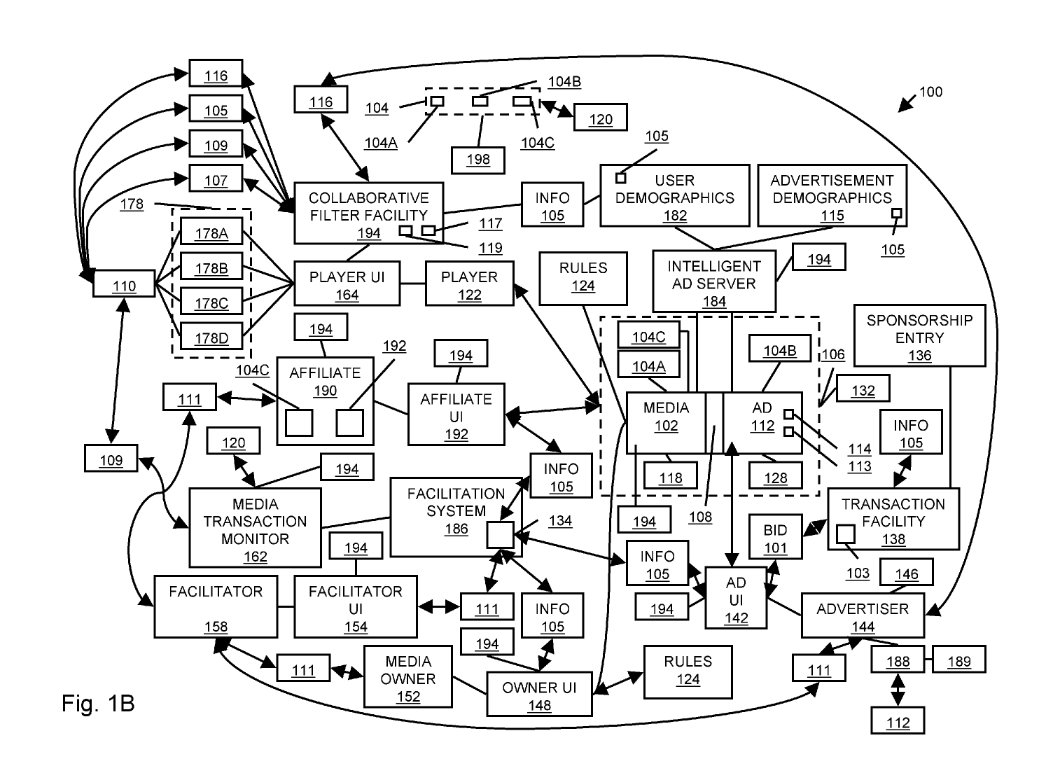

FIGS. 1A and 1B illustrate various embodiments of a media platform 100 according to aspects of the present invention. FIG. 1B illustrates a more detailed embodiment relating to types of information that may be provided from or received by certain facilities, actions, associations and other interactions that may be associated with various embodiments. Referring to the embodiments illustrated in FIGS. 1A and 1B, a media owner 152 interacts with an owner user interface 148 to deliver a media segment 102 to the media platform 100. In the media platform 100 the media segment 102 may be formatted to a preferred format 118 and a media segment tag 104A may be attached to the media segment 102. An advertiser 144 may interact with the media platform 100 through an advertiser user interface 142 to provide an advertisement 112 and to submit a bid 101 through a transaction facility 138 to associate the advertisement 112 with the media segment 102. In the media platform 100 an advertisement tag 104B may be attached to the advertisement 112. The transaction facility 138 may include a dynamic bidding and award process 103. The advertiser may provide information 105, via the advertiser user interface 142, relating to a bid 101 or placement of an advertisement 112. For example and without limitation, this information 105 may be provided through the advertiser user interface 142. The media owner 152 may establish rules 124 through the owner user interface 148. The rules 124, for example and without limitation, may relate to restrictions against certain types of advertisements 112, such as adult advertisements 112, tobacco advertisements 112, advertisements 112 from a particular corporation, advertisements 112 associated with a particular cause, and other such advertisements. The media segment 102 may be associated with one or more advertisements 112. In embodiments, the format 118 and/or rules 124 may result in one or more advertisements 112 being performed in one or more ways. Alternatively or additionally, the advertisement 112 may be associated with a placement 128, which may specify, instruct, suggest, or otherwise influence the way in which the advertisement 112 is performed. In any case, the performance of the advertisement 112 may encompass playing and/or displaying the advertisement 112. The placement 128 may be provided by the advertiser 144, the media owner 152, and/or may be automatically generated by the platform 100.

An advertisement server 184 may facilitate manual and/or automatic selection of advertisements 112 according to the information 105, the rules 124, or any and all other information that may be associated with a user 110, an advertiser 144, an owner 152, a media segment 102, an advertisement 112, a bid 101, and so on. In embodiments, the information 105 may additionally or alternatively encompass user demographics 182. In embodiments, the information 105 may be encoded in a media segment tag 104A, an ad tag 104B, an affiliate tag 104C, or any other tag or metadata tag. In embodiments, the media tag 104A may comprise information relating to the genre of the media segment 102.

A deliverable media segment 106 may comprise a media segment 102, an interstitial segment 108, and an advertisement 112. The media segment may be associated with a media segment tag 104A and a format 118. The advertisement 112 may be associated with an advertisement tag 104B and a placement 128. In embodiments, the format 118 may apply to the media 102, the interstitial segment 108, and the advertisement 112.

The deliverable media segment 106 may be retrieved by the affiliate 190 via the affiliate user interface 192. The media segment 102 combined with a media tracking tag 104A and an advertisement 112, itself combined with an advertisement tracking tag 104B, may be distributed by an affiliate 190, such as a publisher, itself associated with an affiliate tracking tag 104C, retrieving the media segment 102 through an affiliate user interface 192. The affiliate user interface 192 may include a display component such as a dashboard or other such graphical user interface.

Users 110 of the media segment 102 may view, listen to, read, interact with, or otherwise experience the deliverable media segment 106 and/or any of its constituent media segments 102, 108, 112 through a player client or device 178 which may encompass a computer 178A, a wireless device (i.e. a cell phone) 178B, a radio (i.e. an Internet radio) 178C, a television 178D, or the like, any and all of which may provide a player user interface 164. The user 110 may receive recommendations 107 from a collaborative filter facility 194. The collaborative filter 194 may make recommendations 107 based on highly concurrent data, which may encompass preferences, likes, or dislikes of the user 110 and any number of other users 110.

An element of the media platform 100 may provide the deliverable media segment 106 to a user 110 via a player client or device 178. A user 110 may respond to an advertisement 112. The user's 110 response 109 to the advertisement 112 may be captured by a media transaction monitor 162 and reported to a facilitation system 186 containing a reconciliation module 134. The reconciliation module 134 may reconcile information provided by the media transaction monitor 162 with information 105 provided by the advertiser 144 (e.g. via the advertiser user interface 142), the owner 152 (e.g. via the owner user interface 148), and/or the affiliate 190 (e.g. via the affiliate user interface 192) and report the results 111 of the reconciliation to a facilitator 158 through a facilitator user interface 154. The facilitator 158 may further distribute the results of the reconciliation to the media owner 152, the advertiser 144, and/or the affiliate 190

In embodiments, the facilitator 158, the media owner 152, the affiliate 190, or any combination of the foregoing may receive remuneration from the advertiser 144, wherein the remuneration may be associated with the bid 101 and a feature of the reconciliation module 134 that relates to processing a bid 101, receiving payment for a winning bid 101, and dispersing the payment. In embodiments, the media 102, advertisement 112, and tags 104A, 104B, 104C may be monitored and/or protected through a rights management facility 198.

The media platform 100 may include a media segment 102. The media segment 102 may be a form of media that is downloadable, viewable, audible, streaming, progressively viewed, progressively listened, or otherwise made available for viewing, hearing, reading, manipulating, and so on. In embodiments, the media segment 102 may be a video segment, movie, armature movie, cell phone recorded movie, digitally recorded image, digitally recorded video, audio segment, multimedia segment, picture, text, image, publication, blog, book, magazine, article, news article, scientific article, instruction, notification or other media adapted for viewing, listening, reading or otherwise interacting with. For example, the media segment 102 may be a video segment that was recorded by a digital video recorder (e.g. a video camera, digital video recorder). As another example, the media segment may be a digitally recorded sound file (e.g. music, personal recording). As another example, the media segment may be a publication (e.g. a book, blog posting, web posting, article, opinion). A media segment may be originally recorded, created or otherwise made available by an artist, author, corporation or other entity.

The media segment 102 may be formatted in a number of ways. The format may be the pattern into which data making up the media segment 102 are systematically arranged for use on a computer. A file format may be the specific design of how information is organized in the file, and it may be so arranged to be viewed through particular media players. In embodiments, the media segment 102 may be formatted in a streaming format, progressively viewed format, progressive download format, download format, or other such data format. For example, the media segment 102 may be formatted to stream into a user's client device to be viewed or listened to during the process of downloading. Or, as another example, the file may be progressively downloaded to a client device and the client device may play segments of the media segment 102 as the download continues. As another example, the media segment 102 may be downloaded to the client and the client may be able to interact or play the media segment 102 in its downloaded form.

In embodiments, the media segment 102 may be formatted in a streaming format. Streaming media may be media that is consumed (e.g. read, heard, viewed) while it is being delivered. Although it is generally used in the context of certain content types (e.g. “streaming audio”, “streaming video”, etc), streaming is more a property of the delivery systems employed to distribute that content than a type of content. The “streaming” distinction is usually applied to media that are distributed over computer networks; most other delivery systems are either inherently streaming (e.g. radio, television) or inherently non-streaming (e.g. physical books, video cassettes, audio CDs). The word “stream” may also be used as a verb, meaning “to deliver streaming media.” In embodiments, the media or multimedia content may be large, such that media storage and transmission costs are significant; to offset this somewhat, the media may be compressed for both storage and streaming. In embodiments, a media stream can be on-demand or live. On-demand streams are stored on a server for a period of time, and are available to be transmitted at a user's request. Live streams may only be available at one or more particular times, as in a video stream of a live or rebroadcast sporting event or an audio stream of a live or rebroadcast concert. In embodiments, the media may be formatted for a particular media player. For example, the format may be compatible with a Window's Media Player, RealPlayer, QuickTime, MP3 player, .wav player, MPEG player or other such media player.

In embodiments, the media segment 102 may be associated with rules 124. The rules may be rules that are imposed by an author, owner, publisher, provider, viewer, end user or other person or entity associated with the media segment. In embodiments, the rules 124 restrict the types of advertisements 112 and/or interstitial segments 108 that may be associated with the media segment 102. For example, an owner of the media segment 102 may not want certain advertisers 144, such as adult content advertisers, tobacco advertisers, gun advertisers or other advertisers, or certain advertisement segments 112 associated with the media segment. In embodiments, the rules 124 may relate to how, when, where, and/or to whom the media segment 102 may be provided. For example, the media segment 102 may be intended for intranet distribution and therefore restricted from Internet distribution. As another example, the media segment 102 may contain adult content and the rules 124 may restrict the distribution of the media segment 102 to users under an appropriate age. In embodiments, the rules 124 may relate to control over distribution of the media segment 102. For example, the distribution of the media segment 102 may be regulated by statute (e.g. adult content, content containing violence or otherwise regulated material) and the rules 124 may restrict the media segment from being otherwise distributed. In embodiments, the rules 124 may be established by a user 110 who does or does not want certain types of advertisements 112 and/or interstitial segments 108

The media platform 100 may include an advertisement 112. The advertisement 112 may be presented as an image, moving image, cartoon, drawing, video, movie, text, multimedia segment, audio segment, hyperlink or other form of advertisement. The advertisement 112 may be associated with an advertiser 144. For example, the advertisement 112 may represent a product or service provided by an advertiser 144. In embodiments, the advertisement 112 may be associated with a self advertiser (e.g. an individual person). In embodiments the advertiser 144 may be a corporation. In embodiments, the advertisement 112 may be an item that promotes goods, services, companies and/or ideas. In embodiments, the advertisement 112 may be associated with a sponsor. In embodiments, the sponsor may be identified. In embodiments, the advertisement may be a solicitation. The solicitation may be a process used to communicate procurement requirements and/or to request responses from interested vendors. In embodiments, a solicitation may be a request for bid and request for proposal. In embodiments, the advertisement 112 may be targeted towards certain types of individuals, corporations or other entities. The advertisement 112 may be interactive. In embodiments, the advertisement 112 may include a click-through facility, such as a hyperlink. In embodiments, the advertisement 112 may include a transaction facility 113, such as one or more of an electronic shopping cart, electronic payment facility, identity verification facility, transaction review facility, transaction confirmation facility, and the like. In embodiments, the advertisement 112 may include a query facility 114, such as and without limitation a keyword search facility. For example, the advertisement 112 may enable searching for associated goods and/or services. In embodiments, the advertisement 112 may be directed at a particular geographic region, metropolitan statistical area, zip code, census tract, county, state, country, and so on.

In embodiments, the advertisement 112 may be associated with an advertisement server 184. The advertisement server 184 may be an organization, hardware, and/or software that formats, manipulates and/or delivers advertisements 144, which may comprise advertising banners, text advertisements, video advertisements, audio advertisements, or other forms of advertisements. For example and without limitation, the advertisement server 184 may be responsible for selecting an appropriate advertisement 112 to serve in a given situation. For example, the advertisement server 184 may select an advertisement 112 based on a media segment rule 124. The advertisement server 184 may also perform a variety of other administrative tasks including, without limitation, counting of impressions, clicks, or other interactions that a user 110 may have with an advertisement 112, and report generation. In embodiments, the advertisement server 184 may be a program or a type of software or hardware server that manages and/or maintains advertisements 112 for deployment as appropriate, needed, or requested.

An advertisement server 184 may be a sophisticated computer program that is capable of keeping track of interactions, deployments, reporting, or other things associated with the delivery and performance of advertisements 112. In embodiments, this program may select and/or deliver advertisements 112 targeted towards certain types of individuals, corporations, or other users 110. In embodiments, this program may provide the ability to rotate, change the size, change the shape, change the color, change the layout, or otherwise manipulate the advertisement 112. In embodiments, the advertisement server 184 software may deploy the advertisements 112 in varying formats or in varying order such that a viewer or user 110 of the advertisement 112 will not see the same advertisement 112 every time she comes back to the same page. In embodiments, the technology used to format, manipulate, deliver and place advertisements 112 may be operated by a third party (e.g. such as an advertising agency). In embodiments, administrative tasks performed using the advertisement server 184 may be directed at ensuring statistical validity, corporate consistency, or any and all other desirable properties of information or advertising campaigns that may be associated with the advertisement server 184.

In embodiments, the advertisement server 184 may be associated with a user demographics database 182. The user demographics database 182 may include information relating to users 110 and their particular behavior characteristics. For example, the user demographic database 182 may include user information 105 relating to a general population or targeted population. This information 105 may be associated with, provided by, or processed through a collaborative filter 194. For example and without limitation, the collaborative filter 194 may receive a recommendation 107, a response to an advertisement 109, and/or information from a user 110 or any other element of the platform 100. Based upon this input, the collaborative filter facility 194 may generate information 105 that may be associated with the user demographics database 182. The user demographics database 182 may include information 105 relating to a particular user or group of users relating to the media platform 100. For example, a user of the media platform 100 may log into the platform 100 and/or the client 178 associated with the user may be tracked through a cookie or other such facility. The information received through the cookie may be used to populate the user demographic database 182 such that the information can be later used to better target media segments 102 and/or advertisements 112 to the user 110.

In embodiments, information 105 may be collected and stored in a demographics database 182. A graphical user interface may present the information 105, for example and without limitation, through the use of a dashboard or other such graphical user interface. Alternatively, the information 105 may be presented as a metric or any and all other measures, aggregations, disaggregations, summaries, and so on.

In embodiments, the advertising server 184 may be associated with an advertisement demographics database 115, which may encompass information 105 associating an advertisement 112 with a target demographic.

The data (105, 107, 109) collected and processed by the collaborative filter 194 may be presented to any or all of the owner 152, advertiser 144, system facilitator 158, affiliate 190, or user 110. This data may, without limitation, be presented in metric form, displayed through a dashboard, shown on a graphical user interface, provided in a textual form, and so on. A collaborative filter 194 may process the data (105, 107, 109) and make suggestions 116 to an owner 152 that may be directed at informing the owner 152 as to advertising alternatives that may improve advertising revenues. The suggestions 116 may involve pricing recommendations, recommendations of certain advertisers 144, recommendations of distribution channels, or any and all other suggestions to increase revenues. A collaborative filter 194 may process data (105, 107, 109) and make suggestions 116 to an advertiser that wants to associate its advertisements 112 with media segments 102. The suggestions 116 may involve bidding recommendations, recommendations of certain media segments 102, recommendations of media segment categories, recommendations of media segment distribution channels, or other such suggestions.

As illustrated in the embodiment of FIG. 1, the collaborative filter 194 may be associated with the player user interface 164, the affiliate 190, the affiliate UT 192, the intelligent ad server 184, the media transaction monitor 162, the advertiser UT 142, the owner UT 148, and/or the Facilitator UI 154. For example, the collaborative filter 194 may receive information from the media transaction monitor 162, perhaps in addition to other sources, and it may generate suggestions 116 based at least in part on the information received. The collaborative filter 194 may then provide processed information (e.g. processed through the collaborative filter 194) to the various user interfaces, including the advertiser UT 142, the owner UT 148, the facilitator UT 154, and the affiliate UT 192. In embodiments, the collaborative filter 194 may receive information from the intelligent ad server 184.

In embodiments, the media platform 100 may include a collaborative filter 194. The collaborative filter 194 may encompass a collaborative filter, a filter, a predictive facility, or any and all other prediction mechanisms for assessing, predicting, or otherwise processing information associated with user behaviors and/or preferences. For example and without limitation, the collaborative filter 194 may be algorithm-based or table-based. The collaborative filter 194 may have an input facility 117 and a reporting facility 119. In embodiments, the collaborative filter 194 may provide or be associated with recommended media segments 102 or advertisements 112. The collaborative filter 194 may be associated with data that is associated with the advertisement server 184, such as user demographics 182, advertisement demographics 115, and so forth. For example and without limitation, an advertisement 112 may be selected based upon information contained in or accessed using the collaborative filter 194. In embodiments, the collaborative filter 194 may be associated with media segments 102. For example, a media segment 102 may be selected or featured based upon information contained in or accessed using the collaborative filter 194. The collaborative filter 194 may include active data, such as user-defined data. For example, a user may provide information 105 such as a rating, which may be associated with a media segment 102. The collaborative filter 194 may include implicit data, such as data based upon observed user behavior, which may be the information 105, the response to an advertisement 109, and so on. For example and without limitation, the collaborative filter 194 may facilitate association of a media segment 102 with another item, such as a media segment 102, an advertisement 112 or another item associated with or independent of the media platform 100. In embodiments, the collaborative filter 194 may include or access historical data, which may, without limitation, encompass the information 105, the recommendation 107, the response to an advertisement 109, the suggestion, and so forth. Such data may include data associated with one or more users 110, user demographics 182, affiliates 190, clients 178, advertisements 112, advertisers 144, media owners 148, media segments 102, facilitators 158, formats 118 and rules 124. In embodiments, this data may be maintained concurrently. For example and without limitation, the collaborative filter 194 may maintain all or part of the data in RAM; each input of new data may have a concurrent effect on historical data. In embodiments, an algorithm may or may not process data maintained only in RAM or other active memory, without requiring use of data in a database or other stored data for which there must be a query to a database. In embodiments, the quantity of data in RAM may be scaled according to the quantity of available RAM. In embodiments, newly added data may replace older data on a rolling basis, and older data may be stored or discarded. In embodiments, the data may be associated with fields. For example and without limitation, the fields may include user 110, media segment 102, and rating or recommendation 107 by the user. The collaborative filter 194 may associate data in one field with data in another field. It will be appreciated that an advantage of using a locally accessible data set when using the collaborative filter 194 relates to speeding the process of operating the filter 194. This technique can be used to avoid many calls to a standard database, which may be time consuming, especially when making the calls to a remote database (e.g. one residing over a network). In embodiments, an algorithm of the collaborative filter 194 may be executed on the server side or the client side of computing facilities that are arranged according to client-server architecture. In any case, this algorithm may access information that has been loaded into local transactional memory such as RAM.

In embodiments, the media segment 102 may be associated with the advertisement 112. In embodiments, the advertisement 112 may be a banner advertisement, a sponsorship-type advertisement, a rich-media advertisement, a plate advertisement, or any and all other types of advertisement. In embodiments, an interstitial segment 108 may be used in the association between the media segment 102 and the advertisement 112. For example, the interstitial segment 108 may be a transition segment to appropriately transition a user from the media segment 102 to the advertisement 112. In embodiments, the interstitial segment may include an effect (e.g. a fade) to further enhance the transition between the media segment 102 and the advertisement 112. In embodiments, the media segment 102 or the advertisement 112 may include a transition segment to accomplish a similar transition effect.

In embodiments, the media segment 102 may be dynamically associated with the advertisement 112 through a dynamic attachment facility 132. The dynamic attachment facility 132 may track the location of a media segment 102 and attach new advertisements 112 from time to time. For example, the dynamic attachment facility 132 may know the storage location of the advertisement 112, and, periodically, the dynamic attachment facility 132 may be instructed to attach or otherwise associate a particular advertisement 112, advertisement link, advertisement association, or the like, with the media segment 102.

In embodiments, the media segment 102 may be associated with a media segment tag 104A and/or the advertisement 112 may be associated with an advertisement tag 104B, both of which may be a tag facility 104, or “tag” for short. In embodiments, a tag 104 may be a link, XML tag, metadata tag, feedback device, feedback program, cookie, or other facility adapted to track interactions with the tagged item. Tagging is a term used in a number of contexts for different purposes, mostly referring to adding a tag 104 of some form. In embodiments, tagging is the process by which meta-information (e.g. metadata) is associated with the media segment 102 and or the advertisement 112. This metadata may be used to describe, categorize, discriminate, track or otherwise characterize the tagged item or associate the tagged item with other items. The tag 104 may enable handling of the media segment 102 and/or the advertisement 112. In embodiments, tagging may involve making the tagged item(s) identifiable and trackable. The tag 104 may be used to track duplication of the media segment 102. The tag 104 may self-replicate in response to replication of the media segment 102. The tracking may involve tracking where the item (i.e. the media segment 102 and/or the advertising segment 112) resides and/or it may involve tracking interactions (such as interactions by the user 110) with the item.

In embodiments, the tag facility 104 may report information relating to media segment 102 interactions and/or advertisement 112 interactions from a client device 178 to a server application. In embodiments, the tag facility 104 may also generate an activity record 120. The activity record 120 may be generated and stored locally to the client 178, for example. In embodiments, the activity record 120 may be generated when the client 178 is operating in an off-line network mode. In other embodiments, the activity record 120 may be generated for each interaction, or for certain specified interactions (e.g. only full length playbacks), with the media segment 102 and/or advertisement 112. The activity record 120 may include information indicating whether media and/or advertisement interaction indication data has been communicated via a network connection. The activity record 120 may also include confirmation data indicating a confirmation that the interaction indication data was received by an intended recipient (e.g. the media transaction monitor 162). In embodiments, once a network connection is identified, information from the record(s) 120 may be communicated via the network connection. For example and without limitation, a record 120 may be generated for each interaction that was made while the client device 178 was off line and all such records, or information from the records, may be communicated to a media transaction monitor 162 through a network connection once the network connection is established. This technique may be used to generate relatively accurate measures of the interactions associated with the media segment 102 and the advertisement 112. These relatively accurate measures may be used to determine the compensation due each of the parties that are associated with the playing of the media segment 102 and/or advertisement segment 112 by the user 110. These parties may, without limitation, comprise the facilitator 158, the owner 152, the affiliate 190, and so on. Alternatively or additionally, the relatively accurate measures may be used to determine the popularity of the media segment 102 or advertisement 112, determine other related performance, and so on.

In embodiments, a tag 104, which may be used to uniquely identify a media segment 102, may be inserted into some or all media segments 102. For example and without limitation, a user 110 may download a media segment 102 from a server. This download may encompass a unique session, which may be associated with a unique identifier. This identifier may be included in a tag 104 that is associated with or incorporated into the media segment 102. Perhaps each and every time this media segment 102 is played, the tag 104 may be received or otherwise monitored by a facilitation system 186. The session may or may not be credited for revenue and/or counted toward a metric if and only if the media segment 102 and/or advertisement segment 112 are viewed in their entirety. This may prevent a user 110 from triggering credits or counts associated with the segments 102, 112 in cases where the user 110 does not play the segments 102, 112 in their entirety. The platform 100 may also enable a facilitation system 186 to monitor the IP address of the user. In embodiments, there may be an offline counter that is adapted to count or otherwise monitor interactions of a user 110 with the media when the user's client 178 is not connected to the internet, or other related network. In embodiments, prior to entering a media segment 102 into the platform 100, the media segment 102 is reviewed for, among other aspects, possible infringements of intellectual property rights such as copyright and/or trademarks. It will be appreciated that one or more elements of the platform 100 may include a database management system, flat file system, or other such system for storing and retrieving media segments 102, advertisement segment 112, tags 104, and so forth.

In embodiments, an advertiser 144 may bid for placement of an advertisement 112. Additionally or alternatively, the advertiser 144 may include in the bid 101 an indication as to what the advertiser 144 would be willing to pay for off-line interactions between an advertisement 112 and the user 110. The bid 101 as it pertains to these off-line interactions may comprise a per-interaction bid 101 and/or a cap on total per-interaction bids 101. In embodiments, this per-interaction bid 101 and/or cap may be a determining factor in the process of awarding a winning bid 101.

In embodiments, the media platform 100 may be used in connection with one or more external media platforms 100 or with one or more external advertisement systems or servers 184, players or clients 178, reconciliation modules 134, collaborative filters 194, facilitation systems 186, transaction modules or facilities 138, media transaction monitors 162, and so on. In embodiments, each of the dynamic attachment facility 132, the transaction module 138, the reconciliation module 134, the media transaction monitor 162, the intelligent ad server 184, the collaborative filter 194, the player 122, any tag 104 or any user interface relating to any of the foregoing may be use in connection with any one or more external media platform components. For example, a media tag 104A may be attached to a media segment 102 that is externally associated with an advertisement pursuant to an external advertisement server 184, which may comprise a selection, placement and/or facilitation system. In embodiments, the reconciliation module 134 may receive input from one or more external reconciliation modules 134, facilitation systems 186, player user interfaces 164, and so on. In embodiments, an advertisement 122 that may be externally associated with a media segment 102 may be reformatted in a desired format 118.

In embodiments, the media segment 102 and associated advertisement 112 (or the entire deliverable media segment 106) may be played on a client device 178. For example and without limitation, the client device 178 may be a cell phone, satellite phone, computer 178A (such as and without limitation a desktop computer, laptop computer, palmtop computer, PDA, and so on), television 178D, navigation device, wireless device 178B, radio 178C, audio content playback device, home appliance, remote-control device, billboard, projector, public display (such as and without limitation a transit system display), networked office equipment, or other client device.

The client device 178 may be associated with a client user interface 164. The client user interface 164 may be adapted to provide a user 110 with an interactive platform (e.g. hardware, software, firmware) to facilitate the interactions with a media segment 102, advertisement 112, and/or any and all other elements of the platform 100. In embodiments, the client user interface 164 may include control systems to facilitate playback, rewinding, fast forwarding, stopping, pausing, saving, editing, messaging, forwarding, emailing, instant messaging, downloading, streaming, viewing, listening or otherwise controlling the media segment 102 and/or advertisement 112. These and other aspects of the client user interface 164 may be described herein, may be described in documents included herein by reference, or may be appreciated from the present disclosure. All such aspects of the client user interface 164 are intended to fall within the scope of the present invention.

In embodiments, a media segment tag 104A may encompass a rating tag, said rating tag enabling a player 178 of the media segment 102 to contact a facilitation system 186, advertisement server 184, or any and all servers associated with the delivery and monitoring of media segments 102. This contact may be directed at identifying requests from users 110 or other parties relating to media segments 102. In the event that a media segment 102 containing the tag 104A complies with rules 124 established by a user 110 or other party, the media segment 102 may be directly delivered to said party's site player 178 or website. For example and without limitation, the party may be an affiliate 190 that provides a website containing the media segment 102 in a form that is downloadable by a user 110.

In embodiments, there is may be a player 178 containing a video bar, wherein the player 178 is programmed via an element of the platform 100. For example and without limitation, said player 178 may contain four windows which may consist of a channel, each window capable of being updated. Said channels may have an embedded recommendation channel. Other embodiments of the player 178 may be described herein, described in documents included herein by reference, or appreciated from the present disclosure. All such embodiments of the player 178 are intended to fall within the scope of the present invention.

An advertiser 144 may be able to interact with the media platform 100 through the advertiser user interface 142. The advertiser user interface 142 may facilitate advertiser activities such as bidding, participating in advertisement placement activities, selecting advertisements for association with the advertiser's advertisements, editing advertisements 112 and/or media segments 102, editing videos (e.g. if allowed per the media segment rules), adding/deleting interstitial segments 108, adding/modifying a revenue model, adding/deleting/modifying an advertisement 112, making advertisement associations, or performing other such interactions. The advertiser user interface 142 may be described in detail hereinafter.

In embodiments, an advertiser 144 may be able to interact with a transaction facility 138 to participate in a process adapted to provide sponsored content (e.g. advertisements, sponsored links, a sponsored item). In embodiments an advertiser 144 may be provided with an interface to allow it to enter sponsor information, such as bidding information, content to be presented in the event a bid 101 is won (e.g. an advertisement), contact information, and the like. For example, a transaction facility 138 may be adapted with a sponsorship entry facility 136. The transaction facility 138 may perform other functions in connection with providing advertisements in association with media segments 102. For example, the transaction facility 138 may facilitate a bidding process and/or interact with a dynamic attachment facility 132.

In embodiments, the advertiser 144 may enter a bidding process to provide certain sponsored content in association with a media segment 102 to a client 178. The advertiser 144 may provide bid information (such as maximum bids for certain keyword matches), content information, compatibility information and the like. Once the advertiser 144 has entered a sponsor or bidding process, it may be in a position to display the sponsored content in association with a media segment 144 in exchange for a bid amount. A user 110 of a client 178 may interact with a media segment 102 (e.g. through a web server application adapted to stream the media segment 102 along with a dynamically associated advertisement segment 112 to the client) and the interaction may initiate a bidding process to determine which sponsor's content (as there may be several sponsors bidding for the same placement) is going to be provided in association with the media segment 102. The bidding process may result in the placement of sponsored content (i.e. the association of an advertisement segment 112 with a media segment 102) as identified by the bidder either during the entry process or selected on behalf of the bidder. For example, the advertiser may have indicated that upon a winning bid 101, a link or other content (i.e. an advertisement segment 112) should be associated with the media segment 102 and presented to the requesting client 178.

In embodiments, the media segment 102 may be associated with more than one advertisement 112, and each such advertisement 112 may be displayed in an interstitial segment 108 or in another way, such as via a plate advertisement. In embodiments, the number and method of display of advertisements 112 may be associated with inputs relating to format 118, rules 124 and placement 128 through the advertiser user interface 142, the owner user interface 148, the facilitator user interface 164, the player user interface 164 or the affiliate user interface 190.

In embodiments, an advertiser 144 may be presented with options to facilitate association with a media segment 102. For example and without limitation, the advertiser 144 may want to bid a particular amount for association with the most popular media segment 102 available at the time. Or, the advertiser 144 may want to bid on the highest-rated media segment in a particular category (e.g. funny videos). In embodiments, an advertiser 144 may be capable of entering criteria into an advertiser user interface 142 to facilitate the bidding process. For example and without limitation, such criteria may relate to key words, phrases, terms, lingo, SMS codes, MMS codes, queries, media category, media type, media rating, and the like.

In embodiments, the advertiser may include a bid 101 in association with criteria to establish which media segment(s) 102 it is willing to bid on. For example and without limitation, a maximum bid amount may be associated with such criteria. In embodiments the maximum bid may be associated with simple matching criteria (e.g. such as matching a video rating) or it may be associated with a more complicated string or weighted string of terms, events, or characteristics. For example and without limitation, while an advertiser may provide a maximum bid of $0.10 for a category match, it may provide a bid of $0.15 for a combination of category match and media segment rating, or $0.20 for a combination of category match, media segment rating, and certain user demographics. While certain illustrations of bid criteria associated with bid amounts have been provided, it should be understood that the criteria matching may be matching, weighted function matching, algorithm based matching, or otherwise matched.

In embodiments, the transaction facility 138 may include a revenue model (or other compensation scheme). The revenue model may define the revenue sharing, or other arrangements, between an advertiser 144, media segment owner or publisher 152, and media platform facilitator 158. For example, a bid received from an advertiser 144 may be apportioned or otherwise compensate the media platform facilitator 158, media segment owner/publisher 152, one or more affiliates 190, and so on. In embodiments, the apportionment may take place upon an award of a bid 101. For example and without limitation, an advertiser may bid $0.50 for placement with a media segment 102 meeting its criteria. Once the criteria are met and the bid 101 is awarded, the media segment 102 may be played or otherwise interacted through the client 178. Through the bidding process, a revenue sharing model (or other compensation scheme) may have been developed. The bid results in $0.50 being paid by the advertiser and the revenue model may require that the revenue is split between the media segment owner/publisher 152, the media platform facilitator 158 and affiliates of the advertiser. The revenue model may be an algorithm, table, function, or other facility adapted to apportion the revenue or other form of compensation.

In embodiments, the revenue model may determine other forms of compensation splits that involve non-monetary compensation. For example, the revenue model may pass along free placements, coupons, barters, enhanced placement, extended placement duration, future revenue, rebates, rights, credit, placement size, enhanced formats, or other such non-monetary compensation. For example, the media segment owner/publisher 152 may receive enhanced placement of his media segments in exchange for making his media segment available through the media platform 100.

The revenue model may work in association with or otherwise feed a reconciliation facility 134. While the revenue or compensation model may determine compensation splits and the like, the reconciliation facility 134 may be adapted to facilitate the actual compensation. In embodiments, the reconciliation facility 134 may include or be associated with bank transaction facilities (e.g. bank routing numbers and lines of communications with the relevant banks), electronic payment systems, such as PayPal, and the like.

In embodiments, the media platform 100 may be made available directly or indirectly to one or more affiliates 190. In embodiments, the affiliate 190 may be a third party web host that posts media that was either posted or tagged using the media platform 100. For example, the affiliate 190 may copy media that was posted through the media platform through an agreement with one of the related parties. Once the affiliate has the media, it may post the media on its website and the tag may continue to track activities related to the media segment or the associated dynamically attached advertisement. The affiliate 190 may enter into an agreement with one of the media platform related parties (e.g. the facilitator 158) such that the affiliate is compensated for distributing the media. The affiliate 190 may operate a website that has high traffic and the owner/facilitator/advertiser may be well served to compensate the affiliate 190 for access to its customer base.

In embodiments, an affiliate 190 may process its own media through the media platform 100. For example and without limitation, the affiliate 190 may want to enter an online media marketplace by facilitating the dynamic attachment of advertisements 112 and to receive compensation from the advertisers 144. As a result, the affiliate 190 may submit its media 102 (e.g. video segment) to the media platform 100 through an affiliate user interface 192. Once submitted, the media 102 may be tagged for tracking and for participation in the advertising attachment process (e.g. a bidding process).

In embodiments, an affiliate 190 may be a media segment owner/publisher 152, an author of a media segment 102 or a licensee or agent of a media segment owner/publisher 152, author or host of a media segment 102, licensee or agent of the media platform facilitator 158 or other affiliate 190. An affiliate 190 may be an advertiser or advertising agent, or an owner, operator, agent, distributor or user of a media facility, bank transaction facility, data transmission facility or Internet facility. In embodiments, an affiliate 190 may be an affiliate 190 of an affiliate 190. In embodiments, an affiliate 190 may interact with the media platform 100. For example and without limitation, an affiliate 190 (e.g. a third party web host that posts media that was either posted or tagged using the media platform 100) may interact with the media platform 100 to have a tag 104 associated with the media segment 102. In embodiments, an affiliate 190 may submit a media segment 102 to be associated with a tag 104, retrieve a media segment 102 associated with a tag 104, host a media segment 102 associated with a tag 104 or retrieve or distribute a media segment 102 associated with a tag 104 from or to another affiliate 190. For example and without limitation, an affiliate 190 may submit a media segment 102 to be associated with a tag 104, and deliver the tagged media segment 102 to a host for viewing by third parties.

In embodiments, a media segment 102 may be tagged with an affiliate tag 104C associated with an affiliate 190. In embodiments, the affiliate 190 may submit a media segment 102 to or access a media segment 102 from the media platform 100 and the media segment 102 may be tracked for purposes of associating the media segment 102 and its attached advertisements 112 with the affiliate 190. The affiliate tag 104C may be in addition to any other tag 104 associated with the media segment 102. In embodiments, an affiliate may have its media tagged at the media platform 100 and participate in a revenue model associated with the media platform 100 while operating a media facility otherwise independent of the media platform 100. For example and without limitation, an affiliate 190 may publish a media segment 102 to which a media tag 104A, an advertisement 112 and an advertisement tag 104B have been attached, and a user may view the media segment 102 and respond to the advertisement 112. The response may be reported through the media transaction monitor 162 and the affiliate 190 may receive payment pursuant to the transaction module or facility 138.

In embodiments, an affiliate 190 may participate in the transaction facility 138. For example, an affiliate may enter into a special revenue (or other compensation) scheme pursuant to which affiliate 190 hosts tagged media segments 102 and receives revenue generated as a result of a bidding process and subsequent activity relating to an advertisement 112. In embodiments, an affiliate 190 may interact with or otherwise be associated with the media platform 100 through a server, client device or other computing facility.

In embodiments, the media platform 100 may include an affiliate user interface 192. The affiliate user interface 192 may provide an affiliate with options relating to the media segment 102, the transaction facility 138, the advertisement server 184 or any other aspect of the media platform 100, including, for example, associating with tags 104, establishing rules 124, compensation split requirements, status, placement requirements, coupon usage, and other options.

In embodiments, the media platform 100 may include a media transaction monitor 162. The media transaction monitor 162 may be adapted to monitor the location and interactions associated with a media segment 102 and/or advertisement 112. In embodiments, the media transaction monitor 162 may track the location and interactions through the tags 104. The tags 104 may be XML tags that may be pinged through a pinger, or tracked through a spider associated with the media transaction monitor 162, for example. In embodiments, the tags may be reporting tags (e.g. links that activate or report upon interaction) that report activity to the media transaction monitor 162. For example, a user may download a media segment 102 to his client facility 178. Once on the client facility 178, interactivity (e.g. plays, emails, forwards) may be reported back to the media transaction monitor 162. Upon such reporting, the monitor 162 may report such activity to the reconciliation facility 134 and further compensation may be apportioned.

In embodiments, the media platform 100 may include a rights management facility 198. The rights management facility 198 may facilitate the management of tags 104. In embodiments, the tags 104 cannot be removed from media segments 102 or advertisements 112, or disassociated from affiliates 190. In embodiments, the tags retain one or more original characteristics even if reformatted or if the media segment 102 or advertisements 112 to which they are attached are reformatted, compressed or segmented. For example, an affiliate 190 may publish a media segment 102 in a format 118 other than the format 118 in which the media segment 102 was associated with a tag 104A, and the tag 104 may retain its original format 118.

In embodiments, a downloaded media segment 102 may retain a dynamic advertisement link (which may be embodied as a tag 104 or as the advertisement segment 112) such that new advertisement 112 can be associated with the downloaded media segment 102.

A media owner/publisher 152 may upload his media segment 102 to the media platform 100 through an owner user interface 148. The owner user interface 148 may provide an owner 152 with options relating to the media segment 102, including, for example, establishing rules 124, compensation split requirements, status, placement requirements, coupon usage, and other options.

A media platform facilitator 158 may interact with the media platform 100 through a facilitator user interface 154. The facilitator user interface 154 may include a display component such as a dashboard or other graphical user interface. The facilitator user interface 154 may provide a facilitator 154 with options relating to the media segment, advertisements and other parameters within the platform. For example, it may be able to establish rules 124, compensation split requirements, status, placement requirements, coupon usage, regulate bidding, establish compensation models and the like.

In embodiments, an affiliate 190 may provide information 105 in the form of meta-information (such as metadata) or keywords describing or relating to such items as the content, author, subject matter or other aspect of the media segment 102. The transaction module or facility 138 may enable the collection and/or tracking of the insertion of such information 105. The collected and/or tracked information 105 could be used as part of the compensation scheme contained in the revenue module.

The media platform 100 may further comprise a visualization module 146. The visualization model 146 may provide an advertiser 144 with a depiction of any and all characteristics associated with the utilization of tagged media segments 102 in a marketplace. These characteristics may, without limitation, comprise or be associated with download and/or viewing rates of the tagged media segments 102; trends of download and/or viewing rates; user interaction with advertisements 112 attached to tagged media segments 102; metrics, measurements, predictions, or any and all other values directed at informing an advertiser 144, wherein the advertiser 144 may be considering, evaluating, executing, or retrospectively analyzing a bid for advertisement 112 placement with tagged media segments 102; and so on.

The characteristics may be associated with an individual end user who experiences a rendition of the tagged media segments 102, such as by listening to the segments 102, viewing the segments 102, reading the segments 102, and so forth. These characteristics may encompass demographics, which may comprise a zip code or other geographical designation, an age, a gender, an income level, and so on. Alternatively or additionally, the characteristics may represent a set of individual users, such as may be associated with a demographic; a metropolitan statistical area, a census tract, or a geographical region; and so on. The set of individual users may be actual, estimated, projected, or otherwise calculated or measured. For example and without limitation, a characteristic may encompass the popularity of a video with the female, 18-25 year-old demographic.

In embodiments, the characteristics may be associated with a feature of the tagged media segments 102. Without limitation, the feature may relate to the content of the segments 102, such as a type of content (i.e., audio, video, text, and so on); a nature of content (i.e., humorous, informative, religious, and so on); an intended audience for the content (i.e., child, young adult, adult, and so on); an actual, projected, or estimated audience of the content; and so forth. Alternatively or additionally, the characteristics may represent a set of tagged media segments 102, such as by aggregating any and all characteristics that may be associated with a feature of the tagged media segments 102. The set of tagged media segments 102 may be actual, estimated, projected, or otherwise calculated or measured. For example and without limitation, a characteristic may encompass the estimated number of videos that are intended for children, given a subset of the videos.

The visualization module 146 may be associated with an advertiser 144, a collaborative filter 194, or a transaction module 138, any and all of which may be associated with, engaged in, promoting, or assisting a bid 101 for placing an advertisement 112 in association with tagged media segments 102.

Visualization module 146 may be used by an advertiser 144 for assessing advertising opportunities in a media marketplace. Many examples of this are described hereinafter; some examples may be described in documents included herein by reference; and still other examples will be appreciated. All such examples are within the scope of the present invention. The visualization module 146 may provide an advertiser 144 an interface to the facilitation system 186 for bidding to attach advertisements 112 to tagged media segments 102.

Visualization module 146 may be associated with the collaborative filter 194. In embodiments, the visualization module 146 may be adapted to represent a variety of market data as provided by the collaborative filter 194. Collaborative filter 194 may receive characteristics associated with the utilization of tagged media segments 102 from other elements of the facilitation system 186; analyze, project, aggregate, generalize, simulate, optimize, extrapolate, or otherwise process the characteristics. For example and without limitation, the collaborative filter 194 may combine or associate characteristics with market data to produce an output. This output may be received by the visualization module 146, which may provide a visual representation of the output. In embodiments, an advertiser 144 may use the visualization module 146 to identify one or more tagged media segments 102 for which the advertiser 144 wants to bid. The advertiser 144 may provide additional information to the visualization module 146 such as bid price, payment information, bidding model, advertisements 112, and the like.

The visualization module 146 may be associated with the transaction module 138. The transaction module 138 may facilitate bidding on tagged media segments 102 by an advertiser 144. The visualization module 146 may process the advertiser's tagged media segments 102 selection along with the additional bidding information. The visualization module 146 may enable or be directed at enabling the advertiser 144 to make informed decisions when bidding on tagged media segments 102 with the transaction module 138. Such informed decisions may allow the advertiser 144 to win some choice bids. Upon a winning bid, an advertisement 112 may be associated with a media segment 102. The advertisement 112 may be presented to a user 110 who views the media segment 102 and advertisement 112. Then, the advertiser 144 may be assessed a fee. The fee may be apportioned in an appropriate manner, so that a media owner 152; one or more affiliates 190; a facilitator 158; and so on are compensated for their contribution to the user's viewing of the advertisement 112.

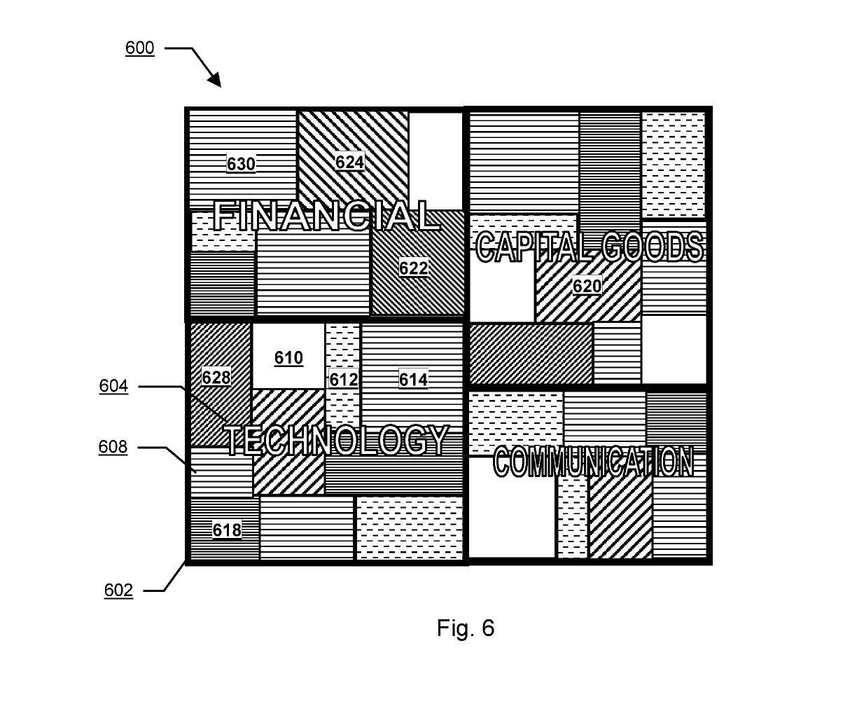

The visualization module 146, which is described in detail hereinafter with references to FIGS. 6-13, encompasses a tool that may facilitate an advertiser 144 in achieving one or more advertising objectives through the use of the media platform 100. The visualization module 146 facilitates visually assessing the advertising market spaces accessible through the media platform 100. The advertiser 144 can use the visualization module 146 to identify tagged media segments 102 that may facilitate an advertisement 112 reaching recipients that may have one or more relevant associations with the product or service being advertised.

Advertisements 112 may be created by an advertiser 144 or an advertising agency on behalf of the advertiser 144. These advertisements 112 may be directed at attaching to tagged media segments 102. The advertisements 112 may be input into the facilitation system 186 through the advertiser interface 142. The intelligent advertisement server 184 may automatically adjust an aspect of the advertisement 112. This aspect may encompass color, length, and so on, and may be based on collaborative filter 194 recommendations 107 or suggestions 116. Alternatively, an auto-ad creation module 188 may automatically generate an advertisement 112 for an advertiser 144, facilitator 158, media owner/creator 152, viewer 178, affiliate 190, and the like. An advertisement 112 may be created automatically by applying one or more of a plurality of various format advertisement templates 189 to material that may be readily available such as movie trailers, CD art, box art, album notes, web sites, media segments, internet purchasing systems, and the like.

The advertisements 112 may be generated and stored, to be retrieved at any time. For example and without limitation, an advertiser 144 may be a movie studio that has a library of movies, movie trailers, print promotional material, and so on. The movie studio may have a website for each movie where viewers (i.e. users 110) can experience more about the movie. The auto-advertisement module 188 may apply one of a plurality of templates 189 for video advertisements 112 to a portion of the movie, thus combining the two to generate an advertisement 112. The advertisement 112 may then be made available for attachment to a tagged media segment 102.

Alternatively or additionally, the advertisements 112 may be generated dynamically, such as when playing the tagged media segment 102 to which the advertisement 112 is attached. The dynamic generation may be based on a combination of a template 189, stored textual input; media segment input; other visual, aural, or textual input available to the auto-ad creation module 188; or any and all other information 105. The advertisement 112 may be automatically generated by the auto-ad creation module 188.

As an example, in a media platform 100, an auto-advertisement template 189 may be attached to a tagged media segment 102 (as an advertisement 112). While the media segment 102 is being viewed, the auto-advertisement module 188 may interact with the template 189 to update template elements such as textual content (e.g. a tag line, user calls to action links, web links); a background video; or any and all other content that may be specified by the advertiser 144 with the winning bid 101. The viewer interface 164 may display the advertisement 112 composed of the updated elements and in the format prescribed by the template 189.

The automatically created advertisements 112 may be provided on one or more websites for viewing and/or downloading along with associated tagged media segments 102 or independently of tagged media segments 102.

An auto-ad creation module 188 may be associated with an advertiser 144. The advertiser 144 may be a commercial media owner 152 like a movie studio, a musician, or a record label, and the like. The advertiser 144 may use the platform 100 to create advertisements 112 from available material by submitting or selecting a video, a tagline, contact information, and any and all other pertinent information. For example and without limitation, the advertiser 144 may select a video from a website, specify that the tagline is “Click to Buy,” provide an email hyperlink to contact the advertiser, and specify that the offer in the advertisement 144 is valid only during specified times. From all of this information, the platform 100 may create an advertisement 112.

The auto-ad creation module 188 may be associated with a media owner 152, who may, in some cases, also be the creator of the media 102. The media owner 152 may use the auto-ad creation module 188 to automatically create an advertisement 112 for a media segment 102 as it is being uploaded to the facilitation system 186.

The auto-ad creation module 188 may be associated with an affiliate 190. The affiliate 190 may reproduce, distribute, disseminate, or otherwise make available to users 110 or other affiliates 190 any and all advertisements 112, including those advertisements that are generated by the auto-ad creation module 188. In embodiments, an affiliate 190 may choose to post or place one or more automatically created advertisements 112 in a website, blog, email mailing, or any and all other promotional systems and methods under the control of or associated with the affiliate 190. For example and without limitation, an affiliate 190 may run a fan website relating to her favorite singer. The affiliate 190 may select and put on her fan website one or more advertisements 112 related to the singer (such as an advertisement 112 for the singer's latest CD, concert tour, and so on). Many other such examples will be appreciated and all such examples are intended to fall within the scope of the present invention.

The auto-ad creation module 188 may include or be associated with templates 189 of various types of video advertisement 112, such as and without limitation music video advertisements 112, movie trailer advertisements 112, static image-and-text advertisements 112, moving graphical background text advertisements 112, and so forth.

The media platform 100 facilitates an end user 110 accessing on-line content by making it available as tagged media segments 102. An end user 110 may access tagged media segments 102 through an end user interface 164. An end user 110 may also display, listen to, or view tagged media segments 102 and attached advertisements 112 through a client device 178 such as a computer 178A, a wireless client 178B, a radio 178C, a television/set-top box 178D, and other clients capable of providing the end user with a rendition of a tagged media segment 102.

An end user 110 may initiate contact with the media platform 100 to locate and access tagged media segments 102. An end user 110 may visit a website, such as with a web browser that makes available tagged media segments 102. Alternatively an end user 110 may visit the site of an affiliate 190, or may access a tagged media segment 102 through any website that has a link to a tagged media segment 102.

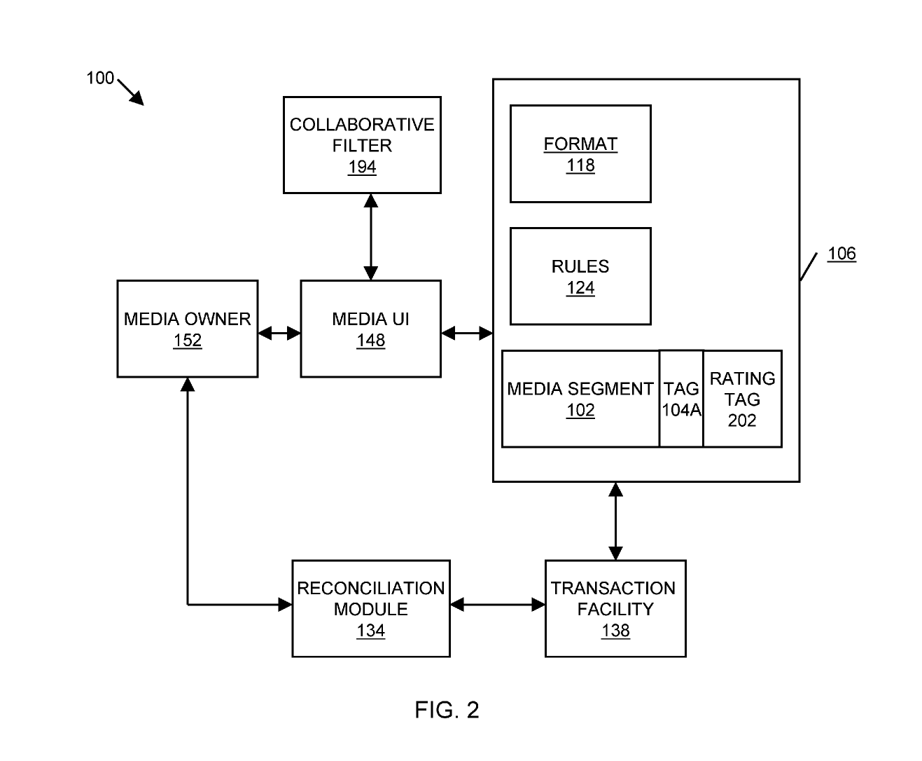

Referring to FIG. 2, a media owner 152 may by any individual, business, enterprise, or the like that may develop and create media segments 102. In embodiments, the media segment 102 may be a video segment, movie, armature movie, cell phone recorded movie, digitally recorded image, digitally recorded video, audio segment, multimedia segment, picture, text, image, publication, blog, book, magazine, article, news article, scientific article, instruction, notification, or other media adapted for viewing, listening, reading or otherwise interacting with. For example, the media segment 102 may be a video segment that was recorded by a digital video recorder (e.g. a video camera, digital video recorder). As another example, the media segment 102 may be a digitally recorded sound file (e.g. music, personal recording). As another example, the media segment 102 may be a publication (e.g. a book, blog posting, web posting, article, opinion). A media segment 102 may be originally recorded, created or otherwise made available by an artist, author, corporation or other entity.

The media owner 152 may desire to publish and distribute the media segments 102 to a network and may wish to collect revenue for the playing of the media segments 102 by users on the network. In embodiments, the network may be an Internet, an intranet, a local network, a wide area network, a peer-to-peer network, or the like. The media owner 152 may use a media platform 100 for the publishing and distribution of the owner's media segment 102 to the network. The media platform 100 may encompass, be operated by, or be operated in association with an enterprise that may associate media segments 102 with advertisers 144 and may be able to track the playing of the media segment 102 on the network. By tracking the playing of the media segments 102, the media platform 100 may be able to collect revenue from advertisers and distribute a portion of the revenue to the media owner 152.

In an embodiment, the media platform 100 may provide a service for a set fee, for a portion of advertisement revenues, a combination of a fee and a portion of advertisement revenues, or the like. In an embodiment, each media owner 152 may determine, select, specify, accept, or otherwise agree to fee terms under which the media owner 152 may provide media segments 102. The media owner 152 may initially contact the media platform 100 to establish fee terms, setup accounts, setup logon procedures (e.g. ID and passwords), download a computer application providing a media platform 100 interface, and the like. In an embodiment, the media owner 152 may select terms from a set of common media platform 100 revenue sharing terms. There may also be a custom revenue sharing term whereby the user 110 may be able to make a bid 101 for proposed terms that may be reviewed by the media platform 100. In an embodiment, the media owner 152 may be able to set different revenue sharing terms for each uploaded media segment 102. In an embodiment, the accounts may be an ewallet, credit line, bank account, credit account, or the like where the media platform 100 may collect any required fees, deposit any revenue collected from advertisers 144, or the like. In an embodiment, the media owner 152 may be able to view the accounts.

In an embodiment, the media owner 152 may be able to create the media segment 102 using any and all types of media creation software. In an embodiment, the media owner 152 may create the media segment 102 for a particular market, a particular advertiser 144, a particular event, a particular geographic area, a particular demographic, or the like. The media segment 102 may be created to be appropriate for the particular market or the media segment 102 may be generic and may be applied to a plurality of marketing situations.

In an embodiment, the media owner 152 may create the media segment 102 offline on the media owner's 152 computer device or online using a media creation network application. The created media segment 102 may be stored on the media owner's 152 computer device, a network device, a network server, a network file server, or the like where the media owner 152 may maintain access to the media segment 102.

The media platform 100 may provide a media user interface (UI) 148 for media owner 152 interaction with the media platform 100. This user interface 148 may allow the creation, modification, definition, redefinition, deletion, or specification of all or part of a deliverable media segment 106, such as and without limitation a media segment 102, tag 104A, rating tag 202, rule 124, format 118, and so forth. In an embodiment, the media UI 148 may include media segment 102 uploading/downloading capability, interaction with media segment rules 124, interaction with media segment format 118, interaction with a collaborative filter 194, viewing of media segment 102 ratings, viewing the revenue account ledger, and the like. The media owner UI 148 may require the media owner 152 to login to access the media UI 148 features. Logging in to the media UI 148 may also allow the media owner 152 access to previously uploaded media segments 102, visibility to potential advertisers, visibility to advertisers associated with any of the media owner's 152 media segments 102, access to the media owner 152 accounts, and the like.

In an embodiment, the media owner 152 may have a unique storage location on the media platform 100 where the media owner 152 may store media segments 102. In an embodiment, the media segment 102 storage may be to a shared storage device on the media platform 100 where all media owners 152 may store media segments 102. Using the media owners 152 logon information, the media owner 100 may access only the media segments 102 associated with the individual media owner 152. Using the media owner UI 148, media owner 152 management of the media segments on the media platform 100 may include uploading additional media segments 102, downloading media segments 102, removing media segments from the media platform 100, editing the media segments 102 on the media platform, or the like. After a media segment 102 has been uploaded to the media platform 100, the media owner may edit the media segment using a media editor that may be part of the media owner UI 148. In an embodiment, the media UI 148 may have a media segment editor to edit media segments 102 that are stored on the media platform 100; the media UI 148 editor may be able to edit any media segment 102 type stored on the media platform 100. The media owner 152 may also download the media segment 102, edit the media segment 102 using the media owner's software, and upload the new version of the media segment 102 to the media platform 100. In an embodiment, the media owner 152 may add, modify, edit, or the like the interstitial segments 108 that may be the transition or lead-in to the advertisement.

In an embodiment, the media owner 152 may upload or download media segments 102 either individually or in batches. The upload/download function may be a graphical interface tree structure that may provide standard cut, paste, copy, move, or the like functions. In an embodiment, any supported type of media platform 100 file format may be uploaded/downloaded; different media segment 102 types may be copied at the same time.

In an embodiment, the media owner 152 may upload the media segment 102 in the original format that in which the media segment 102 was created. The media segment 102 may be reformatted on the media platform 100 using the media UI 148. The media segment 102 may be formatted in a plurality of formats. The format may be the pattern into which data making up the media segment 102 are systematically arranged for use on a computer. A file format may be the specific design of how information is organized in the file, and it may be so arranged to be viewed through particular media players. In embodiments, the media segment 102 may be formatted in a streaming format, progressively viewed format, progressive download format, download format, or other such data format. For example, the media segment 102 may be formatted to stream into a user's client device to be viewed or listened to during the process of downloading. Or, as another example, the file may be progressively downloaded to a client device and the client device may play segments of the media segment 102 as the download continues. As another example, the media segment 102 may be downloaded to the client and the client may be able to interact or play the media segment 102 in its downloaded form.

In embodiments, the media segment 102 may be formatted in a streaming format. Streaming media may be media that is consumed (e.g. read, heard, viewed) while it is being delivered. Although it is generally used in the context of certain content types (e.g. “streaming audio”, “streaming video”, etc), streaming is more a property of the delivery systems employed to distribute that content than a type of content. The “streaming” distinction is usually applied to media that are distributed over computer networks; most other delivery systems are either inherently streaming (e.g. radio, television) or inherently non-streaming (e.g. physical books, video cassettes, audio CDs). The word “stream” may also be used as a verb, meaning “to deliver streaming media.” In embodiments, the media or multimedia content may be large, such that media storage and transmission costs are significant; to offset this somewhat, the media may be compressed for both storage and streaming. In embodiments, a media stream can be on-demand or live. On-demand streams may be stored on a server for a period of time, and may be available to be transmitted at a user's request. Live streams may only be available at one or more particular times, as in a video stream of a live or rebroadcast sporting event or an audio stream of a live or rebroadcast concert. In embodiments, the media may be formatted for a particular media player. For example, the format may be compatible with a Window's Media Player, RealPlayer, QuickTime, MP3 player, .wav player, MPEG player or other such media player.

In an embodiment, the media owner 152 may use the media owner UI 148 to format the media segment 102 into any of the available formats 118. The media segment 102 may be saved in a plurality of formats at the same time either individually or in a batch mode. This may provide for a wide range of available media play and advertiser options where the same media segment 102 may be played using several different media players. In an embodiment, having different format types may provide an increased revenue stream to the media owner 152 because there would be more than one format for the advertiser 144 to choose from when bidding on the media segments 102. In an embodiment, the media UI 148 may present to the media owner 152 the format choices into which the original media segment may be formatted. For example, dependent on the original media segment 102 format, only the Media Player, RealPlayer, and QuickTime formatting options may be presented to the media owner 152. The media owner 152 may choose one or all of the formatting options for the media segment 102.

In an embodiment, the media UI 148 may have access to the collaborative filter 194 for information on potential advertisers. The collaborative filter 194 may process information and make suggestions to the media owner 152 of a media segment 102 and may inform the media owner 152 of advertising alternatives that may generate a favorable revenue stream. The collaborative filter 194 suggestions may include pricing recommendations, recommendations of certain advertisers, recommendations of distribution channels, recommendations of viewing demographics, or other suggestions to optimize revenue. Based on the collaborative filter 194, the media owner 152 may modify a media segment 102 to improve the type of advertiser that may be interested in the media segment 102, improve the media segment 102 rating to improve revenue possibilities, revise the media segment 102 to be used in more channels, revise the media segment 102 for a particular demographic, or the like. The collaborative filter 194 may suggest markets, demographics, media, channels, or the like that the media owner 152 had not previously thought of and may prompt the media user to modify, create new, create different media, or the like to improve the media owners revenue stream.

After interacting with the collaborative filter 194, the media owner 152 may use the media owner UI 148 to interact with the rules 124 to define the type of advertisers 144, advertisements, demographics, or the like that the media owner 152 would like to associate the media segment 102 with. The rules 124 may be rules that are imposed by the media owner 152. In embodiments, the rules 124 may restrict the types of advertisements 112 and/or interstitial segments 108 that may be associated with the media segment 102. For example, an owner of the media segment 102 may not want certain advertisers, such as adult content advertisers, tobacco advertisers, gun advertisers or other advertisers, or certain advertiser segments associated with the media segment 102. In embodiments, the rules 124 may relate to how, when, where, and/or to whom the media segment 102 may be provided. For example, the media segment 102 may be intended for intranet distribution and therefore restricted from Internet distribution. As another example, the media segment 102 may contain adult content and the rules 124 may restrict the distribution of the media segment 102 to users under the appropriate age. In embodiments, the rules 124 may relate to control over distribution of the media segment. For example, the distribution of the media segment may be regulated by statute (e.g. adult content, content containing violence or otherwise regulated material) and the rules may restrict the media segment from being otherwise distributed.

In embodiments, the rules 124 may be used to indicate the desired or acceptable type of advertising that can be associated with the media segment, geographic regions in which the media segment can be distributed, demographics to target, or the like. For example, the media owner 152 may desire the media segment 102 to be directed to 18-25 year old purchasers, therefore with an appropriate rule, the media segment 102 may be played on a website frequented by this age group with an advertiser 144 that is also directed to that demographic. As another example, the media owner 152 may want the media segment to play predominately in the northeast part of the country, therefore the rule may have the media segment 102 played on websites that are directed to the northeast states, cities, or the like. In embodiments, the rule(s) may restrict the type of advertisements that can be associated with the media segment. For example, the rule may restrict tobacco advertisements, alcohol advertisements, or the like. There may be rationale for such restrictions (e.g. the media segment is targeting young adults) and the rationale may be incorporated into a selectable option (e.g. select a children's rule restriction to automatically restrict such advertisements). In other embodiments, there may be no predetermined rationale and the user may select the types of advertisement restrictions in a more manual method (e.g. selecting the groups from a menu or indicating the types through a text field).

In an embodiment, the rules 124 may be applied to the media segment 102 as a rule tag (i.e. a tag 104) that may be matched to rule tags from advertisers 144. The media platform 100 may match compatible rule tags from the media segment 102 and advertisers 144 to make the associations between the media segment 102 and the advertiser. In an embodiment, by creating media segment rules 124, the media owner 152 may not need to individually manage the advertisers 144 that are associated to the media segment 102. This may allow the dynamic association of an advertisement to a media segment 102 for time sensitive playing of the media segment 102, as new advertisers become available, or the like.

In an embodiment, a media segment tracking tag 104A may be applied to the media segment 102; the media segment tracking tag 104A may be persistent. Media segment tracking tags 104A may be associated with media segments 102 such that the media segment tracking tag 104A may remain associated with the media segment 102 through distribution (e.g. downloading, emailing, Instant messaging, syndication, etc.). The media segment tracking tag 104A may feed information back to an activity monitoring facility and the monitored activity may result in revenue and/or revenue sharing. Likewise, the media segment tracking tag 104A may be associated with the media segment 102 to facilitate the dynamic association of advertisements with the media segment 102. For example, a media segment tracking tag 104A may be used to track the location of the media segment 102 to facilitate the attachment of advertisements throughout distribution.

In an embodiment, the media segment tracking tag 104A may be applied to the media segment 102 when the media owner 152 uploads the media segment 102 to the media platform 100. The media platform 100 may use the media owners 152 login information to apply a unique media segment tracking tag 104A. In an embodiment, the media owner 152 may manually apply the media segment tracking tag 104A using the media owner UI 148. By applying a unique media segment tracking tag 104A, the media platform 100 may be able to track the playing of the media segment 102 on the network. In an embodiment, an ad tracking tag 104B and affiliate tracking tag 104C may also be associated with the media segment 102. The combination of the tracking tags may allow the media platform 100 to track the playing of the media segment 102 along with the advertisement and affiliate 190 that may be associated with the media segment 102. With the tracking information, the media platform 100 may be able to determine the advertisement value resulting from the playing of the media segment 102 and to portion the advertisement value between the media platform 100, affiliate 190, and media owner 152 per the predetermined agreement. As previously described, there may be a unique individual agreement for each media segment 102.

In an embodiment, the media segment tracking tag 104A may also be applied when the media owner 152 saves the original media segment 102 to a different format 118. The media platform 100 may use the media owners 152 login information to apply a unique media segment tracking tag 104A as part of the format 118 process. In an embodiment, the same media segment tracking tag 104A may be applied to every format 118 of the media segment 102.

In an embodiment, the media segment tracking tag 104A may be applied to every media segment 102 that is stored in the media owners 152 media platform 100 storage space. In an embodiment, if a media segment 102 is downloaded from the media platform 100 to the media owner 152, the tracking tags may be removed from the media segment 102, unless the media owner 152 is acting as an affiliate 190. Media owners 152 acting as an affiliate 190 is discussed in detail below. The media segment tracking tag 104A may be reapplied if the media segment 102 is uploaded back to the media platform 100.

In an embodiment, the media segment 102 may have a rating tag 202 that may be used by the advertiser 144 to match advertisements to the media segment 102. The rating tag 202 may also influence the advertiser 144 bid value to be associated with a media segment 102. In an embodiment, the media owner 152 may be able to view the media segment rating tag 202 using the media owner UI 148. In an embodiment, the viewing of the rating tag 202 may be read only; the media owner 152 may not be able to edit the media segment rating tag 202. In an embodiment, picture quality, video quality, audio quality, user rating, advertiser 144 rating, or the like may influence the rating tag 202. The user's response to the playing of the media segment 102 may be provided in a feedback to the media platform 100; the media platform 100 may set or modify the rating tag 202. By viewing the rating tag 202, the media owner 152 may modify the media segment 102 to improve the rating tag 202 of the media segment 102.

In an embodiment, a revenue stream realized by the media owner 152 may be related to the rating tag 202. For example, an advertiser 144 may place higher bids on a media segment 102 that have a higher rating tag 202. An advertiser may provide a maximum bid of $0.10 for a media segment 102 match, but may provide a bid of $0.15 for a combination of media segment 102 match and media segment rating tag 202 comprising a particular value (i.e. 5 out of 5 stars). The rating tag 202 may also be related to the demographic appeal of the media segment 102, therefore the demographic target that the media owner 152 indicates the media segment 102 is targeted for may also influence the rating tag 202.

Since the advertisement revenue may be directly associated with the rating tag, the media owner may monitor the rating tag 202 during the life of the media segment 102. In an embodiment, over time, the media segment's 102 rating tag 202 may change as the media segment 102 is viewed, as it become less timely, as advertisers 144 want a fresh media segment for their advertisements, or the like. If the media owner 152 sees the rating tag 202 changing, the media owner 152 may modify the media segment 102, may remove the media segment 102 from the media platform 100, may create a new media segment 102, or the like to maintain a high-valued rating tag 202 for the media segments 102 on the media platform 100.

While certain embodiments disclosed herein describe one or more ‘tags’ in association with the media segment and/or the advertisement, it should be appreciated that the identified information or functions may be embedded into a signal tag or in multiple tags and such embodiments are encompassed by the present invention.

In an embodiment, an affiliate 190 may be an enterprise such as a publisher that may have rights from the media platform 100 to distribute media segments 102. The affiliate 190 may be able to upload and download media segments 102 to and from the media platform 100. The affiliate 190 may get a portion of a revenue stream in return for distributing the media segment 102 to users. The media segment 102 may have an affiliate tracking tag 104C to allow the media platform 100 to track any and all media segments 102 played as a result of the affiliate 190 distribution of the media segment 102.

In an embodiment, the media owner 152 may act as an affiliate 190; in this case the media owner 152 may also be a media publisher. The media owner 152 may develop and create media segments, but may want the media platform 100 to track the playing of the media segment 102 and track the associated advertisement revenue. In an embodiment, the media owner 152 may use the media owner UI 148 to upload the media segment 102 to the media platform 100. The media platform 100 may then apply the media segment tracking tag 104A, associate an advertisement 112 to the media segment 102 (and any ad tracking tags 104B), apply the affiliate tracking tag 104C to the media segment 102, and so on. In an embodiment, when the media owner 152 is acting as an affiliate 190, the media segment tracking tag 104A and affiliate tracking tag 104C may be associated to the media user 152 login information. After the media platform 100 has completed applying the tags required to track the playing of the media segment 102, the media owner 152 may use the media owner UI 148 to download the affiliate tagged media segment 102. In an embodiment, once the media owner 152 has the affiliate tagged media segment 102, the media owner 152 may act as an affiliate 190 and make the media segment 102 available to users 110 to download and view. By acting as an affiliate, the media owner 152 may receive the revenue stream as both the media owner 152 and the affiliate 190 when the advertisement income is distributed.

In an embodiment, the media platform 100 may track the playing of the media segment 102 by users and determine the advertisement income using the transaction facility 138. The various tracking tags that may be applied to the media segment 102 may allow the transaction facility 138 aggregate the number of times a media segment 102 has been played and determine the amount of advertisement income may be associated to the media segment 102 playing.

In an embodiment, the transactional facility 138 may transmit the aggregated media segment 102 play times to the reconciliation module 134 for the distribution of the media segment 102 advertisement revenue. As may have been previously determined by the media owner 152, media platform 100, affiliates 190, and the like, the advertisement income may be divided according to certain terms. The reconciliation module 134 may place the appropriate revenue funds into the accounts for the media platform 100, media owner 152, affiliate 190, and the like.

In an embodiment, the media owner 152, using the media owner UI 148, may be able to view the revenue distributions to the media owner's 152 accounts. The media owner 152 may be able to view the account balance sheet that may list each media segment 102 played, the number of times each media segment 102 was played, the gross advertisement revenues realized by each media segment 102, the revenue distributions each of the media platform 100 and affiliate 190 received, and the like. The media owner UI 148 may provide the media owner 152 with a revenue history for each media segment 102 that may provide an overall value of the media segment 102. For example, the media owner 152 may find that even though the number of media segments 102 plays may have increased, the amount of revenue received may actually go down as a result of the media rating being reduced over time. The changed media rating may result in a lower advertisement bid 101 for the media segment 102. If the media owner 152 sees a trend that the income per media segment 102 is reducing with time, the media owner 152 may modify the media segment, replace the media segment 102 with a new media segment 102, or the like. The media owner 152 may be able to use the accounts view as a management tool to track not only the number of times the media segment is playing, but the amount of revenue is made and the amount of revenue made per media segment 102 play.

In an embodiment, a media owner 152 may wish to stop using the media platform 100 as the agent for tracking the playing of the media segments 102. The media owner 152 may use the media owner UI 148 to terminate the association to the media platform. As part of the termination process, the media owner's 152 stored media segments 102 may be downloaded to the media owner 152; the media segment 102 may have any of the tracking tags removed before the download. The media platform 100 may also delete any of the media owner 152 login information that would be used to create the media segment 102 tags. As a result of the association termination, the media platform 100 may also request that all affiliates with the media owners 152 media segments 102 deleted the media segments 102 from their distributions. In an embodiment, if the media owner 152 was to again use the media platform 100 for distribution of the media segment 102, the media platform 100 may create new login information for the creation of new tracking tags.

Referring generally now to the media platform 100, a media platform facilitator 158 may interact with the media platform 100 through a facilitator user interface 154. The facilitator user interface 154 may include a display component such as a dashboard or other graphical user interface. The facilitator user interface 154 may provide a facilitator 158 with options relating to the media segment, advertisements and other parameters within the platform. For example, with it a facilitator 158 may be able to establish rules 124, compensation split requirements, status, placement requirements, coupon usage, regulate bidding, and establish compensation models and the like.

In embodiments, users such as owners 152, affiliates 190, advertisers 144, device 178 users, and other third parties may require support of a facilitator 158. Support from the facilitator 158 may be executed and or administered through the facilitator user interface 154.

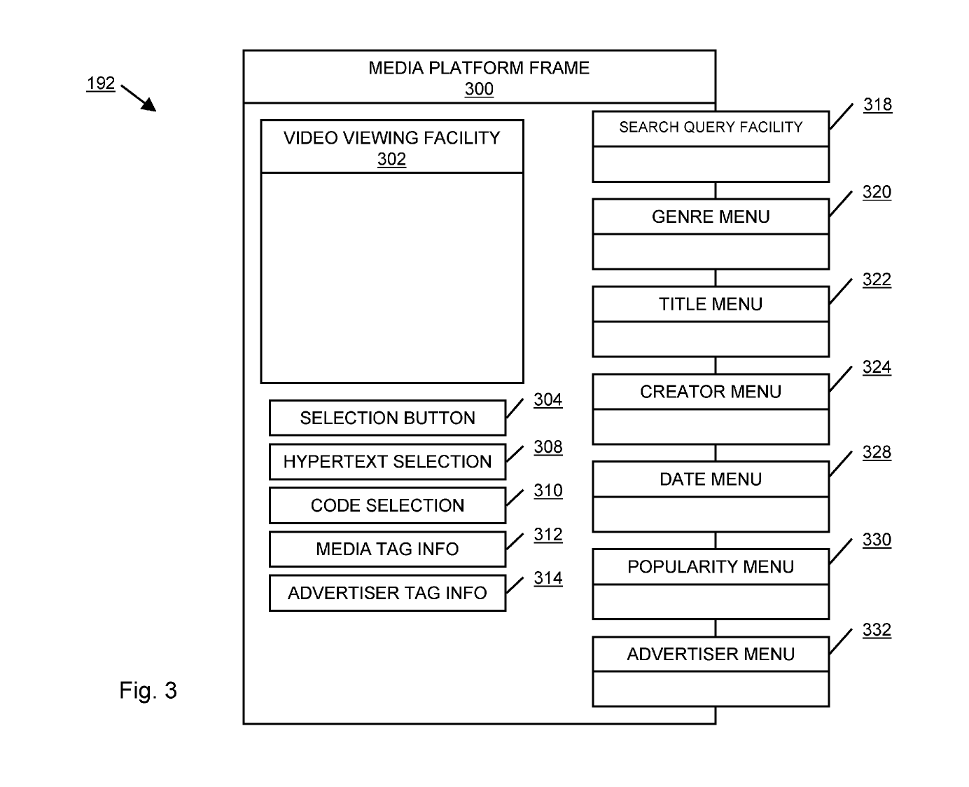

Referring to FIG. 3, in embodiments, an affiliate user interface 192 may be implemented within a network, such as the Internet, and displayed on a website, mobile communication facility, PDA, or some other networked client. In embodiments, a network-based affiliate user interface 192, such as a website, may include a media platform frame 300 within which the affiliate 190 may access the media platform 100 website, while remaining within the affiliate user interface 192 website. Once a listing of the media segments 102 (e.g. video content, audio content, and so forth) that are associated with the media platform 100 has loaded to the affiliate user interface 192, it may be possible for the affiliate 190 to view media segments 102 within a media segment viewing facility 302 and make selections of the media segments 102 which it would like to include within the framework of its affiliate program using, for example, by using a selection button 304. The affiliate 190 may view the contents of the media segments 102 within the video viewing facility 302 or, alternatively, the media segments 102 may be presented in a menu format for selection. For example, a title menu 322 may present the titles of all the media segments 102 available on the media platform 100, the a genre menu 320 may provide all the genres of the media segments 102 available, a creator menu 324 may provide the creators of the media segments 102, a date menu 328 the dates on which the media segments 102 were created, a popularity menu 330 may list the most frequently viewed media segments 102, an advertiser menu 332 may list advertisers 144 associated with available kinds of media segment content (e.g. video, audio, text, and so forth), or a menu may list some other quality of the media segments 102. A genre menu 320 listing may include genres such as animals, music, sports, travel, dance, commercials, humorous, politics, country, city, hobby, and so forth. The kinds of media segment 102 content may also be listed in a directory structure that may include a search query facility 318. This may enable an affiliate 190 to search for all media segments 102 within, for instance, the genre “animals” and then view, hear, or otherwise play the available animal media segments 102 in a listing that includes the authors of the media segments 102, the date of the creation, and other information relating to the media segments 102.

In another embodiment, the affiliate 190 may be able to search for content on the basis of information included in the media tag 104A using a media tag information facility 312. For example, included in the media tag may be information of relevance to an affiliate 190, such as genres of the media segments 102 available, the authors of the media segments 102, the dates on which the media segments 102 were created, advertisers associate with the media segments 102, or list some other quality of the media segments 102 that is of relevance to an affiliate 190 in selecting media segments 102 for reproduction and/or redistribution to users 110. Once a suitable media segment 102 is found, the affiliate 190 may select it for inclusion in its affiliate program. A media segment 102 may have a selection button 304 or box associated with it. By clicking on the button or box, an affiliate 190 may initiate a download process for transferring the video from the media platform 100 to the affiliate 190. Alternatively, an affiliate 190 may copy and paste a hypertext link to the media segment 102 using a hypertext selection facility 308, and/or code for the media segment 102 using a code selection facility 310, in order to share it through the affiliate program.

In embodiments, an affiliate 190 may also select media segments 102 to include in its affiliate program based at least in part on information relating to the advertiser tag 104B using an advertiser tag information facility 314. For example, an affiliate 190 may have information regarding which advertisers offer products of relevance to the participants in the affiliate program. An intelligent advertisement server 184 may facilitate selection of content based at least in part on advertisements 112, advertising content, and according to information provided by the advertiser 144. By enabling an affiliate 190 to select content based on the advertising content and/or advertiser, and affiliate may be able to give preference to including media segments 102 with the greatest likelihood of being viewed by affiliate participants. This may, in turn, generate greater revenues for the affiliate.

Once an affiliate 190 has selected a media segment 102 for inclusion in the affiliate program, it may add its affiliate information to the affiliate tag 104C and associate the tag with the media segment 102. An affiliate tag 104C may include information including affiliate 190 name, affiliate account linked to the media platform, and other information relating to the affiliate 190. The affiliate tag 104C may enable the affiliate to earn credit for each play of media segment 102 by a user 110 through the affiliate program, and to collect revenues associated with the play. Once the affiliate 190 has downloaded or linked to a media segment 102, it may track activities related to the media segment or the associated dynamically attached advertisement. The affiliate user interface 192 may provide an affiliate with additional options relating to the media segment 102, the transaction facility 138, the advertisement server 184 or any other aspect of the media platform 100, including, for example, associating with tracking tags 104, establishing rules 124, compensation split requirements, status, placement requirements, coupon usage, and other options.

In embodiments, an affiliate 190 may also provide media segments 102 of its own to the media platform 100 where it may be made available for download and placement in the affiliate programs of other affiliates 190. For example, the affiliate may want to enter the online media marketplace by facilitating the dynamic attachment of advertisements and to receive compensation from the advertisers 144. As a result, the affiliate 190 may submit its media segments 102 to the media platform 100 through the affiliate user interface 192. Once submitted, the media may be tagged for tracking and for participation in the advertising attachment process, and receive revenues derived from the participants (i.e. users 110) viewing the media segments 102 in other affiliate programs. In embodiments, an affiliate 190 may be an advertiser 144, advertising agent, an owner, operator, agent, distributor or user of a media facility, bank transaction facility, data transmission facility or Internet facility, or some other entity. An affiliate 190 may interact with or otherwise be associated with the media platform 100 through a server, client device or other computing facility. An affiliate program may provide access to media segments 102 through the use of a webpage, email, list server, instant message, blog, social networking, or any and all other systems and methods for distributing, duplicating, redistributing, transferring, communicating, or otherwise providing media segments 102 to an affiliate 190.

In embodiments, an affiliate 190 may be an Internet entity operating a website organized around a special interest, such as a sporting event. For example, an affiliate 190 may be a sports tournament organization, such as the World Cup soccer tournament. The World Cup affiliate 190 may wish to post video or video segments (i.e. media segments 102) pertaining to national teams, venues, match highlights, player profiles, fans, and the like, that it would like to monetize by making such tagged video available to interested viewers (i.e. users 110). The World Cup affiliate 190 may download video segments from the media platform 100 through an affiliate user interface 192. Once received, the video segments may be integrated into the website in whatever manner desired by the affiliate 190. The website may provide a link to the media platform 100 where the video may be viewed. It may host the video content on its own platform for viewing, or provide some other means of accessing the video content that is initially derived from the media platform 100. This flexibility may provide an incentive for affiliates 190 to participate in downloading the tagged content insofar as it may enable website operators to increase the content available on an affiliate website without having to invest the resources to create its own video content.

Continuing the World Cup affiliate 190 example, through the use of a collaborative filter 194 and/or an intelligent ad server 184, video that is related to sports, such as soccer, may be associated with advertisers selling products of relevance to sports, of interest to consumers who watch sports, and so forth. Thus, when the World Cup affiliate 190 downloads video content to present on its website, it may have associated advertising content that is of relevance to the World Cup website's users. This relevance may serve to increase both the advertising revenues and the website's revenues by increasing the likelihood that visitor's to the site will choose to watch the video.

In embodiments, the intelligent ad server 184 may be associated with a data facility containing user demographics 182. The intelligent ad server 184, in conjunction with the collaborative filter 194, may associate the video submitted by a media owner 152 with certain characteristics, some of which may be recorded in a media tag 104. For instance, if the video were a highlight of a World Cup match involving the Mexican national team, the affiliate 190 may provide information relating to the content of the video, the creator of the video, the advertisers associated with the video, the characteristics of previous viewers of the video, and other information associated with the video. For example, the affiliate 190 may indicate the video is within the genre “sport,” is a soccer match, is a World Cup match, involves the Mexican national team, has been viewed most by males in the age group of 18 to 34 year-olds, and the like. The collaborative filter 194 may serve as an intermediary between the advertiser user interface 142, the player user interface 164 and the facilitation system 186, including the intelligent ad server 184. Information derived from these facilities may be used by collaborative filtering algorithms. The affiliate 190 may receive recommendations from the collaborative filter facility 194 based at least in part on the results of applying the collaborative filter algorithms. The collaborative filter 194 may make recommendations to an affiliate 190 based on highly concurrent data, and an affiliate 190 may respond to the recommendation by including the recommended video in its affiliate program.

In embodiments, an affiliate 190 may encompass an entity providing email to participants. The email system may be a personal to an individual, a commercial entity, such as a retailer, a group organized around a special interest, such as a club, or some other type of email provider. For example, an affiliate 190 may be a business, such as a clothing retailer. The retailer affiliate 190 may have a list of customers and their email addresses to whom it wishes to provide video or video segments (i.e. media segments 102) pertaining to new clothing lines, fashion shows, designers, models, and the like, that it would like to monetize by making such tagged video available to its customers. The retailer affiliate 190 may download video segments from the media platform 100 through an affiliate user interface 192. Once received, the video segments may be integrated into the email in whatever manner desired by the affiliate 190, for example the video may be an attachment to the email, the email may contain a link to a retailer's website where the video may be view, the email may contain a link to the media platform 100, or provide some other means of viewing the video. This flexibility may provide an incentive for affiliates 190 to participate in downloading the tagged content insofar as it may enable email operators to increase the variety of content available within an affiliate's email without having to invest the resources to create its own video content.

Through the use of a collaborative filter 194 and/or an intelligent ad server 184, video that is related to the affiliate's interest may be associated with advertisers selling products of relevance to the affiliate, of interest to consumers or persons associated with the affiliate, and so forth. Thus, when the affiliate 190 downloads media segments 102 to present in email sent to its participants, it may have associated advertising content that is of relevance to the affiliate's participants and users. For example, a clothing retailer specializing in haute couture dresses may have customers that are interested in haute couture shoe makers. Thus, it may be able to select media segments 102 that are relevant to its customers and which is also associated with advertisers selling such relevant products. This relevance may serve to increase both the advertising revenues and the retailer's revenues by increasing the likelihood that an affiliate's email participant will choose to watch the video.

In embodiments, the intelligent ad server 184 may be associated with a data facility containing user demographics 182. The intelligent ad server 184, in conjunction with the collaborative filter 194, may associate the media segments 102 submitted by a media owner 152 with certain characteristics, some of which may be recorded in a media tag 104. For instance, if the media segments 102 were a highlight of a fashion, the retailer affiliate 190 may provide information relating to the content of the media segments 102, the creator of the media segments 102, the advertisers associated with the media segments 102, the characteristics of previous viewers of the media segments 102, and other information associated with the media segments 102. For example and without limitation, the affiliate 190 may indicate the media segments 102 are within the genre “fashion,” is a fashion show, is an Italian designer, involves a particular modeling agency and models, has been viewed most by females in the age group of 16 to 30 year-olds, and the like. The collaborative filter 194 may serve as an intermediary between the advertiser user interface 142, the player user interface 164 and the facilitation system 186, including the intelligent ad server 184. Information derived from these facilities may be used by collaborative filtering algorithms. The affiliate 190 may receive recommendations from the collaborative filter facility 194 based at least in part on the results of applying the collaborative filter algorithms. The collaborative filter 194 may make recommendations to an affiliate 190 based on highly concurrent data, and an affiliate 190 may respond to the recommendation by including the recommended video in its affiliate program.

In embodiments, an affiliate 190 may encompass a list server. The list server may be a personal list server, a commercial list server, a list server organized around a special interest, such as model railroading, or some other type of group. For example, an affiliate 190 may be a hobby group, such as a model railroading club. The model railroading club affiliate 190 may wish to post video or video segments (i.e. media segments 102) pertaining to railroads, trains, modeling companies, modeling shows, new model railroad products, and the like, that it would like to monetize by making such tagged video available to interested viewers who are participants in the model railroading club's list server service. The model railroading club affiliate 190 may download video segments from the media platform 100 through an affiliate user interface 192. Once received, the video segments may be integrated into the model railroading club's list server in whatever manner desired by the affiliate 190. The model railroading club may provide a link within the body of a list server message to the media platform 100 where the video may be viewed, it may host the video content on its own platform for viewing, provide the video as an attachment to the list server message, or provide some other means of accessing the video content that is initially derived from the media platform 100. This flexibility may provide an incentive for affiliates 190 to participate in downloading the tagged content insofar as it may enable list server operators to increase the content available on an affiliate list server without having to invest the resources to create its own video content.

Through the use of a collaborative filter 194 and/or an intelligent ad server 184, media segments 102 that are related to the affiliate's interest may be associated with advertisers selling products of relevance to the affiliate, of interest to consumers or persons associated with the affiliate, and so forth. Thus, when the model railroading club affiliate 190 downloads video content to present to its list server participants, it may have associated advertising content that is of relevance to the affiliate's participants and users. For example, a video segment may be associated with a model railroad product manufacturer. This relevance may serve to increase both the advertising revenues and the model railroading club's revenues by increasing the likelihood that model railroading club affiliate's list server participants will choose to watch the video.

In embodiments, the intelligent ad server 184 may be associated with a data facility containing user demographics 182. The intelligent ad server 184, in conjunction with the collaborative filter 194, may associate the media segments 102 submitted by a media owner 152 with certain characteristics, some of which may be recorded in a media tag 104. For instance, if the media segments 102 were a highlight of a model railroad show, the affiliate 190 may provide information relating to the content of the media segments 102, the creator of the media segments 102, the advertisers associated with the media segments 102, the characteristics of previous viewers of the media segments 102, and other information associated with the media segments 102. For example, the affiliate 190 may indicate the media segments 102 is within the genre “hobby,” is a media segment 102 relating to model railroads, is a model railroad show, and has been played most by males in the age group of 50 to 70 year-olds, and the like. The collaborative filter 194 may serve as an intermediary between the advertiser user interface 142, the player user interface 164 and the facilitation system 186, including the intelligent ad server 184. Information derived from these facilities may be used by collaborative filtering algorithms. The affiliate 190 may receive recommendations from the collaborative filter facility 194 based at least in part on the results of applying the collaborative filter algorithms. The collaborative filter 194 may make recommendations to an affiliate 190 based on highly concurrent data, and an affiliate 190 may respond to the recommendation by including the recommended video in its affiliate program.

In embodiments, an affiliate 190 may be an instant messaging service or an individual or entity using instant messaging. The instant message may be a personal message, a commercial message, or some other type of instant message. For example, an instant messaging affiliate 190 may be an individual, such as a college student. The individual affiliate 190 may wish to post video or video segments (i.e. media segments 102) pertaining to the common interests of the persons in his instant messaging contact list, and the like, that he would like to monetize by making such tagged video available to interested instant messaging contacts. The individual affiliate 190 may download video segments from the media platform 100 through an affiliate user interface 192. Once received, the video segments may be integrated into the individual's instant messages in whatever manner desired by the affiliate 190. The individual may provide a link in the body of the instant message to the media platform 100 where the video may be viewed, he may host the video content on his own platform for viewing, paste the video into the instant message, or provide some other means of accessing the video content that is initially derived from the media platform 100. This flexibility may provide an incentive for affiliates 190 to participate in downloading the tagged content insofar as it may enable individual instant messengers, and other instant messaging affiliates and operators to increase the content available to instant messaging contacts without having to invest the resources to create its own video content.

Through the use of a collaborative filter 194 and/or an intelligent ad server 184, media segments 102 that is related to the affiliate's interest may be associated with advertisers selling products of relevance to the affiliate, of interest to consumers or persons associated with the affiliate, and so forth. Thus, when the individual instant messaging affiliate downloads or links to video content to present to its instant messaging contacts, it may have associated advertising content that is of relevance to the individuals contacts. This relevance may serve to increase both the advertising revenues and the individual's revenues by increasing the likelihood that an individual's instant messaging contacts will choose to watch the video.

In embodiments, the intelligent ad server 184 may be associated with a data facility containing user demographics 182. The intelligent ad server 184, in conjunction with the collaborative filter 194, may associate the media segments 102 submitted by a media owner 152 with certain characteristics, some of which may be recorded in a media tag 104. For instance, if the media segments 102 were a highlight of a fraternity keg party, the affiliate 190 may provide information relating to the content of the media segments 102, the creator of the media segments 102, the advertisers associated with the media segments 102 (e.g., beer makers), the characteristics of previous viewers of the media segments 102, and other information associated with the media segments 102. For example, the affiliate 190 may indicate the media segments 102 are within the genre “humor,” is a party, is a college party, involves drunkenness, has been played most by males in the age group of 17 to 22 year-olds, and the like. The collaborative filter 194 may serve as an intermediary between the advertiser user interface 142, the player user interface 164 and the facilitation system 186, including the intelligent ad server 184. Information derived from these facilities may be used by collaborative filtering algorithms. The affiliate 190 may receive recommendations from the collaborative filter facility 194 based at least in part on the results of applying the collaborative filter algorithms. The collaborative filter 194 may make recommendations to an affiliate 190 based on highly concurrent data, and an affiliate 190 may respond to the recommendation by including the recommended video in its affiliate program.

In embodiments, an affiliate 190 may be a blog, blog site, blogger, and the like. The blog provider may be a personal blogger, a commercial blogger, a blog organized around a special interest, such as a political issue, or some other type of blog. For example, an affiliate 190 may be a commercial news organization, such as a newspaper. The newspaper affiliate 190 may wish to associate video or video segments (i.e. media segments 102) with a newspaper columnist's blog pertaining to global warming, or some other political issue, that it would like to monetize by making such tagged video available to interested viewers. The newspaper affiliate 190 may download video segments from the media platform 100 through an affiliate user interface 192. Once received, the video segments may be integrated into the columnist's blog in whatever manner desired by the affiliate 190. The blog may provide a link to the media platform 100 where the video may be viewed. It may host the video content on its own platform for viewing, or provide some other means of accessing the video content that is initially derived from the media platform 100. This flexibility may provide an incentive for blog-related affiliates 190 to participate in downloading the tagged content insofar as it may enable blog operators to increase the content available to the readers of the blog without having to invest the resources to create its own video content.

Through the use of a collaborative filter 194 and/or an intelligent ad server 184, media segments 102 that are related to the affiliate's interest may be associated with advertisers selling products of relevance to the affiliate, of interest to consumers or persons associated with the affiliate, and so forth. Thus, when the newspaper or other blog affiliate downloads video content to present to its blog readers, it may have associated advertising content that is of relevance to the newspaper affiliate's readers and users. This relevance may serve to increase both the advertising revenues and the newspaper's revenues by increasing the likelihood that an affiliate's participant will choose to watch the video.

In embodiments, the intelligent ad server 184 may be associated with a data facility containing user demographics 182. The intelligent ad server 184, in conjunction with the collaborative filter 194, may associate the media segments 102 submitted by a media owner 152 with certain characteristics, some of which may be recorded in a media tag 104. For instance, if the media segments 102 were a highlight of a disintegrating glacier, the affiliate 190 may provide information relating to the content of the media segments 102, the creator of the media segments 102, the advertisers associated with the media segments 102, the characteristics of previous viewers of the media segments 102, and other information associated with the media segments 102. For example, the affiliate 190 may indicate the media segments 102 is within the genre “politics,” is related to global warming, is a nature video, involves the glacial cap, has been played most by males in the age group of 35 to 55 year-olds, and the like. The collaborative filter 194 may serve as an intermediary between the advertiser user interface 142, the player user interface 164 and the facilitation system 186, including the intelligent ad server 184. Information derived from these facilities may be used by collaborative filtering algorithms. The affiliate 190 may receive recommendations from the collaborative filter facility 194 based at least in part on the results of applying the collaborative filter algorithms. The collaborative filter 194 may make recommendations to an affiliate 190 based on highly concurrent data, and an affiliate 190 may respond to the recommendation by including the recommended media segment 102 in its affiliate program.

In embodiments, an affiliate 190 may be a social networking site, a person participating in a social network, and the like. The social network may be a personal social network, a commercial social network host, a social network organized around a special interest, such as a blues music aficionados, or some other type of interest. For example, an affiliate 190 may be a social network of record collectors interested in blues musicians. The social network affiliate 190 may wish to post videos or video segments (i.e. media segments 102) pertaining to blues musicians, and the like, that it would like to monetize by making such tagged video available to interested social network participants. The social network affiliate 190 may download video segments from the media platform 100 through an affiliate user interface 192. Once received, the video segments may be integrated into the social network in whatever manner desired by the affiliate 190. The social network may provide a link to the media platform 100 where the video may be viewed. It may host the video content on its own platform for viewing, or provide some other means of accessing the video content that is initially derived from the media platform 100. This flexibility may provide an incentive for social networking affiliates 190 to participate in downloading the tagged content insofar as it may enable social network operators to increase the content available to the social network without having to invest the resources to create its own video content.

Through the use of a collaborative filter 194 and/or an intelligent ad server 184, video that is related to the affiliate's interest may be associated with advertisers selling products of relevance to the affiliate, of interest to consumers or persons associated with the affiliate, and so forth. Thus, when the social networking affiliate downloads video content to present on its participants, it may have associated advertising content that is of relevance to the affiliate's participants and users. This relevance may serve to increase both the advertising revenues and the revenues derived from the social network by increasing the likelihood that a social network participant will choose to watch the video.

In embodiments, the intelligent ad server 184 may be associated with a data facility containing user demographics 182. The intelligent ad server 184, in conjunction with the collaborative filter 194, may associate the video submitted by a media owner 152 with certain characteristics, some of which may be recorded in a media tag 104. For instance, if the video were a highlight of a blues guitarist, the affiliate 190 may provide information relating to the content of the video, the creator of the video, the advertisers associated with the video, the characteristics of previous viewers of the video, and other information associated with the video. For example, the social networking affiliate 190 may indicate the video is within the genre “music,” is a concert video, involves a blues guitarist, has been viewed most by males in the age group of 30 to 45 year-olds, and the like. The collaborative filter 194 may serve as an intermediary between the advertiser user interface 142, the player user interface 164 and the facilitation system 186, including the intelligent ad server 184. Information derived from these facilities may be used by collaborative filtering algorithms. The affiliate 190 may receive recommendations from the collaborative filter facility 194 based at least in part on the results of applying the collaborative filter algorithms. The collaborative filter 194 may make recommendations to an affiliate 190 based on highly concurrent data, and an affiliate 190 may respond to the recommendation by including the recommended video in its affiliate program.

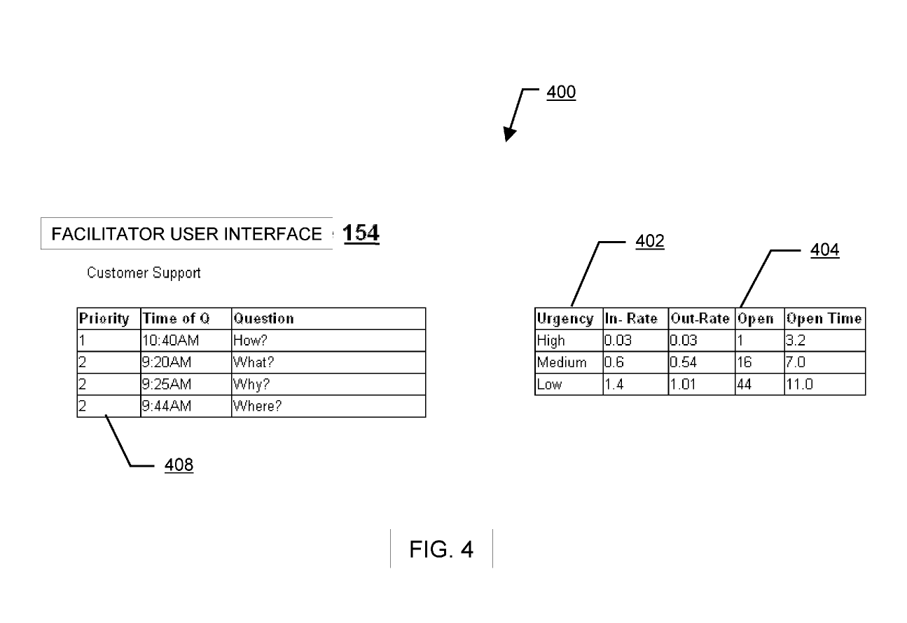

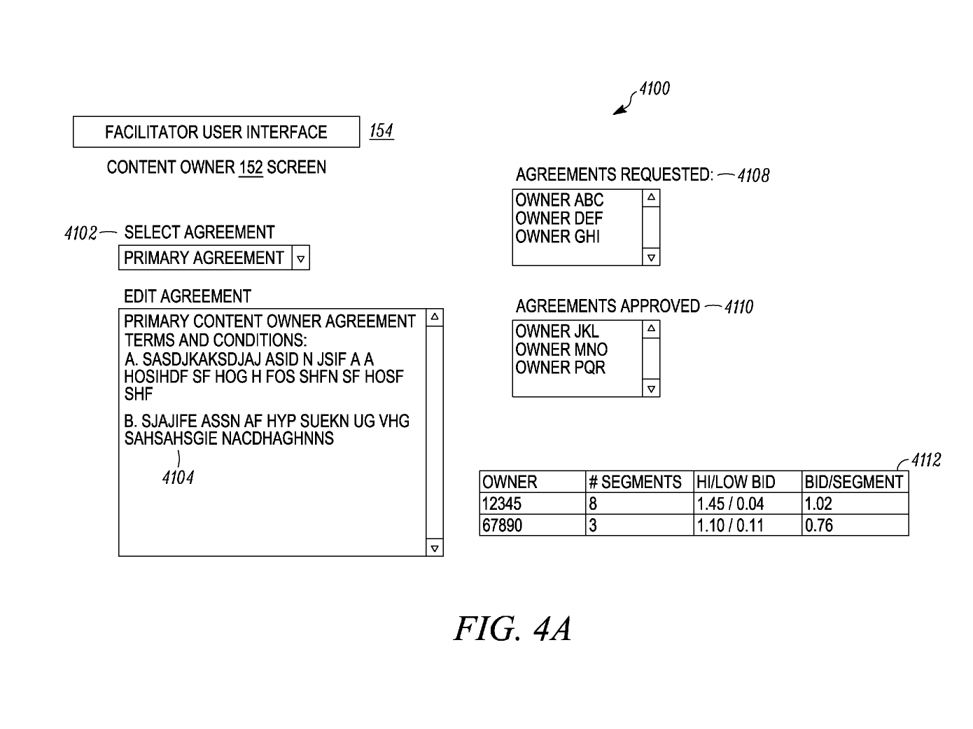

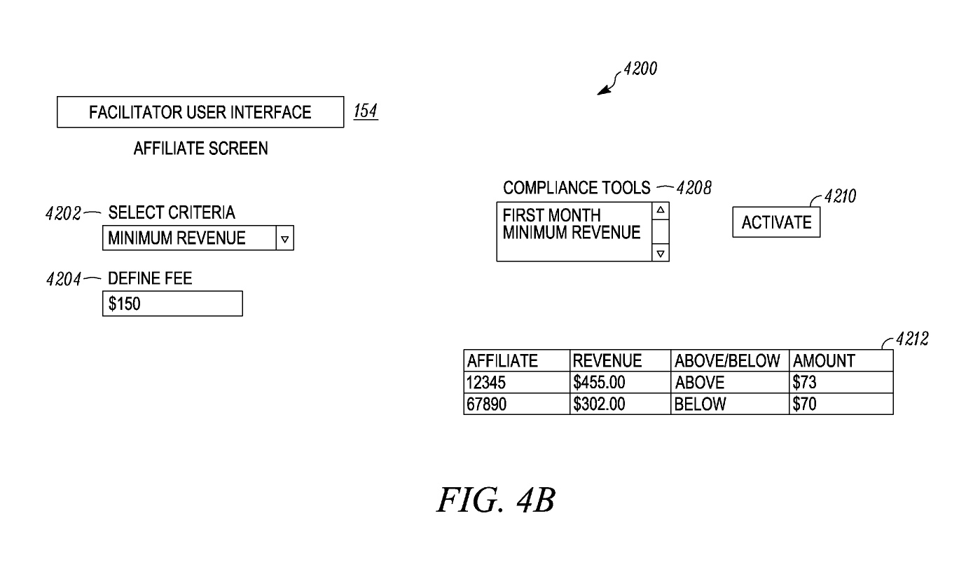

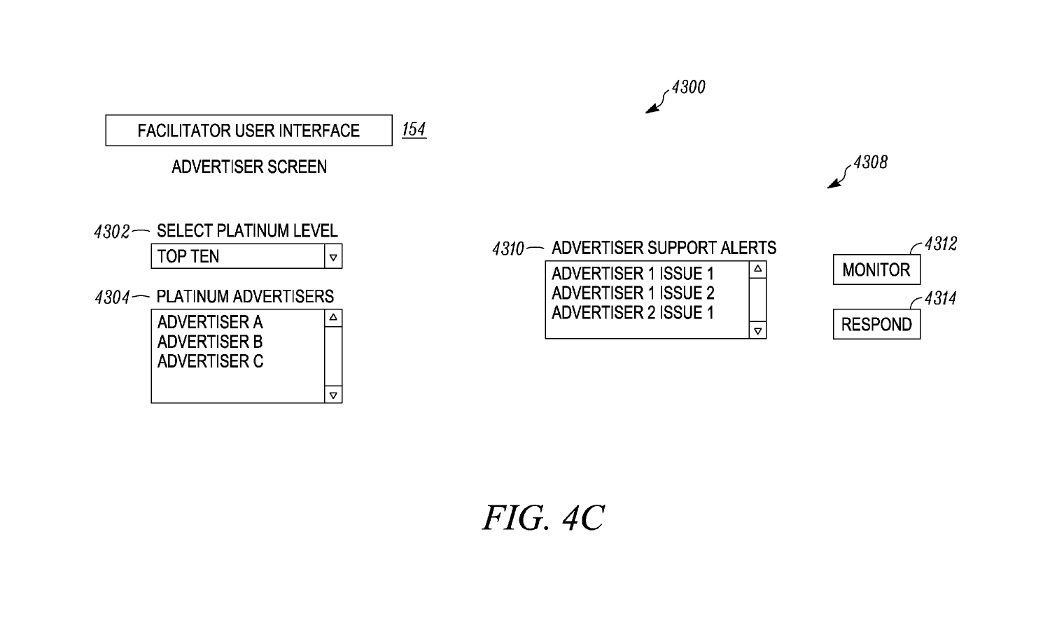

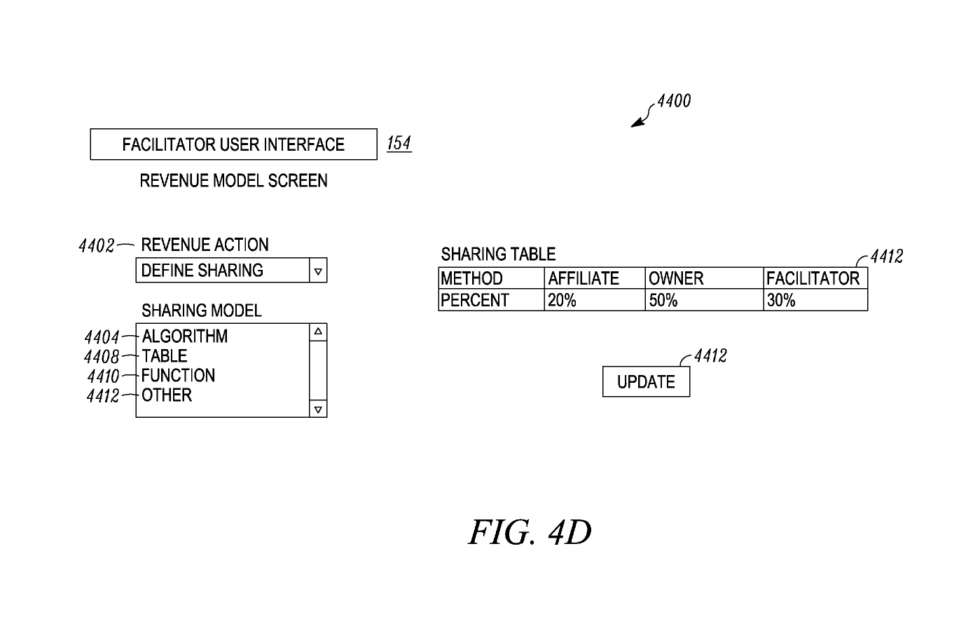

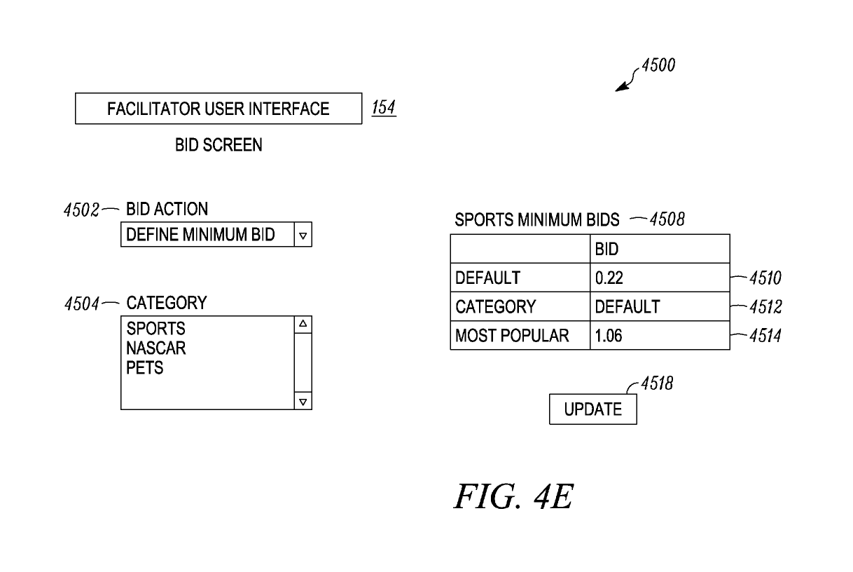

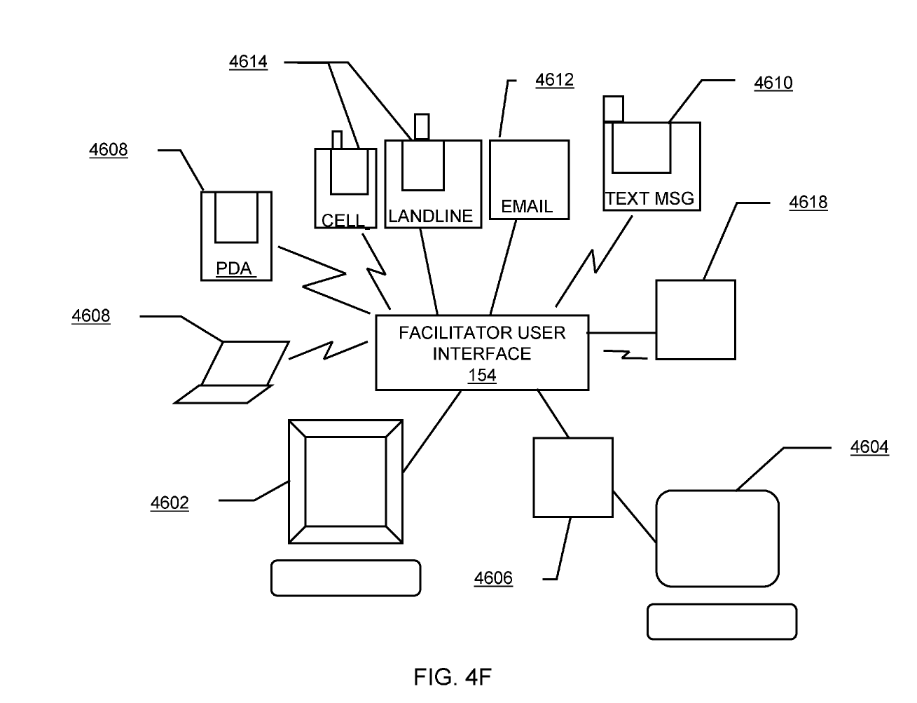

Referring to FIG. 4, a facilitator user interface 154 may facilitate supporting users of the media platform 100. In embodiments, an end user accessing the media platform 100 using a device 178 through the player interface 164, or through an affiliate 190 site may have questions about the media platform 100. The facilitator user interface 154 may provide one or more graphical user interface screen(s) 400 to facilitate a facilitator 158 ensuring timely and complete answers to such questions. In an example, the facilitator user interface 154 may provide tools 402 that a facilitator 158 can use to evaluate the number, frequency, urgency, and type of questions and comments from end users. The facilitator user interface 154 may also provide evaluation tools 404 to evaluate the rate, time to response, open time, and satisfaction level of responses by the media platform 100 to user questions.

The facilitator user interface 154 may also provide user response tools 408 that enable a facilitator 158 to manage the order and priority of responses to end user questions. As an example, user questions may be organized in a queue, with the oldest question typically having the highest priority for answering. A facilitator 158 may choose to prioritize a newer question such that it is answered before an older question. In this example, a facilitator 158 can ensure user questions the facilitator 158 deems more important are answered before less important questions.

The facilitator user interface 154 may also provide a direct response tool that facilitates a facilitator 158 directly responded to a user question. In an example, a facilitator 158 may select, through the facilitator user interface 154 a user question, such as a question in a queue of questions, and respond, (e.g. by email), to the question. The facilitator user interface 154 may automatically open an email reply addressed to the user when the question is selected by the facilitator 158.

Users of the media platform 100 may also provide information, such as suggestions for features, content, and enhancements that may be relevant to the facilitator 158. Users may also provide information about themselves (e.g. demographics), their preferences, their device 178 features, their ISP, and the like. In embodiments, the facilitator user interface 154 may provide the facilitator 158 with tools that allow a facilitator 158 to organize, view, and analyze user provided information. In an example, the media platform 100 may facilitate a user providing such information (through the player user interface 164, for example) while providing an automated response indicating receipt of the information. A facilitator 158 may use the facilitator user interface 154 to define the content and use of the automated response.

Referring to FIG. 4A, content owners 152 may also need to interact with a facilitator 158. In addition to supporting owner 152 and facilitator 158 interactions to address questions and information similarly to that described above for users, owners 152 may have other business dealings with a facilitator 158. The facilitator user interface 154 may provide a content owner support screen 4100. Content owners 152 may have to sign or accept agreements related to the use of the media platform 100 and the use of their content by the media platform 100. The facilitator user interface 154 may allow a facilitator 158 to view, modify, or otherwise establish 4102 an agreement 4104 for a content owner 152. In addition the facilitator user interface 154 may provide the facilitator 158 a way to view status of an agreement signing process with a content owner 152. In an example, the facilitator user interface 154 may provide a display, such as a list, of the recent owner 152 agreement requests 4108 and approvals 4110.

The facilitator user interface 154 may also provide the facilitator 158 with tools, such as display and statistical analysis tools, to monitor the activity of content owners 152. In an example, the facilitator user interface 154 may display for the facilitator 158 a table 4112 showing aspects of content owner 152 activity such as number of media segments 102 uploaded, advertisement 112 bid rate, bid prices, price per segment, and the like. A facilitator 158 may use this information to make offers premium services to a content owner 152 that may reward or otherwise encourage the content owner 152 to achieve higher performance within the media platform 100. The facilitator user interface 154 may highlight a subset of content owners 152 achieving a predefined level of activity such that the facilitator 158 may have the option of further interacting with them.

The facilitator user interface 154 may also provide tools for a facilitator 158 to resolve and/or validate ownership of uploaded content before the media platform 100 adapts the content such as to a tagged media segment 102. In embodiments, the facilitator user interface 154 may provide a facilitator 158 with tools for viewing at least a portion of uploaded content based on certain criteria related to the uploaded content (e.g. size, genre, tags, and other aspects of the uploaded content) and/or owner 152 (e.g. history, upload statistics, and the like). The facilitator user interface 154 may, in addition to displaying a portion of the uploaded content, provide a means for flagging the content for further review. For example, a facilitator 158 may review a portion of uploaded content and determine that the content may include copyrighted material, or material that has recently been uploaded by another owner 152. The facilitator user interface 154 may provide a tool by which the uploaded content can be flagged such that it may not be converted to a tagged media segment 102 unless it has been thoroughly reviewed (e.g. for ownership validation).

The facilitator user interface 154 may provide the facilitator 158 with tools for defining criteria, such as criteria for flagging uploaded content as described above. In embodiments, the facilitator 158 may use the facilitator user interface 154 to select aspects of uploaded content, such as combinations of tags, and/or genre, and/or size, and/or format, etceteras such that when he media platform 100 detects one or more of these aspects or combinations of aspects, the uploaded content may be forwarded to a queue for review by the facilitator 158. The facilitator user interface 154 may also provide tools for the facilitator 158 to manage this queue. In an example, the media platform 100 may detect a selected aspect of uploaded content as herein described. The facilitator 158 may use the facilitator user interface 154 to review the queue of content for review and assign individual entries in the queue (or groups of entries) to specific reviewers. The facilitator user interface 154 may also allow the facilitator 158 to group entries in this queue based on one or more aspects of the uploaded content and or content owner 152. The facilitator 158 may then, through the facilitator user interface 154 take an action on the group such as accepting the group for use in the media platform 100.

The facilitator user interface 154 may facilitate a facilitator 158 managing and interacting with affiliates 190. In addition to supporting affiliate 190 and facilitator 158 interactions to address questions and information similarly to that described above for users and content owner 152, affiliates 190 may have other business dealings with a facilitator 158. Affiliates 190 may have to sign agreements related to the use of the media platform 100 and the use of content within the media platform 100. The facilitator user interface 154 may allow a facilitator 158 to view, modify, or otherwise establish an agreement for an affiliate 190. In addition the facilitator user interface 154 may provide the facilitator 158 a way to view status of an agreement signing process with an affiliate 190. In an example, the facilitator user interface 154 may provide a display, such as a list, of the recent affiliate 190 agreement requests and approvals.

The facilitator user interface 154 may also provide the facilitator 158 with tools, such as display and statistical analysis tools, to monitor the activity of affiliates 190. In an example, the facilitator user interface 154 may display a chart showing aspects of affiliate 190 activity such as number of media segments 102 accessed, breakdown by aspects of the tagged media segments 102 accessed by the affiliate, revenue per time period (e.g. per day, week, month), revenue rate per tagged media segment 102, and the like. A facilitator 158 may use this information to offer premium services to affiliates 190 that may reward or otherwise encourage the affiliate 190 to achieve higher performance within the media platform 100. The facilitator user interface 154 may highlight a subset of affiliates 190 achieving a predefined level of activity such that the facilitator 158 may have the option of further interacting with them.

Referring to FIG. 4B, the media platform 100 may include tools for verifying compliance of an affiliate 190 agreement. The facilitator user interface 154 may include a screen 4200 for a facilitator 158 to manage affiliate 190 compliance tools, and use the results of these tools to further manage affiliates 190. In embodiments, the facilitator 158 may establish criteria of a minimum revenue per time (e.g. per week) 4202 that an affiliate 190 must generate for the facilitator 158 to avoid the affiliate 190 being charged a fee 4204. The facilitator user interface 154 may provide a screen 4200 by which the facilitator 158 can establish and activate an affiliate 190 compliance tool for these minimum revenue criteria. In an example, the facilitator 158 may use the facilitator user interface 154 screen 4200 to establish the criteria 4202, apply the criteria to an affiliate 190 compliance tool 4208, activate the tool 4210, and review the results 4212 of the activated tool. The facilitator 158 may then use another aspect of the facilitator user interface 154 (such as an email interface) to notify any affiliate 190 included in the results of the activated affiliate 190 compliance tool that they are not in compliance with the criteria.

The media platform 100 may include an affiliate 190 support system that defines levels of support based on certain criteria. The facilitator user interface 154 may provide tools for the facilitator 158 to define these criteria. The facilitator user interface 154 may also provide tools for the facilitator 158 to manage affiliate 190 support levels. In embodiments, the media platform 100 may include affiliate 190 elevated support levels that include notifying the facilitator 158 when an affiliate 190 associated with an elevated support level submits a request for support. In an example the facilitator 158 may define a ‘platinum’ support level as being associated with any affiliate 190 that is one of the top 10 revenue producers. If a ‘platinum’ affiliate 190 requests support through the affiliate user interface 192, the facilitator 158 may be notified of this request through the facilitator user interface 154. The facilitator user interface 154 may include an alert section in which ‘platinum’ affiliate 190 support requests are displayed. The facilitator user interface 154 may allow the facilitator 158 to choose to monitor the progress of this support request, or take some other action such as contact the affiliate 190.

The facilitator user interface 154 may facilitate a facilitator 158 managing and interacting with advertisers 144. In addition to supporting advertiser 144 and facilitator 158 interactions to address questions and information similarly to that described above for users and content owner 152, advertisers 144 may have other business dealings with a facilitator 158. Advertisers 144 may have to sign or accept agreements related to the use of the media platform 100 and the use of their advertisements 112 within the media platform 100. The facilitator user interface 154 may allow a facilitator 158 to view, modify, or otherwise establish an agreement for advertisers 144. In addition the facilitator user interface 154 may provide the facilitator 158 a way to view status of an agreement signing process with advertisers 144. In an example, the facilitator user interface 154 may provide a display, such as a list, of the recent advertiser 144 agreement requests and approvals.

The facilitator user interface 154 may also provide the facilitator 158 with tools, such as display and statistical analysis tools, to monitor the activity of advertisers 144. In an example, the facilitator user interface 154 may display for the facilitator 158 a chart showing aspects of the activity of advertisers 144 such as number of advertisements 112, number of bids, number of successful bids, average bid, and the like. A facilitator 158 may use this information to offer premium services to advertisers 144 that may reward or otherwise encourage the advertisers 144 to achieve higher performance within the media platform 100. The facilitator user interface 154 may highlight a subset of advertisers 144 achieving a predefined level of activity such that the facilitator 158 may have the option of further interacting with them.

The media platform 100 may include tools for verifying compliance of an advertiser 144 agreement. The facilitator user interface 154 may facilitate a facilitator 158 managing advertiser 144 compliance tools, and using the results of these tools to further manage advertisers 144. In embodiments, the facilitator 158 may establish criteria of a minimum revenue per time (e.g. per week) that an advertiser 144 must generate for the facilitator 158 to avoid the advertiser 144 being charged a fee. The facilitator user interface 154 may provide a screen by which the facilitator 158 can establish and activate an advertiser 144 compliance tool for these minimum revenue criteria. In an example, the facilitator 158 may use the facilitator user interface 154 screen to establish the criteria, apply the criteria to an advertiser 144 compliance tool, activate the tool, and review the results of the activated tool. The facilitator 158 may then use another aspect of the facilitator user interface 154 (such as an email interface) to notify any advertiser 144 included in the results of the activated advertiser 144 compliance tool that they are not in compliance with the criteria.

Referring to FIG. 4C, the media platform 100 may include an advertiser 144 support system that defines levels of support based on certain criteria. The facilitator user interface 154 may provide tools such as a screen 4300 of tools for the facilitator 158 to define these criteria. The facilitator user interface 154 may also provide tools for the facilitator 158 to manage advertiser 144 support levels. In embodiments, the media platform 100 may include advertiser 144 elevated support levels that include notifying the facilitator 158 when an advertiser 144 associated with an elevated support level submits a request for support. In an example the facilitator 158 may define a ‘platinum’ support level 4302 as being associated with any advertiser 144 that is one of the top 10 revenue producers 4304. If a ‘platinum’ advertiser 144 requests support through the advertiser user interface 142, the facilitator 158 may be notified of this request through the facilitator user interface 154. The facilitator user interface 154 may include an alert section 4308 in which ‘platinum’ advertiser 144 support requests 4310 are displayed. The facilitator user interface 154 may allow the facilitator 158 to choose to monitor the progress of this support request 4312, or take some other action such as contact 4314 the advertiser 144.

The facilitator user interface 154 may support the facilitator 158 performing security related functions. In embodiments, security features such as passwords, user names, access levels, authorization requirements, and the like may be administered through the facilitator user interface 154. In an example, a facilitator 158 may define an access level that allows a user that is authorized at the high access level to change or control functional elements of the media platform 100. A user authorized at an access level, such as “administrator” may be able to change how the reconciliation module 134 divides revenue among the facilitator 158, affiliate 190, and content owner 152.

The facilitator user interface 154 may provide the facilitator 158 with security related information about the media platform 100 such as attempted intrusions, results of security audits, number and type of logins through the facilitator user interface 154 (e.g. by authorized users and by other facilitators 158). The facilitator user interface 154 may display this information automatically such as when a facilitator 158 logs into the facilitator user interface 154, from time to time such as each hour, or upon request by the facilitator 158.

The facilitator user interface 154 may allow the facilitator 158 to review security settings for one or more of the elements of the media platform. In an example, the facilitator 158 may use the facilitator user interface 154 to review the security settings of the intelligent advertisement server 184.

Operation, maintenance, and management of the media platform 100 may be a responsibility of the facilitator 158. The facilitator user interface 154 may provide tools by which the facilitator 158 addresses these responsibilities. The facilitator user interface 154 may allow the facilitator 158 to setup the facilitation system 186, the collaborative filter 194, the media transaction monitor 162, the reconciliation module 134, rules 124, formats 118, the dynamic attachment facility 132, placement 128 rules, the transaction monitor 138, the intelligent advertisement server 184, the advertiser user interface 142, the affiliate user interface 192, the owner user interface 148, rights management 198, tags 104, and other elements and features of the media platform 100.

Referring to the example of FIG. 4D, the facilitator 158 may setup the revenue model (or other compensation scheme) associated with the transaction facility 138. The facilitator 158 may use the facilitator user interface 154 revenue model screen 4400 to define 4402 the revenue sharing or other arrangements among the an affiliate 190, media segment owner 152, media platform facilitator 158 and/or other entities that may be enacted when an advertiser 144 bid is accepted by the transaction facility 138. In setting up the transaction facility 138, the facilitator user interface 154 may provide the facilitator 158 the choice of using an algorithm 4404, table 4408, function 4410, or other facility 4412 adapted to apportion revenue or another form of compensation. In an example, the facilitator 158 may select a table 4404 for the revenue model. The facilitator user interface 154 may provide the facilitator 158 the option of defining entries 4414 in the table that will effect how the revenue model apportions revenue, and updating 4418 the transaction facility 138.

The facilitator user interface 154 may also provide the facilitator 158 with tools that facilitate defining data facilities of the media platform 100. In an example, the facilitator user interface 154 may display a setup screen for defining the format and allowable content of data fields used in tags 104 such as the media segment tag 104A. Through the media segment tag 104A setup screen of the facilitator user interface 154, the facilitator 158 may define a list of categories for associating with a media segment 102.

Referring to FIG. 4E, the facilitator 158 may use aspects of the facilitator user interface 154 to set minimum bid amounts for placement 128 of advertisements 112 with certain tagged media segments 102. In embodiments, the facilitator 158 may use a bid configuration screen 4500 of the facilitator user interface 154 to set minimum bid amounts based on one or more criteria of a tagged media segment 102. In an example, a facilitator 158 may specify that the top 5 most popular tagged media segments 102 in each category (e.g. pets, sports, college life, kids, cars, and other categories that may be used to group tagged media segments 102) require a minimum bid which is different from minimum bids for other tagged media segments 102. The facilitator 158 may select a function such as set bit amount 4502, then select the category 4504 and define 4508 minimum bid amounts. The facilitator user interface 154 may include entries for minimum default 4410, category specific 4512, and most popular 4514 bid amounts. The facilitator user interface 154 bid configuration screen 4500 may also include a minimum bid amount update 4518 button.

The facilitator user interface 154 may enable access to rules 124. A facilitator 158 may access rules 124 through the facilitator user interface 154 such that an individual rule 124 may be activated, deactivated, modified, or selectively enforced. In an example, a rule 124 requiring content owners 152 using more than a predetermined amount of media segment 102 storage to pay a fee if the revenue generated by their media segments 102 is below a threshold, may be deactivated. The facilitator user interface 154 may enable the facilitator 158 to select this option from a menu of rule 124 related commands. In another example, facilitator 158 may reduce the fee or reduce the threshold for the fee by the selecting the appropriate menu option on the facilitator user interface 154.

In embodiments, the facilitator 158 may be responsible for ensuring quality control and compliance with internal procedures. The facilitator user interface 154 may facilitate the facilitator 158 in executing these responsibilities by providing tools for viewing, analyzing, and reporting quality related data. In an example, the facilitator user interface 154 may have one or more quality control and monitoring screens for displaying and interacting with the quality data. One such screen of the facilitator user interface 154 may display a number of advertisements 112 that had the winning bid for placement 128 with a media segment 102 but were not confirmed as placed due to another problem such as a communication problem with the player device 178. In another example, the facilitator 158 may use a screen of the facilitator user interface 154 to display transaction data in associated elements of the media platform 100. The facilitator 158 may view reconciliation module 134 transactions associated with an advertiser 144 compared to transaction facility 138 transactions for the same advertiser 144. Any discrepancy may indicate to the facilitator 158 that the advertiser 144 account needs further review.

The facilitator user interface 154 may provide tools for ensuring the media platform 100 meets regulations such as decency laws, age limits, and the like. In embodiments, the facilitator user interface 154 may provide tools that the facilitator 158 can use to define actions to be taken on uploaded content based on certain criteria. For example, the facilitator user interface 154 may enable the facilitator 158 to require all uploaded content that the content owner 152 claims to be appropriate for children to be reviewed by a human prior to being converted to a tagged media segment 102. The facilitator user interface 154 may further allow the facilitator 158 to define a list of trusted content owners 152 that can update content and tag it for children such that their content may not be reviewed prior to being converted to tagged media segments 102.

In embodiments, the facilitator 158 may use aspects of the facilitator user interface 154 to take actions related to agreements with affiliates 190, content owners 152, and advertisers 144. In an example, the facilitator 158 may change revenue sharing terms, stop accepting content or advertisements, stop revenue sharing, stop advertisement placement, remove content or advertisements, limit or prevent access by affiliates 190 to tagged media segments 102, and other such actions as needed to ensure integrity of the media platform 100.

The facilitator user interface 154 may provide tools to the facilitator 158 for specifying, activating, and managing promotions such as limited trial offers. In an example, the facilitator 158 may use an aspect of the facilitator user interface 154 to make available a limited time trial offer to advertisers 144. The facilitator 158 may define the terms of the trial, such as the number of advertisements, number of placements, duration of the trial, criteria of tagged media segments 102 to which advertisements 112 submitted through the trial may be attached, and other aspects and features of the trial offer. The facilitator user interface 154 may provide one or more screens associated with such trial offers through which the facilitator 158 defines and manages the offers. The facilitator 158 may also use the facilitator user interface 154 to adjust duration of a trial offer, or to stop or cancel an offer.

The facilitator user interface 154 may further include tools that the facilitator 158 can use to monitor activity associated with a trial offer. In an example, the facilitator 158 may use the facilitator user interface 154 to display a report of the number of advertisements 112 accepted in the trial offer, information about the advertisers 144, and other such information.

Referring to FIG. 4F, the facilitator user interface 154 may be adapted to accept input from a variety of facilitator 158 input devices. In embodiments, the facilitator user interface 154 may accept input from a directly connected facilitator user interface 154 console 4602, a networked computer such as a personal computer 4604 through a hub 4606, a wireless devices such as a PDA or laptop computer 4608, a text messaging system 4610, an email system 4612, voice input from a landline phone or a mobile phone 4614, or other such input device 4618. In an example, a facilitator 158 may send a text message 4610 to the facilitator user interface 154 from a cellular phone. The text message 4610 may include a command to send a text message list of predefined advertiser 144 messages to the phone of facilitator 158. The advertiser may select one of these messages and send a new text message 4610 to the facilitator user interface 154 identifying the message to send to all advertisers (e.g. wishing them a happy holiday). The facilitator 158 may alternatively use a networked computer to select a message for advertisers from a displayed list of predefined messages.

The facilitator 158 may use aspects of the facilitator user interface 154 to define and manage tagged media segment 102 and/or advertisement 112 licensing programs. In embodiments, the facilitator 158 may define a licensing program for advertisements 112 that may provide the advertiser with benefits such as additional exposure for a fee. In an example, the facilitator 158 may use the facilitator user interface 154 to allow a non-profit entity, or an academic entity to download tagged media segments 102 and/or advertisements 112 for limited use such as promoting the non-profit entity or for inclusion in a class educational project. The facilitator 158 may arrange for facilitator 158 revenue and/or content owner 152 revenue to be shared with the non-profit entity.

The facilitator 158 may establish licensing programs within the media platform 100 into which content owners 152, advertisers 144, and affiliates 190 may opt-in and/or opt-out. The facilitator user interface 154 may allow the facilitator 158 to establish and monitor such licensing programs and participant activity.

The facilitator 158 may use aspects of the facilitator user interface 154 to manage finances associated with the media platform 100. In embodiments, the facilitator 158 may view financial reports such as profit and loss, cash flow, and other reports using a financial report screen of the facilitator user interface 154. The facilitator 158 may use the facilitator user interface 154 to see where revenue generated through the media platform 100 is going. In an example, the facilitator 158 may display a report breaking down revenue from the top 10 most popular tagged media segments 102 each day. In another example, the facilitator 158 may use the facilitator user interface 154 to display statistics associated with advertisements 112 such as potential revenue associated with unfulfilled advertisement 112 placement 128 bids.

The facilitator user interface 154 may also facilitate the facilitator 158 complying with SEC regulations. The facilitator 158 may use the facilitator user interface 154 to list pertinent dates and actions associated with compliance with SEC or other governmental regulations.

The facilitator user interface 154 may provide the facilitator 158 with tools to monitor activity in one or more on-line blogs related to the media platform 100, or activity related to other aspects of the facilitator 158 business. In embodiments, the facilitator 158 may identify a list of blogs for monitoring and may use aspects of the facilitator user interface 154 to display relevant portions of identified blogs. In an example, the facilitator 158 may identify a blog which may include comments directed toward content owners 152. The facilitator 158 may use the facilitator user interface 154 to display portions of the blog that include keywords defined by the facilitator 158.

The facilitator user interface 154 may also facilitate integrating 3^{rd} party software such as graphical editors, video mixers, audio dubbing, text overlay editors, and other software related to the media platform 100. The facilitator 158 may use the facilitator user interface 154 to configure the media platform 100, or any website screens associated with the media platform 100, to enable the integrated use of 3^{rd} party software.

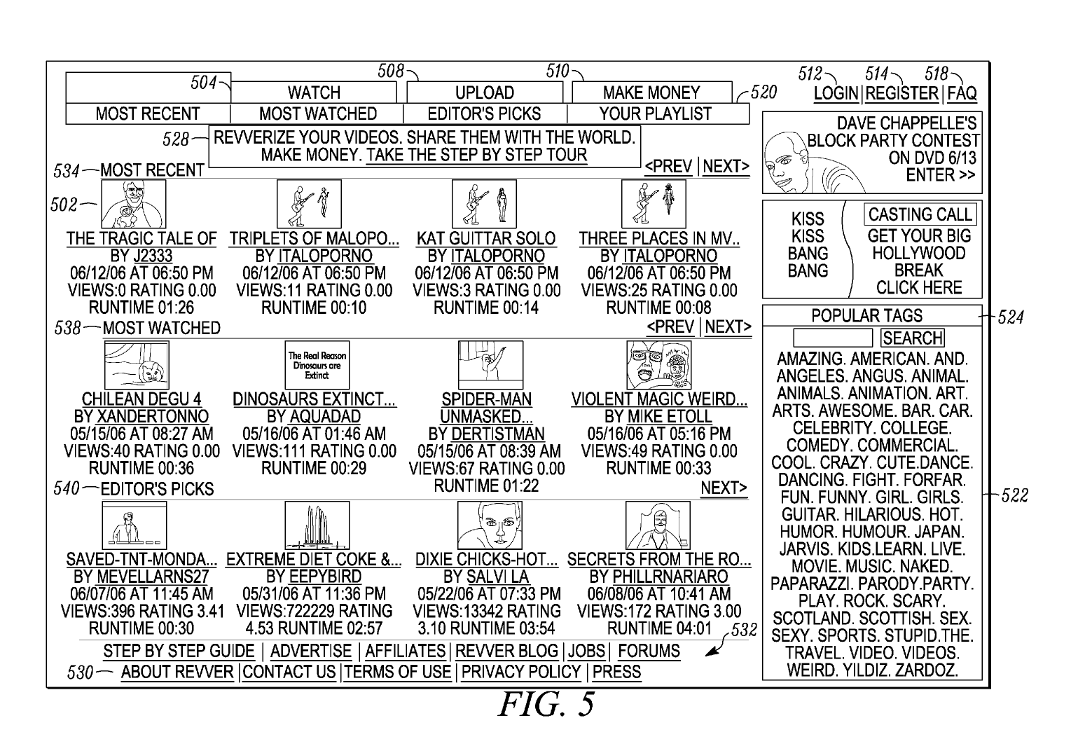

Referring to FIG. 5, a depiction of a web browser view of the user interface 164 of the media platform 100, the user interface 164 may include thumbnails 502 of various tagged media segments 102, and menus. The menus may include selections for watching 504 tagged media segments 102, uploading content 508 to the media platform 100, sharing revenue 510 associated with tagged media segments 102, logging into 512 the media platform 100, registering 514, reviewing frequently asked questions 518, setting up and accessing an end user 100 playlist 520, selecting a text tag 522 associated with tagged media segments 102, searching 524 for tagged media segments 102 that match a text tag entered by the end user 100, instructions 528 for using the media platform 100, contacting 530 a facilitator 158, and other menus 532 related to the media platform 100.

A thumbnail 502 displayed through the user interface 164 may include an image selected from a tagged media segment 102 associated with the thumbnail 502. The thumbnails 502 may be arranged in predefined groups such as most recent 534, most watched 538, editor's picks 540, and other groupings that may appeal to end users 110. From time to time the groupings may reflect contemporary topics such as a presidential election, a sports event (e.g. the world cup), and the like.

An end user 110 may select a thumbnail 502 to view the tagged media segment 102 associated with it. The tagged media segment 102 may play on the client device 178 through which the end user 110 has accessed the user interface 164 of the media platform 100.

An end user 110 using a client device 178 such as a wireless client 178B may use a web browser of the wireless client 178B to access the user interface 164. A wireless client 178B such as a cellular phone, PDA, or laptop computer may include a web browser through which an end user 110 may communicate with the media platform 100.

Additionally or alternatively, an end user 110 may communicate with the media platform 100 by accessing the user interface 164 in other ways. For example, an end user 110 may send an email to an email address associated with the user interface 164 such that the user interface 164 may interpret aspects of the email to determine what action to take. The end user 110 may send an email with a subject “search” and a body that includes text strings. The user interface 164 may interpret the email to perform a search of tagged media segments 102 to locate segments with tags that match the text strings included in the body of the email. The media platform 100 may provide a list of matching tagged media segments 102 to the user interface 164 which may, through an email reply facility, send the list in a reply email to the end user 110.

The end user 110 and user interface 164 may further communicate through email to facilitate sending a tagged media segment 102 and attached advertisement 112 to the client 178. The end user 110 may, for example, send an email to the email address associated with the user interface 164 of the media platform 100 with a subject of “Select” and a body identifying one of the tagged media segments 102 from the list of tagged media segments 102 emailed to the end user 110 by the user interface 164.

The end user 110 may receive a further reply email that may have one or more files attached that includes the tagged media segment 102 and attached advertisement 112.

In this way, the end user 110 may use an email system to communicate with the media platform 100 through the user interface 164 without a web browser. Other configurations of aspects of email are possible such as including the text strings for searching in the subject of the email, or including the search command in the body of the email. Likewise the reply email from the media platform 100 may include a link to the tagged media segment 102 instead of attaching a file including the tagged media segment 102 and attached advertisement 112. Many other combinations of syntax, position of text strings, attachments of files, format of attachments, and the like are possible and should be included within the scope of this disclosure. As an example, a tagged media segment 102 may be a text type segment and may include a text type attached advertisement 112. In such an example, the entire tagged media segment 102 and attached advertisement 112 may be included in the body of a reply email from the media platform 100.

As an alternative to email and web browsers, an end user 110 may communicate with the media platform 100 through the user interface 164 by exchanging instant messages that may include text and images to be interpreted by the user interface 164 and end user 110 similarly to email as disclosed herein. The instant message system of the client 178 may include capabilities of transferring files such that the tagged media segment 102 and attached advertisement 112 may be transmitted via the instant message system to the client 178 so that the end user may view them on the client 178. The client 178 may be a wireless client 178B such as a cell phone, a computer 178A, or other client 178 adapted to communicate by instant messaging.

An end user 110 may interact with more than one type of client 178 such that the end user 110 may select to use one client 178 for communicating with the media platform 100 and another client for viewing the tagged media segment 102. In an example, the end user 110 may communicate with the media platform 100 through a web browser of a computer client 178A for selecting and accessing tagged media segments 102. However, the end user 110 may choose to view the selected tagged media segment 102 with a digital video player. The end user 110 may use the user interface 164 to specify to the media platform 100 a type of viewer for a tagged media segment such that the end user 110 would receive the tagged media segment 102 in a format compatible with the type of viewer the end user 110 specified.

An end user 110 may interact with a client 178 such as a digital music player and may indicate to the media platform 100 to provide tagged media segments 102 formatted for use in a digital music player such as an MP3 player. The media platform 100 may respond to search and download requests with a subset of available tagged media segments 102 wherein the subset is suitable for the client 178. In an example, the end user 110 may have identified the viewer type as a digital music player in one or more requests for tagged media segments 102. The media platform 100 may provide a response that may include a list, such as a playlist, of tagged media segments 102 that can be used on a digital music player. The end user 110 may select to download a portion of the tagged media segments 102 on the playlist such that the downloaded tagged media segments 102 may be further downloaded to the digital music player. In such an example, the end user 110 may listen to the downloaded tagged media segments 102 while commuting or during some other activity or situation that may not allow the end user 110 to be interacting with the media platform 100.

The media platform 100 may make tagged media segments 102 available to end users 110 through other clients 178 such as radio (e.g. satellite radio). In embodiments, the user interface 164 of the media platform 100 may be adapted to facilitate an end user 110 accessing tagged media segments 102 through a radio client 178C. The user interface 164 may receive signals from the radio client 178C indicating an end user 110 selection of a tagged media segment 102, a type of tagged media segment 102 (e.g. sports), tagged media segments 102 in a specific language, tagged media segments 102 associated with the location of the radio client 178C (such as local interest tagged media segments 102), and the like. The media platform 100 may send tagged media segments 102 that substantially match the end user 110 selection to the radio client 178C. Alternatively, the media platform 100 may send tagged media segments 102 to the radio client 178C with tags containing information (such as metadata) that the radio client 178C can interpret and group into listening channels that the end user 110 may select.

The media platform 100 may send a tagged media segment 102 to an end user in a standard format. However, an end user 110 may identify a type of viewer to the media platform 100 with each request to view a tagged media segment 102. The end user 110 may also be known to the media platform 100 such that the media platform 100 may associate an end user 110 specific viewer type with the end user 110. The media platform 100 may send a tagged media segment 102 to the end user 110 in the end user 110 specific viewer format unless the end user 110 requests a different format.

The end user 110 may be known to the media platform 100 in a variety of ways. The end user 110 may login to the media platform 100 through the user interface 164 when the end user 110 initiates contact with the media platform 100. In this way communication between the logged-in end user 110 and the media platform 100 may take advantage of any information known to the media platform 100 about the end user 110. The end user 110 may contact the media platform 100 through a specific client 178 that has a unique internet address, or reply email address, or instant message id, or caller id, or other self identifying aspect detectable by the user interface 164. The user interface 164 may maintain a record of prior contact and communication activity associated with the unique identifier of the client 178 that the user interface 164 and/or the media platform 100 may reference during communication with an end user 110 using the unique client 178.

In an example, the media platform 100 may reference an end user 110 profile created by the end user 110 and or inferred by the media platform 100 as herein disclosed to determine the end user 110 specific viewer format. To facilitate controlling the content of an end user 110 profile, the user interface 164 may include menus or other facilities for allowing an end user 110 to specify aspects of an end user 110 profile such as a specific viewer type.

An end user 110 may also identify to the media platform 100 one or more client 178 identifiers as herein disclosed such that the media platform 100 may associate communication with the one or more client 178 identifiers with the end user 110. This information may be provided by the end user 110 in an end user 110 profile, or may be inferred by the media platform 100 through analysis of communication with an end user 110. In an example, an end user 110 may login to the media platform 100 from more than one uniquely identified client 178 such that the media platform 100 may associate the uniquely identified clients 178 with the end user 110.

The user interface 164 of the media platform 100 may detect such login/client 178 activity and may present to the end user 110 an option of confirming the inferred association. In this way, the media platform 100 may collect demographic type information about the end user 110 while making it easier for the end user 110 than requiring the end user 110 to provide a list of unique client 178 identifiers to be included in an end user 110 profile.

An end user 110 may share tagged media segments 102 with friends and others in a variety of ways including direct transfer of a downloaded tagged media segment 102. The direct transfer may be executed by the end user 110 by email, email attachment, instant messaging, peer-to-peer file transfer, ftp, non-volatile memory device (CD-ROM, floppy disk, memory card, memory key, removable hard drive, and the like), common network storage, website, social networking web page, and other electronic transfer means.

An end user may share tagged media segments 102 with friends and others through indirect means such as sending a link to a tagged media segment 102 in email or instant message, by posting a link to a tagged media segment 102 on a social networking web page, by posting a link to a tagged media segment 102 on a website, and the like.

The media platform 100 may include a communication facility that may allow an end user 110 to send access information for a tagged media segment 102 to another person. In an example, an end user 110 may provide an email address of another person through the user interface 164 to the media platform 100 and associate that email address with a tagged media segment 102. The media platform 100 may send an email containing access information (such as a hyperlink) for the associated tagged media segment 102 to the provided email address.

An end user 110 with a tagged media segment 102 downloaded to a digital music player may transfer the tagged media segment 102 from the digital music player to a compatible electronic device of the friend or other, such as through a USB port with compatible download software.

The media platform 100 may include automated facilities for notifying end users 110 of recently uploaded tagged media segments 102. The automated facilities may reference a direct or inferred profile of an end user 110 when notifying the end user 110 of recent tagged media segments 102. In this way preferences established in the end user 110 profile may be used by the media platform 100 in determining which tagged media segments 102 to notify the end user 110 about. An end user 110 may select to opt-in or opt-out of such automated facilities. An end user with a plurality of clients 178 may select to opt-in for one or more of the clients 178 while opting-out for one or more other of the clients 178. In an example, an end user 110 may opt-in to being notified of new politically oriented tagged media segments 102 on their cell phone client 178B.

The automated facilities may include pushing tagged media segments 102 to one or more end user 110 clients 178. The automated facilities may also reference the end user 110 profile to push only the subset of recent tagged media segments 102 that substantially match the preferences of the end user 110. The end user 110 preferences may include client 178 and tagged media segment 102 preferences as well as client 178 and schedule preferences. For example, an end user 110 may prefer to receive tagged media segments 102 at a business computer client 178A during business hours, at a wireless client 178B during commuting hours, and at a home computer client 178A at other times. The end user 110 may directly specify this schedule of client 178 preference or the media platform 100 may infer this based on communication experience with the end user 110.

The media platform 100 may also include selection facilities for an end user 110 to specify preference of attributes, tags, content, language, and other aspects of advertisements 112 similarly to specifying aspects of tagged media segments 102. For example, an end user 110 may prefer to not receive tagged media segments 102 with attached advertisements 112 for beer. The user interface 164 may facilitate an end user 110 specifying this preference in an end user 110 profile, for example. Automated facilities of the media platform 100 may reference this aspect of an end user 110 profile and seek to avoid sending tagged media segments 102 with attached beer advertisements 112 to the end user 110.

Similarly to specifying a schedule of client 178 use, an end user 110 may specify a schedule of tagged media segment 102 and advertisement 112 preference. In an example, an end user 110 may specify a schedule to the automated facilities of the media platform 100 through the user interface 164. The end user 110 may specify tagged media segments 102 with adult content not be pushed to the end user 110 client 178 during certain hours of the day, such as during business hours. The end user 110 may similarly specify advertisements 112 for food to not be pushed to the end user 110 client 178 during the afternoon. The user interface 164 of the media platform 100 may include menus, setup screens, preference upload commands, and the like to facilitate an end user 110 managing their preferences including preferences associated with an end user 110 profile.

The user interface 164 may include facilities for the end user 110 to establish an automated search of tagged media segments 102. An end user 110 may select one or more criteria associated with tagged media segments 102 that may be applied to an automated search of available tagged media segments 102. The user interface 164 may include end user 110 controls associated with the automated search such as frequency of searching, schedule for notifying the end user 110 of the results, client 178 to receive the results, content of the notification (e.g. titles of tagged media segments 102 only, links to tagged media segments 102, thumbnails of tagged media segments 102, full tagged media segments 102, and the like).

In embodiments, the end user 110 may identify owner 152, rules 124, advertiser 144, and other information that may be associated with a tagged media segment 102 or an advertisement 112 when configuring an user profile to be referenced by an automated facility such as automated searching or automated updating.

The end user 110 may provide demographic and other relevant information to the media platform 100 through the user interface 164. The user interface 164 may be adapted to receive the end user 110 demographic information in a variety of ways including: an end user 110 filling in one or more forms configured to accept end user 110 demographic information; interactive end user 110 response to questions provided by the user interface 164; an end user navigating through menus to select one or more choices of demographic information; an end user submitting a formatted file, email, or instant message of demographic information; an end user 110 submitting a link to a formatted file of demographic information; a link to an end user 110 social networking web page such as a page on myspace.com or facebook.com; a link to a personal resume; a v-card; and other ways of identifying or selecting demographic information.

The media platform 100 may include an automated email or messaging system wherein an end user 110 can opt-in to the system to receive updates through the user interface 164 from time to time. The updates may include information, tagged media segments 102, advertisements 112, and other content as may be relevant to the end user 110 and or the media platform 100. The end user 110 may opt-in to select none, some, or all updates from the automated messaging system. In embodiments, the user interface 164 may provide the end user 110 with a list of update categories to which the end user 110 may opt-in.

The media platform 100 may include a revenue sharing model that shares revenue with end users 110 who refer another end user 110 to the media platform 100. In embodiments, the referring end user 110 may receive a portion of revenue generated by the referred end user's 110 viewing tagged media segments 102 and attached advertisements 112. In an example, the referring end user 110 may receive a portion of revenue generated by an end user 110 referred to the media platform 100 similar to that shared with an affiliate 190. The referral sharing model may include time and/or revenue limits or may adjust up or down over time.

The user interface 164 may include facilities for a first end user 110 specifying a relationship with a second end user 110 and or a uniquely identified client 178 such that the first end user 110 may control what tagged media segments 102 and/or advertisements 112 may be viewed by the second end user 110 or uniquely identified client 178. In an example, a parent may identify a client 178 of one of the parent's children as being restricted to tagged media segments 102 designated for children. In another example, a school administrator may designate the school ISP address as excluding tagged media segments 102 containing adult content.

The user interface 164 may allow an end user 110 to identify a tagged media segment 102 as meeting one or more restrictions (such as objectionable content) determined by the end user 110. The end user 110 may specify one or more aspects of the tagged media segment 102 that relates to the restriction. The media platform 100 may suggest to the end user 110 one or more aspects, such as tags, content types, and the like to include in the end user 110 preferences such that tagged media segments 102 with these aspects are not presented to the end user 110. The end user 110 may not specify one or more aspects of the tagged media segment 102 that relates to the restriction. In either situation, the media platform 100 may utilize the collaborative filter 194 to suggest aspects to the end user 110. By combining the end user 110 notification to the media platform 100 regarding tagged media segments 102 and output from the collaborative filter 194, the media platform 100 facilitates an end user 110 building a content/advertisement firewall.

The user interface 164 may include facilities for recording an end user 110 comment about a tagged media segment 102. The user interface 164 may facilitate the end user 110 in identifying recorded comments as visible to other users of the media platform 100 (e.g. public comments) or only visible to the tagged media segment 102 content owner 152, or other entity associated with the media platform 100 such as the facilitator 158, affiliate 190, or advertiser 144. The user interface 164 may further facilitate an end user 110 maintaining anonymity when recording comments.

The user interface 164 may provide facilities for an end user 110 to get help with the media platform 100. The user interface 164 may include one or more menus that provide answers to frequently asked questions that an end user 110 may review. The user interface 164 may also provide a hyperlink for sending a message, such as a request for assistance, to a facilitator 158 of the media platform 100. The user interface 164 may also include an interactive messaging chat facility wherein an end user 110 may contact a member of the media platform 100 support staff through an instant messaging type interface.

The user interface 164 may also provide contact information of tagged media segment 102 content owners 152 such that an end user 110 or any user of the media platform 100 may contact an owner 152 of a tagged media segment 102. In a similar way, the user interface 164 may facilitate an end user 110 contacting an advertiser 144 of an advertisement 112 attached to a tagged media segment 102.

In embodiments, the user interface 164 may facilitate an end user 110 interacting with the collaborative filter 194 such that the end user 110 may receive recommendations for tagged media segments 102 based on an end user's 110 input regarding tagged media segments 102 and the input of other similar end users 110. The user interface 164 may facilitate an end user 110 providing input such as preferences and other information that may be contained in an end user 110 profile to the collaborative filter 194. The user interface 164 may further facilitate notifying an end user 110 of recommendations output from the collaborative filter 194.

Referring now to FIG. 6, advertisers 144 may be desirous of providing a message (i.e. an advertisement 112) to inform and inspire a recipient of the message to take an action. The action may be to purchase or otherwise take advantage of a product or service promoted in the message. Advertisers 144 may also desire to focus their messages toward recipients who may be more likely to take action. In this regard, advertisers 144 may prefer to present their message to a recipient (i.e. a user 110) that already may have some relevant association with the product or service. By emphasizing the relevant association in the message, the advertiser 144 may be able to emotionally and/or intellectually connect with recipient so as entice the recipient into action with respect to the product or service. The connection may facilitate the recipient's understanding of why they should take action, and why they should take action now. Therefore, targeting advertisements 112 at such recipients may be of great value to advertisers 144.

Advertisers 144 may have a budget for delivering the message (i.e. an advertisement 112). The advertisers 144 may have an objective of ensuring a message is delivered to a recipient with a potentially relevant association such that the budget for advertising may be effectively spent. To improve the rate of connection of a recipient of a message to a product or service in the message, advertisers may use tools to identify potential recipients and assess their relevant association as described herein. In addition, advertisers may use tools to assess one or more distribution media for their message. They may be interested in how effectively a distribution medium delivers a message to recipients having a relevant association.

Advertisers 144 may also use tools to assess a population of potential recipients, looking for opportunities to create associations between the potential recipients and the product or service they are advertising. These tools, some of which are described in detail herein and others of which will be appreciated, may allow an advertiser to assess a population accessible by one or more distribution mediums.

Advertisers 144 may also identify a product or service being advertised with a market space. A market space may relate to aspects of a product or service such that similar products or services may be found within a market space. A market space may be broad, encompassing a wide variety of products or services (e.g. transportation). Alternatively, a market space may be narrow, encompassing closely related products or services (e.g. golf carts). By identifying products or services with one or more market spaces, advertisers 144 may be able to further identify populations of potential recipients associated with markets spaces. Advertisers 144 may assess the effectiveness of a distribution medium in reaching potential recipients in a market space, thereby identifying preferred distribution mediums for reaching recipients. Achieving high visibility to recipients in one or market spaces may facilitate reaching recipients who have a relevant association to the product or service being advertised. This may result in more recipients taking action such as buying a product or service advertised.

Associating a product or service with a market space may also allow advertisers 144 to associate the product or service with other products or services in that market space. Advertisers 144 may gain advantage by being associated with a market space that includes related successful products (e.g. skin moisturizers in a razor blade market space). Advertisers may also gain advantage by advertising their product or service in the same market space as their competitors (e.g. Acer PCs in a market space that includes Dell PCs). Therefore advertisers may evaluate distribution mediums in a market space that are characterized by what products or services are associated with the market space.

A market space visualization map 600 of the visualization module 146 may show a multi-dimensional view of at least a portion of a market. The portion of the market may be static, dynamic, automatically generated, or may, in whole or in part, be selected by the advertiser 144. The visualization map 600 may depict a generalized population of end users of the media platform 100, effectively depicting an undefined market space. However, as shown in FIG. 6, the visualization map 600 may also depict a market space as herein described which may represent a subset of end users of the media platform 100. The visualization map 600 of FIG. 6 may further represent a high-level view of an advertising market, covering several broad market spaces such as technology, capital goods, communications, and financial.

The visualization map 600 may include regions of various sizes and various markings that represent characteristics associated with the utilization of tagged media segments 102 as described herein. Each market space 602 has a label 604 identifying the market space. The market space 602 is further divided into regions 608 representing characteristics associated with the utilization of tagged media segments 102. The visualization map 600 may facilitate an advertiser visually assessing the relative effectiveness of advertising with tagged media segments 102 associated with each region 608. The visualization map 600 may facilitate the advertiser assessment process because each region 608 has a size and marking that may visually communicate some aspect of the represented characteristics and may differentiate one region 608 from another. By assessing the relative size and marking of regions depicted in the visualization map 600, an advertiser may identify tagged media segments 102 to bid on for placement of an advertisement 112.

As shown in FIG. 6, regions 610, 612, 614, 618 are differentiated by the density of the horizontal lines, wherein region 610 has no visible horizontal lines. Regions 620, 622, 624, 628 are differentiated by both the density and the angle of lines. Thus, the aspect of characteristics associated with the utilization of tagged media segments 102 visually communicated by the markings of these regions may be different from one region to another. (In embodiments, colors, hues, shades, or other visual cues may be used in lieu of hatching.) In an example, the aspect visually communicated by the markings of regions 610, 612, 614, and 618 may be associated with tagged media segment 102 viewer's age. Further in the example, region 610 may represent viewers aged 18-24, region 612 may represent viewers aged 25-32, region 614 may represent viewers aged 32-44, and region 618 may represent viewers aged over 44. Regions 610 and 614 are also differentiated by size, wherein region 614 is larger than region 610. Although regions 610 and 618 are differentiated by marking, they are substantially the same size, indicating the aspect visually communicated by size may be the same for region 610 and region 618. Therefore in a continuation of the example describing markings above, the characteristic represented by the size of a region 608 may be the percent of viewers that watch an advertisement 112 attached to tagged media segments 102. The aspect visually communicated by size may be that larger size indicates greater percent. In this example, region 614 visually represents a greater percent than does region 610, while regions 610 and 618 visually represent a substantially identical percent.

In embodiments, an advertiser may identify a product or service with a market space 602. In an example, an advertiser 144 may have identified the product or service they are advertising with the technology market space. However, they may have also identified their product or service with a portion of the technology market space such as digital entertainment. Although the visualization map 600 of FIG. 6 may provide the advertiser with information to facilitate selecting tagged media segments 102 for bidding on the placement of advertisements 112 within the media platform 100, the visualization map 600 may be insufficient for the advertiser to make selections of tagged media segments 102 for the digital entertainment market space within the technology market space. Therefore, the visualization module 146 provides flexibility to meet the advertiser's 144 needs by allowing the advertiser 144 to visualize a market space in a finer detail perspective.

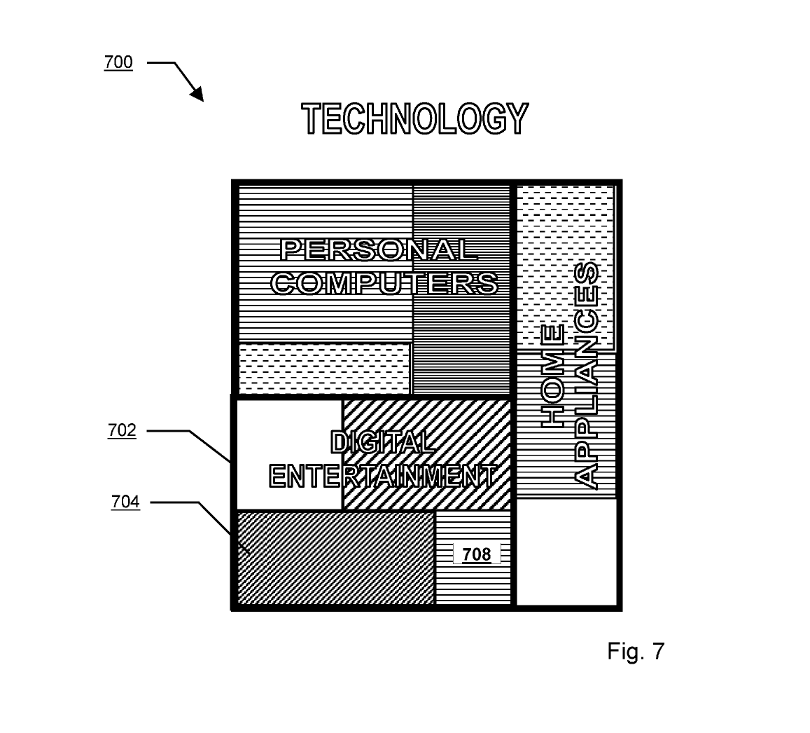

FIG. 7 is a finer detail visualization map 700 of the technology market space. To view the detail, the advertiser 144 may select the technology market space of visualization map 600 to reveal a visualization map 700 of just the technology market space. Details of the technology market space viewed may include markets such as digital entertainment 702, personal computers, home appliances, medical devices, and the like. The advertiser 144 may use the greater level of detail visually presented by regions 704 in visualization map 700 to bid to attach advertisements 112 to tagged media segments 102. The finer detail of the visualization map 700 may provide the advertiser 144 with information to facilitate selecting the best tagged media segments 102 for the digital entertainment market space 702. Referring to FIGS. 6 and 7 regions 614 and 708 may represent the same characteristic of utilization of tagged media segments 102. However, the tagged media segments 102 contributing to the characteristics represented by region 708 may be different from those contributing to the characteristics represented by region 614. Therefore an advertiser bidding on the placement of advertisement 112 with tagged media segments 102 associated with region 708 may distribute advertisements 112 to recipients with more direct association to the product or service advertised than if the advertiser 144 used the tagged media segments 102 associated with region 614.

In embodiments, a visualization map of the visualization module 146 may depict aspects other than market space. A visualization map may depict tagged media segment 102 attributes such as creator/owner 152, rules 124, segment genre, language, or a wide variety of other tagged media segment 102 attributes.

The visualization map may depict a combination of attributes such as market spaces (e.g. sports equipment) and viewer attributes (e.g. age) to facilitate advertisers 144 assessing and bidding on tagged media segments 102 in the depicted combination. Other combinations are possible, such as tagged media attributes and product markets, viewer attributes and other viewer attributes. The type and number of combinations may be unbounded. An advertiser 144 may specify a combination to the visualization module 146 and the visualization module 146 may generate a visualization map depicting the specified combination.

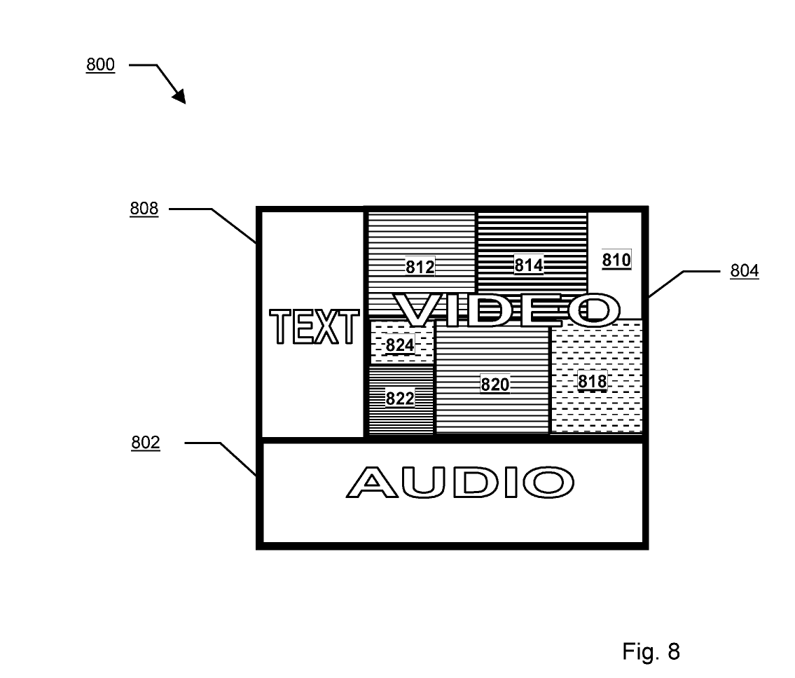

FIG. 8 shows an example visualization map 800 of a selected combination of tagged media segment 102 attributes with a further combination of viewer demographics. The tagged media segment 102 attribute depicted by the visualization map 800 includes the type of tagged media segment 102. A tagged media segment 102 may have one or more type attributes such as audio, video, text, and the like. The tagged media segment 102 type attribute visualization map 800 is divided into an audio type space 802, a video type space 804, and a text type space 808. Each type space is further divided into regions. Each region represents a combination of viewer attributes. The combination is age—18-35, gender—M, location—northeast USA, annual household income—>$50K.

The size of each region represents an aspect of the relative number of views of tagged media segments 102 associated with a region; wherein larger sized regions represent greater relative number of views.

The marking of each region represents the relative accuracy of advertisements 112 attached to tagged media segments 102 represented by the region reaching the selected viewer demographic combination (age—18-35, gender—M, location—northeast USA, annual household income—greater than $50K).

In the example of FIG. 8, region 820 is the largest and therefore has the greatest relative number of views. Regions 812 and 814 are smaller in size than region 820 but are of equal size, therefore they have a smaller relative number of views than region 820 but they each have substantially the same number of views. In reducing order of relative views, region 818 is next, followed by region 822, then region 810, and finally by region 822. From this example, one could conclude that within the video type space 804, region 820 has the greatest number of views and region 824 has the least number of views. An advertiser may conclude that advertising with tagged media segments 102 represented by region 820 would provide the greatest opportunity for reaching the selected viewer demographic. However, this conclusion does not factor in the markings of the regions.

The regions are marked by horizontal lines wherein the density of horizontal lines is proportional to the accuracy of advertisements reaching the selected viewer demographic combination.

Again referring to FIG. 8, region 822 may have the highest accuracy of regions within the video type space 804, while region 810 may have the lowest accuracy. Regions in descending order of accuracy below region 822 are: region 814, regions 820 and 812, regions 818 and 824, and region 810. An advertiser may conclude that advertising with tagged media segments 102 represented by region 822 would provide the greatest opportunity for accurately reaching viewers within the selected viewer demographic combination. Given that this conclusion may include both the size and markings of region 822, it may provide the advertiser 144 a sufficient reach into the selected viewer demographic. However, another advertiser 144 may conclude that advertising with tagged media segments 102 represented by region 814 would provide the greatest opportunity for accurately and thoroughly reaching viewers within the selected viewer demographic combination.

An advertiser may choose to assess one of the regions in greater detail. The advertiser may select a region, such as region 814 for a greater detail view. FIG. 9 depicts a visualization map of region 814 wherein the size and markings of the regions visually represent the same characteristics as the visualization map of FIG. 8, yet each region now represents a single tagged media segment 102. At the level of detail depicted in the visualization map of FIG. 9, an advertiser may select one or more tagged media segments 102 of the region 814 for bidding. In this way, an advertiser 144 may select specific tagged media segments 102 based on other characteristics not represented in the visualization map by querying the media platform 100 for further details about each media segment 102. For example, an advertiser 144 may choose to not select the tagged media segment 102 represented by region 902 because its intended audience is young adult which does not match well to the advertiser's 144 understanding of the selected demographic.

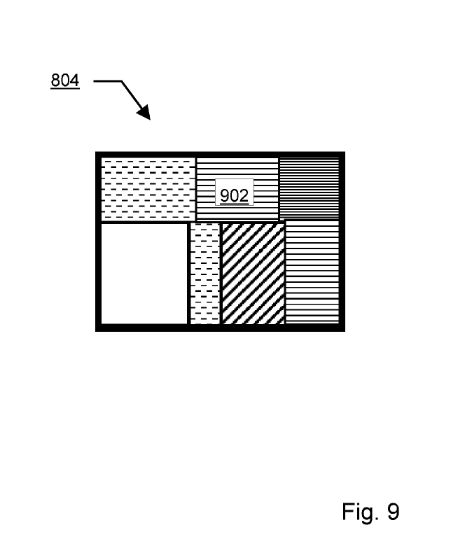

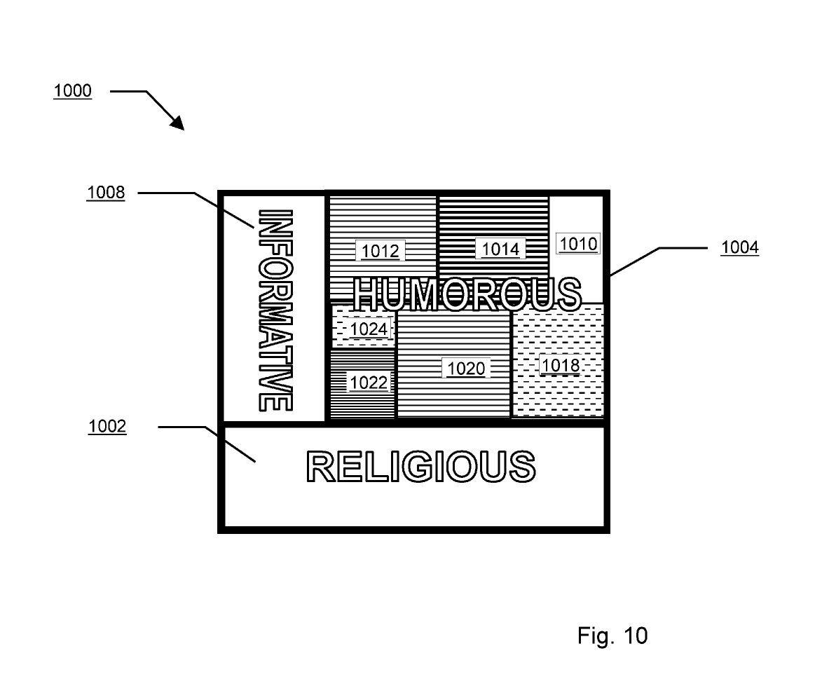

FIG. 10 shows an example visualization map 1000 of the nature of content attribute of tagged media segments 102 in combination with the viewer demographics combination depicted in the visualization maps of FIGS. 8 and 9. The nature of content of a tagged media segment 102 may include humorous, informative, religious, and the like. The tagged media segment 102 nature of content attribute visualization map 1000 is divided into a religious nature of content space 1002, a humorous nature of content space 1004, and an informative nature of content space 1008. Each nature of content space is further divided into regions. Each region represents the combination of viewer attributes depicted in FIGS. 8 and 9, specifically: age—18-35, gender—M, location—northeast USA, annual household income—greater than $50K.

The size of each region represents an aspect of the relative number of views of tagged media segments 102 associated with a region; wherein larger sized regions represent greater relative number of views.

The marking of each region represents the relative accuracy of advertisements reaching the selected viewer demographic combination (age—18-35, gender—M, location—northeast USA, annual household income—>$50K).

In the example of FIG. 10, region 1020 is the largest and therefore has the greatest relative number of views. Regions 1012 and 1014 are smaller in size than region 1020 but are of equal size, therefore they have a smaller relative number of views than region 1020 but they each have substantially the same number of views. In reducing order of relative views, region 1018 is next, followed by region 1022, then region 1010, and finally by region 1022. From this example, one could conclude that within the humorous nature of content space 1004, region 1020 has the greatest number of views and region 1024 has the least number of views. An advertiser may conclude that advertising with tagged media segments 102 represented by region 1020 would provide the greatest opportunity for reaching the selected viewer demographic. However, this conclusion does not factor in the markings of the regions.

The regions are marked by horizontal lines wherein the density of horizontal lines is proportional to the accuracy of advertisements reaching the selected viewer demographic combination.

Again referring to FIG. 10, region 1022 may have the highest accuracy of regions within the humorous nature of content space 1004, while region 1010 may have the lowest accuracy. Regions in descending order of accuracy below region 1022 are: region 1014, regions 1020 and 1012, regions 1018 and 1024, and region 1010. An advertiser may conclude that advertising with tagged media segments 102 represented by region 1022 would provide the greatest opportunity for accurately reaching viewers within the selected viewer demographic combination. Given that this conclusion may include both the size and markings of region 1022, it may provide the advertiser 144 a sufficient reach into the selected viewer demographic. However, another advertiser 144 may conclude that advertising with tagged media segments 102 represented by region 1014 would provide the greatest opportunity for accurately and thoroughly reaching viewers within the selected viewer demographic combination.

An advertiser may choose to assess one of the regions in greater detail. The advertiser may select a region, such as region 1014 for a greater detail view. FIG. 11 depicts a visualization map of region 1014 wherein the size and markings of the regions visually represent the same characteristics as the visualization map of FIG. 10, yet each region now represents a single tagged media segment 102. At the level of detail depicted in the visualization map of FIG. 11, an advertiser may select one or more tagged media segments 102 of the region 1014 for bidding. In this way, an advertiser 144 may select specific tagged media segments 102 based on other characteristics not represented in the visualization map by querying the media platform 100 for further details about each media segment 102. For example, an advertiser 144 may choose to not select the tagged media segment 102 represented by region 1102 because its intended audience is young adult which does not match well to the advertiser's 144 understanding of the selected demographic.

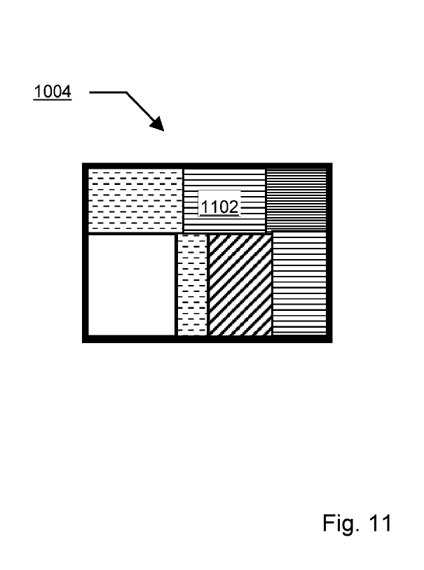

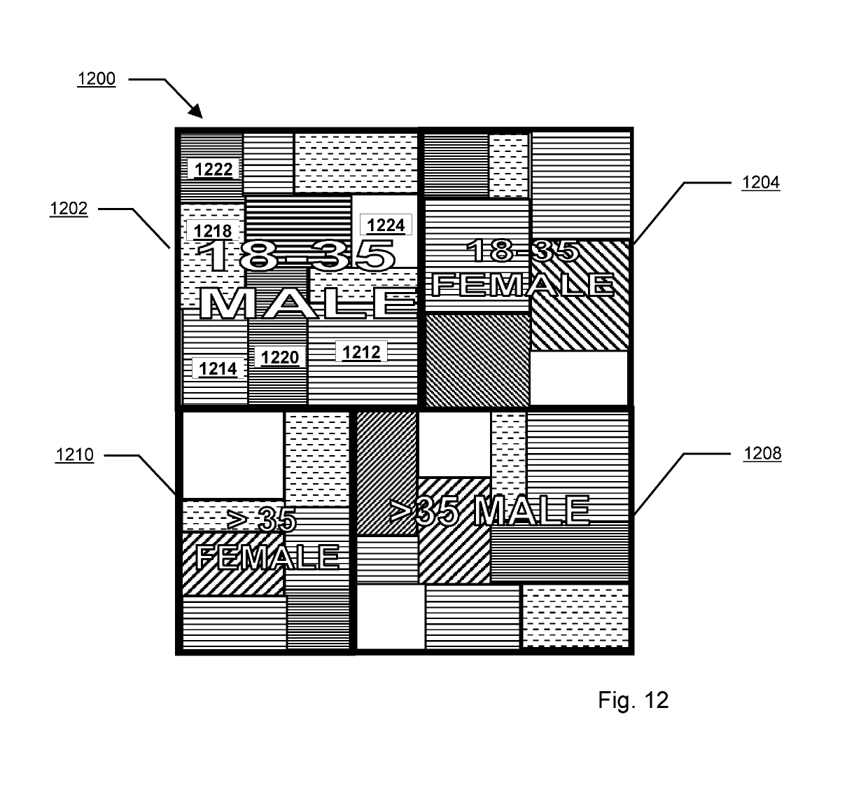

In another example, FIG. 12 depicts a visualization map 1200 representing an audience based on selected demographic criteria. The visualization map 1200 may represent an actual audience based on data collected through the media platform 100. The visualization map 1200 may alternatively represent a projected or estimated audience. The audience depicted in visualization map 1200 is based on a demographic combination of viewer age and gender. The visualization map 1200 is divided into four spaces; age 18-35 males 1202, age 18-35 females 1204, age 36+ males 1208, and age 36+ females 1210. The visualization map 1200 could be divided by any other demographic or any combination of demographics such as zip code, geographic area, household income, education, age, gender, and any other demographic of a viewer of tagged media segments 102.

Each audience demographic space (1202, 1204, 1208, and 1210) may be further divided into regions wherein each region depicts relative effectiveness of a specific combination of the nature of content and type of tagged media segment 102. In the visualization map 1200 of FIG. 12, the regions represent the combination of humorous nature and video type (i.e. humorous videos). Therefore information related to “informative videos” or “religious audio segments” (for example) is not depicted in and does not affect how an advertiser 144 may interpret the visualization map 1200.

The size of each region represents an aspect of the relative number of views of tagged media segments 102 associated with a region; wherein larger sized regions represent greater relative number of views.

The marking of each region represents the relative effectiveness of advertisements reaching the selected viewing audience. In an example, regions in age 18-35 female space 1204 represent the effectiveness of reaching females ages 18-35.

In the example of FIG. 12, region 1212 is the largest and therefore has the greatest relative number of views of space 1202. Regions 1214 and 1218 are smaller in size than region 1212 but are of equal size, therefore they have a smaller relative number of views than region 1212 but they each have substantially the same number of views.

The regions with space 1202 are marked by horizontal lines wherein the density of horizontal lines is proportional to the effectiveness of advertisements reaching the depicted viewing audience demographic.

Again referring to FIG. 12, region 1220 and 1222 may be the most effective of regions within age 18-35 male 1202 space and region 1224 may be least effective. An advertiser may conclude that advertising with tagged media segments 102 represented by region 1220 would provide the greatest opportunity for effectively and thoroughly reaching viewers within the selected viewing audience demographic combination.

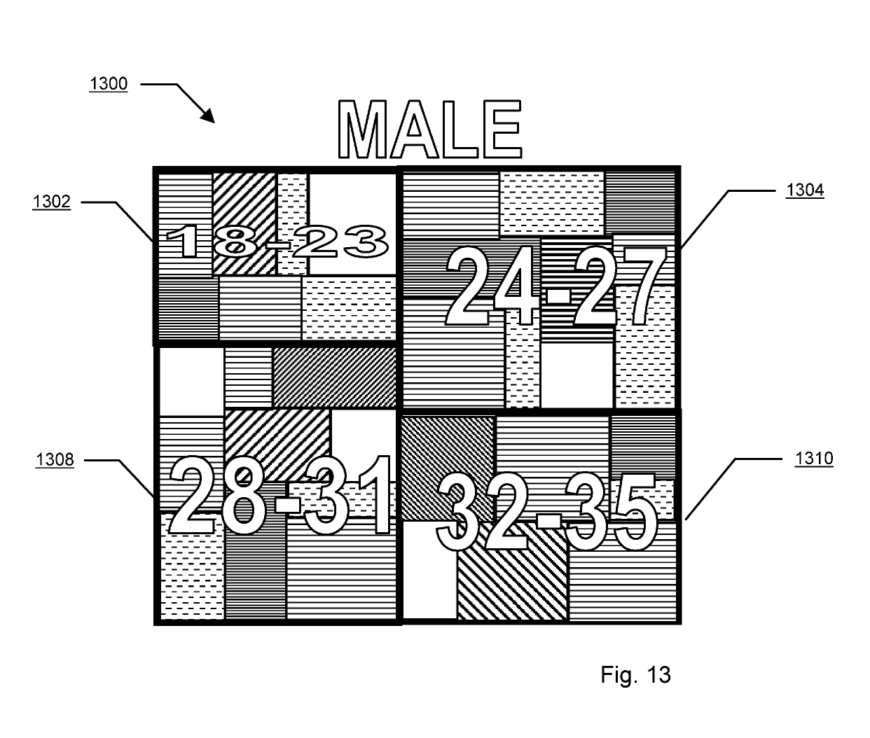

An advertiser may choose to assess the 18-35 male space 1202 in greater detail. FIG. 13 depicts a visualization map 1300 of the selected space 1202. The space is further divided into spaces based on smaller age ranges within the overall 18-35 age range. In the example of FIG. 13, the visualization map 1300 is divided into four (4) male spaces; age 18-23 1302, age 24-27 1304, age 28-31 1308, age 32-35 1310. Within each space the regions represent the same characteristics with the size of the region representing the relative number of views and the markings representing the effectiveness of reaching the selected viewing audience.

With this level of detail view, an advertiser may choose to select one or more of the narrow age range spaces or a subset of regions in one or more spaces. For example, an advertiser 144 may select the top region for spaces 1302, 1304, and 1308, leaving out space 1310 because it represents an age group greater than the advertiser 144 identifies the product or service with. If the advertiser 144 had selected the top region of space 1202 in visualization map 1200 of FIG. 12, their advertisements would have been distributed to any viewing audience member of the space 1202, which includes males ages 32-35. By narrowing down the larger space 1202 the advertiser 144 has greater control of where and how their advertising budget is spent.

While particular examples of visualizations have been provided hereinabove with references to FIGS. 6-13, many other such visualizations will by now be appreciated from the present disclosure. All such visualizations are intended to fall within the scope of the present invention. It will also be appreciated that visualizations provided by or used in association with the media platform may be directed at enabling an advertiser 144 to place informed bids 101; to monitor the performance of ongoing bids 101 or of elements of deliverable media segments 106 associated with ongoing bids 101; to monitor the performance of winning bids 101 or of elements of deliverable media segments 106 associated with ongoing bids 101; to gather market intelligence; and so on. In embodiments any and all visualizations may be provided for free, for a fixed fee, for a recurring subscription fee, and so on. The visualizations may be delivered via a webpage, a cell phone, a pager, an interactive voice response system, an email, and instant message, an SMS message, an MMS message, and so forth. The visualizations may be implemented in client software, server software, application software, web software, and the like. The visualizations may be provided by a client software application, a client/server software application, a web service, a data service, an interactive service, a server-side script, a client-side script, an executable, and so on.

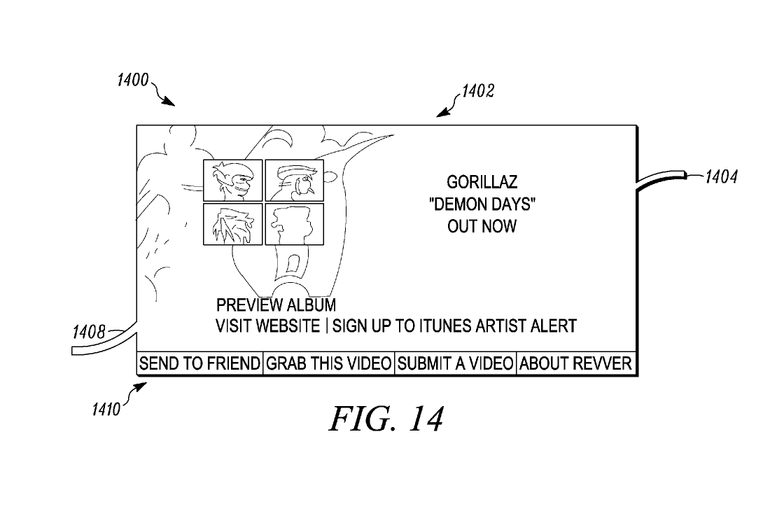

Referring to FIG. 14, a template 1400 may include a background 1402, a tag line 1404, a contact line 1408, and a menu 1410. An operator of the automated advertisement creation module 188, who may, without limitation, be the advertiser 144 or someone working on behalf of or in association with the advertiser 144, may select a template 1400 and provide, via a graphical user interface or any and all other user or data interfaces, input for the elements (1402, 1404, 1408, 1410) of the template. The auto-ad creation module 188 may provide and/or accept a wide variety of templates 1400 and, as a result, may be capable of customizing or creating a wide variety of advertisements 112.

The background 1402 may encompass a static image and may be selected from a set of static, graphic images available through the auto-ad creation module 188. Alternatively or additionally the operator may provide his own static, graphic image. Similarly, the background 1402 may encompass a dynamic graphic image which the operator either may select from a set of dynamic, graphic images available through the auto-ad creation module 188 (such as and without limitation a computer generated color pattern) or may provide to the platform 100. In embodiments, the background 1402 may be clipped from a movie, music video, media segment, or the like. The operator may identify a portion of a movie, music video, media segment, or the like for use as the background 1402. Alternatively or additionally, the operator may allow auto-ad creation module 188 to select a portion for the background 1402. In embodiments, the auto-ad creation module 188 either may randomly select the portion or may select a portion based on input from the collaborative filter 194 or any and all other elements of the platform 100.

The tag line 1404 and contact line 1408 may be provided by the operator. The operator may provide a single entry for the tag line 1404 and the contact line 1408. Alternatively or additionally, the operator may provide a list of tag lines from which the auto-ad creation module 188 may select, perhaps based on rules 124 established when the list of tag lines is provided. The auto-ad creation module 188 may select a tag line 1404 and/or a contact line 1408 each time it creates an advertisement 112. The operator may identify a language for the tag line 1404 and/or the contact line 1408. In this case, the auto-ad creation module 188 may automatically translate a tag line to the language specified by the user. Alternatively or additionally, the language may be dynamically changed based on a preference of a user 110 who views a tagged media segment 102 and the advertisement 112 that may be attached to it.

The menu 1410 may be associated with the advertisement 112 and/or with the auto-ad creation module 188, providing a viewer (i.e. a user 110) of the automatically created advertisement 112 with a means for interacting with the advertisement 112. This interaction may, without limitation, comprise re-running the advertisement 112, changing the language of the advertisement 112, increasing the size of the advertisement 112, sending the advertisement 112 to a friend, downloading the advertisement 112, submitting a media segment and/or advertisement 112, learning more about the auto-ad creation module 188, and the like.

In embodiments, the template 1400 may encompass a QuickTime template and may include, for the background 1402, a GIF file that includes transparent pixels. In embodiments, the template 1400 may encompass a use of Macromedia FLASH. Many other such embodiments will be appreciated and all such embodiments are intended to fall within the scope of the present disclosure.

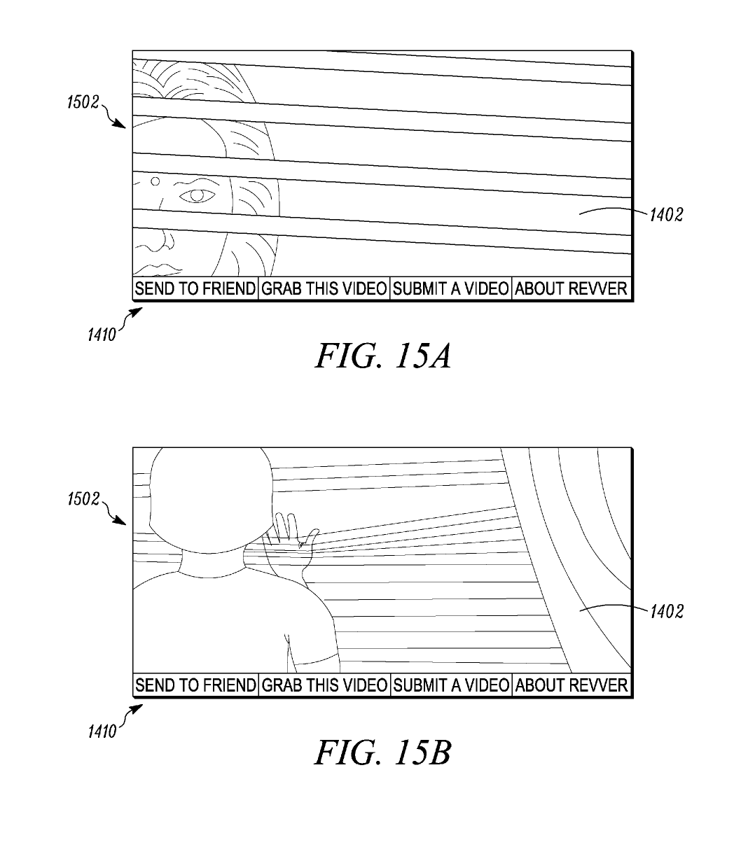

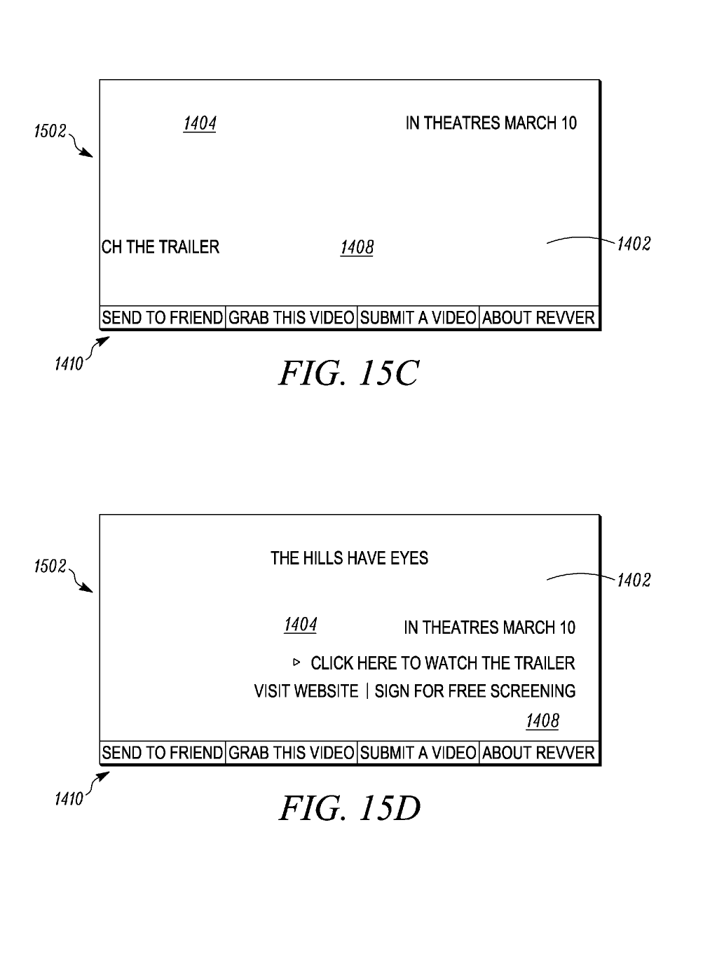

FIGS. 15A-15D encompass a sequence of screen shots illustrating an example of an automatically created advertisement 112 with a movie trailer as a background 1402. FIG. 15A shows a start frame 1502 of the movie trailer as the background 1402 and a menu 1410 that is superimposed or attached along the bottom of the frame 1502. FIG. 15B shows an middle frame 1502 of the movie trailer as the background 1402 with the menu 1410 superimposed or attached along the bottom of the frame. FIG. 15C shows an interstitial segment 108 in which a tag line 1404 and contact line 1408 are sliding over the background 1402, which encompasses a black frame of the movie trailer. The menu 1410 is present as it was in FIGS. 15A and 15B. FIG. 15D shows the final frame 1502 of the movie trailer as the background 1402 along with the tag line 1404 and contact line 1408 in their final positions, superimposed over the background 1402. The menu 1410 is present as it was in FIGS. 15A, 15B, and 15C.

The auto-ad creation module 188 may be used to generate advertisements 112 that have a visual association with a media segment 102. In embodiments, the media segment 102 may encompass a movie or the like. The auto-ad creation module may combine images from the media segment 102 with any and all information 105 from the advertiser 144. In embodiments, such information 105 may encompass ad copy or the like. For example and without limitation, an advertiser 144 may want to advertise a pair of cross training shoes. The advertiser 144 may select a tagged media segment 102 that has action scenes relating to cross training. The advertiser 144 may, through an agreement with the tagged media segment owner 152, use a relevant portion of the media segment 102 to generate an advertisement 112 to be attached to the media segment 102. The agreement between owner 152 and the advertiser 144 may be facilitated, negotiated, enabled, acted upon, or otherwise instantiated or animated by any and all elements of the platform 100.

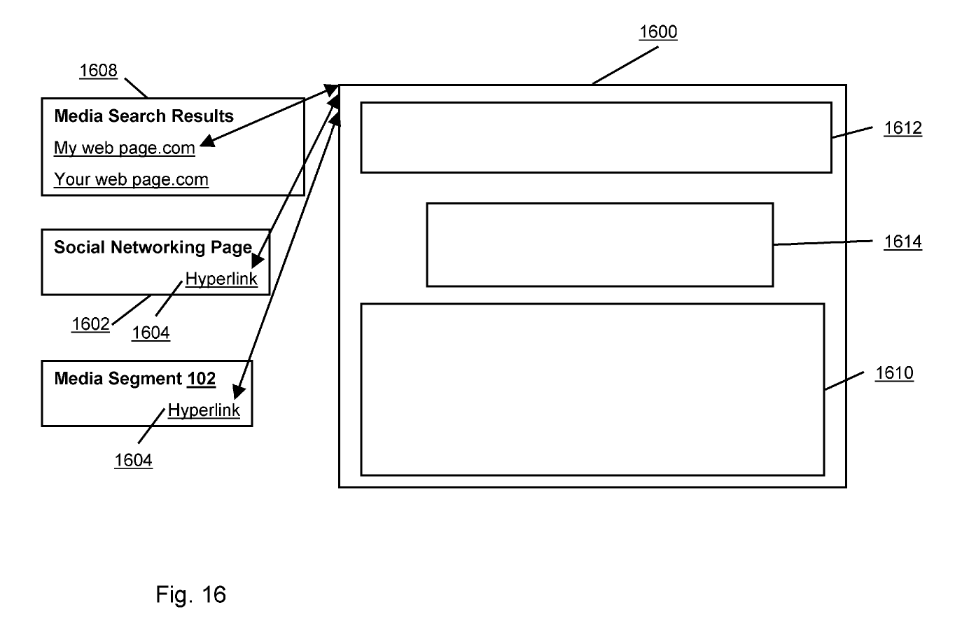

Referring to now FIG. 16, in an aspect of the invention, an owner 152 of on-line media 102 may use the media platform 100 to generate a self-published web page 1600 that is directed at generating revenue for the owner 152. This revenue may be generated from advertisements 112 on the web page 1600. All media elements on a web page may be tagged with a persistent revenue tag 104 identifying the elements as belonging to the owner 152. An advertiser 144 may use a media platform 100 to bid 101 on the placement of an advertisement 112, wherein the placement may be in a self-published web page 1600. Alternatively or additionally, an advertiser 144 may bid 101 to attach an advertisement 144 to a media segment 102. The owner 152 may elect to self-publish a web page with the media segments 102. Thus, the platform 100 may dynamically attach the advertisement 112 to the media segment 102, effectively placing the advertisement 112 in the web page. The owner 152 may distribute the media segment 102 using the media platform 100 or any other system or method for distributing the media segment 102.

The self-published web page 1600 may be accessed through a hyperlink. Examples of hyperlinks include a hyperlink 1604 on a social networking member web page 1602, a hyperlink 1604 in a tagged media segment 102, and a search engine search result 1608. As an example, the self-published web page 1600 may include, on-line content regions 1610 (which may include tagged media segments 102 and/or advertisements 112), banner type advertisements 1612 (which may include tagged media segments 102 and/or advertisements 112), auto-ad created advertisements 1614, and so on.

The media platform 100 may allow a media owner 152 to select from a variety of self-publishing web page 1600 templates which may further incorporate auto-ad templates 1400.

Advertisers 144 may provide information 105 for incorporation into an auto-ad template 1400. The template-formatted advertiser information 105 may be combined with at least a portion of a tagged media segment 102 to generate an advertisement 112, which may then be included in a self-published web page 1600. Auto-ad creation module 188, and the template 1400 may be used by the advertiser 144 to create a baseline advertisement 112 which includes the advertiser information (e.g. for a tag line 1404, a contact line 1408, and a menu 1410). The media segment owner 152 may use the auto-ad creation module 188 to combine the baseline advertisement 112 with at least a portion of a media segment 102 and publish the resulting advertisement 112.

Additionally or alternatively the auto-ad creation module 188 may automatically combine the advertiser information 105; the template 1400; and the media segment 102 to generate an advertisement 112. The auto-ad creation module 188 may do so upon request by an owner 152, advertiser 144, or dynamically when requested by the dynamic attachment facility 132. The dynamic attachment facility 132 may request creation of an auto-ad to include one or more advertisements 112 on a self published web page 1600 when the self published web page 1600 is viewed.

In embodiments, actions associated with an advertisement 112, such as a viewer (i.e. user 110) clicking a link included with the advertisement 112 may provide additional compensation to the affiliate 190, the media owner 152, and the facilitator 154. As an example, an action that results in a purchase by a viewer (such as a purchase of a movie) may by tracked by the media platform 100 and may be incorporated in a compensation model. The self published web page 1600 templates may include one or more variations which support generating a web page that enables such additional payment links.

Social networking websites may receive revenue from advertisements that appear on a member's web page. Popular members may generate substantial advertising revenue for the social networking web site, such as by allowing the social networking website to charge higher rates to advertisers 112 for the more popular member's page(s), and by collecting an advertisement fee each time a member's page is viewed.

An aspect of the invention may allow a member of a social networking website to receive compensation from advertisers 112 and/or from an operator of the website, who may be an affiliate 190 with respect to the platform 100. In an embodiment, an advertisement, such as a page banner on the member's webpage may include the member's media segment 102 (or a portion thereof) and an attached advertisement 112. This arrangement may enable the member to receive remuneration associated with the playback of the advertisement 112 by a visitor to the member's webpage.

As an example, a member of a social networking website may be an owner 152 and may use the media platform 100 to tag one of the member's media segments 102. The member may coordinate with the social networking website to advertise the tagged media segment 102 on the member's page. When a user 110 accesses the advertised, tagged media segment 102 on the member's page, the media platform 100 may deliver an advertisement 112 to the user 110, perhaps by using the dynamic attachment facility 132. When the user 110 plays, views, interacts with, or otherwise experiences this advertisement 112, the platform 100 may compensate the member.

In another example, an affiliate 190 may receive a deliverable media segment 106 through the media platform 100 and similarly coordinate with the social networking website for placement of the deliverable media segment 106 for purposes of receiving compensation from the advertiser 144. The deliverable media segment 106 may be controlled by and/or associated with the affiliate 190 and may or may not generate revenue for the member on whose website the deliverable media segment 106 is placed.

In embodiments, a social networking web site may establish a compensation model to compensate a member with a portion of advertising revenue derived from advertisements 112 on the member's page. As an example, a social networking web site may use the media platform 100 to tag an advertisement 112 on a member's page with a persistent revenue tag 104 such that the web site may be compensated (e.g. similarly to an affiliate 190) and the member may be compensated (e.g. similarly to an owner 152). Alternatively or additionally, the social networking web site may use the media platform 100 (e.g. similarly to a facilitator 154) to facilitate advertisers 144 in bidding on placement of an advertisement 112 on a member's pages.

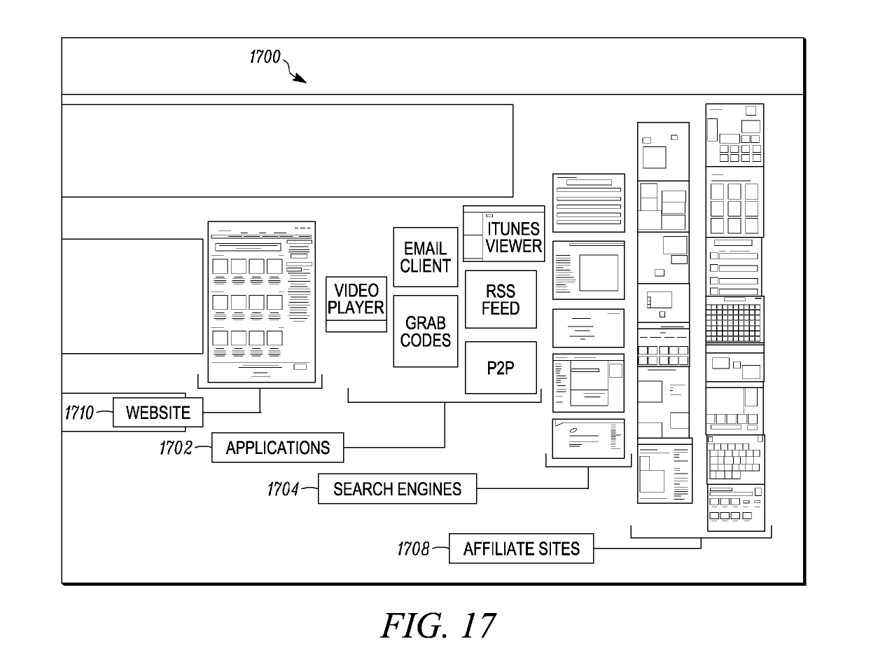

Referring to FIG. 17, super distribution 1700 facilitates use of existing internet systems such as search engines 1702, applications 1704, and affiliate sites 1708 to make a network media object (such as a tagged media segment 102) visible to an wide audience while retaining traceability for revenue sharing and advertiser audience tracking purposes.

As an example, a network media object, such as a tagged media segment 102, may be available for viewing, downloading, copying, linking, etcetera on a website 1710. Applications 1704 such as video players, email clients, peer-to-peer networks, RSS feeds, iTunes Viewers, social networks, podcasts, blogs, instant messages, grab codes, etcetera may enable viewers 178, affiliates 190, and owners 152 to access the network media object.

Search engines 1702 may deliver search results which may provide access to the network media object or to a link to the network media object in one or more websites, such as affiliate sites 1708.

Affiliate sites 1708 may provide further access to network media objects through replication of selected network media objects on the affiliate web site 1708. Each instance of a network media object may maintain a persistent tag 104, allowing replication and viewing of a network media object without concern for the propagation of unauthorized or untraceable/untrackable copies. The media platform 100 may support super distribution 1700 to facilitate media owners 152 in profiting on the open flow of media objects via the internet.

A website 1710 which maintains open access to tagged media segments 102 may be a source of network media objects for super distribution 1700.

In embodiments, a variety of media files (e.g. photos, movies, audio, e-books, news clip, sports casts, home movies, on-line training, and so on) and webpages that may be processed through the media platform 100 could become traceable network media objects through the application of a persistent tag 104. A network media object may encompass an attached advertisement 112, which may include an advertisement tag 104B, which may encompass a persistent revenue and tracking tag 104.

Software tools for generating network media objects may be available to a media segment owner 152, advertiser 144, affiliate 190, and facilitator 154. Such a software tool may facilitate media segment packaging for on-line super distribution 1700 by providing capabilities such as and without limitation selecting an encoding bit rate; identifying an advertisement 112 for layering with the media segment 102 using the auto-ad creation module 188; and identifying portions of the media segment 102 for inclusion in an auto-ad; and so forth.

Some of the systems and methods hitherto described involve a multimedia file (“the content file” or media 102) that is associated with one or more advertisements, wherein the advertisements themselves are multimedia files (“the advertising files” or ads 112). According to those systems and methods, playback of part or all of the content file and/or the advertising files may trigger a revenue-related activity, such as billing, transferring funds, sharing revenue, and so on. To insure that market participants (such as rights holders, producers, market facilitators, affiliates, owners 152, facilitators 158, and the like) receive appropriate compensation, the content file and the advertising files are associated with information that provides for playback and/or playback monitoring. Unfortunately, intermediaries like content-search or content-delivery facilities may, inadvertently or otherwise, dissociate the content files and/or the advertising files from this information. This dissociation may impair the playback or playback monitoring of the content file and/or the advertising files. There exists a need for systems and methods that limit such dissociation.

A system and method for providing Flash media may be directed at maintaining an association between, on the one hand, a content file and/or a number of advertising files and, on the other hand, information that provides for playback and/or playback monitoring of the files. In embodiments, the content file and the advertising files may encompass files in the SWF format or any other multimedia format. The association between the files and the information may enable a revenue generation method, which may involve a fee being charged to one or more advertisers and payment being made to one or more recipients. These recipients may be associated with a value chain that includes the production, distribution, and/or redistribution of the content file and/or advertising file to an end-user, which may be a consumer. The payment may be a function of the recipient's position in the value chain and a playback status of the content file and/or the advertising files. This playback status may relate to a number of complete or partial plays of the files by an end-user. Thus, it may be of critical importance to the revenue generation method that the playback status can be accurately measured or, at the very least, measured to such an extent that one can calculate related statistics to an acceptable level of confidence.

Unfortunately, various intentional or unintentional acts may dissociate the information from the content file and/or the advertising files. This dissociation may disable or impair the measurement of the playback status. Moreover, this dissociation may disable or impair the playback of the advertising files.

The foregoing paragraph may be better understood with reference to the following example, which is provided for the purpose of illustration and not limitation. Suppose a server provides a video file, at a URL. Every time the URL is accessed, the server responds by first transmitting a dynamically selected advertisement and then transmitting the video file. Each transmission is logged, so that the server can accurately bill an advertiser for each time the advertisement is transmitted and pay a producer of the video file for each time it is transmitted. A client, perhaps unwittingly, accesses the URL via a web proxy. The web proxy, having not seen the URL before, retrieves the advertisement and the video file, caches them locally, and transmits them to the client. A subsequent client accesses the URL via the web proxy. The web proxy, recognizing that it has a cached version of the resource at the URL (i.e. the advertisement file and video file), transmits the cached version without contacting the server. The server, therefore, never has an opportunity to dynamically select an advertisement for the subsequent client and never even learns that the subsequent client has received the files! It will be appreciated that this may be an undesirable result that follows from the proper functioning of an innocent web proxy.

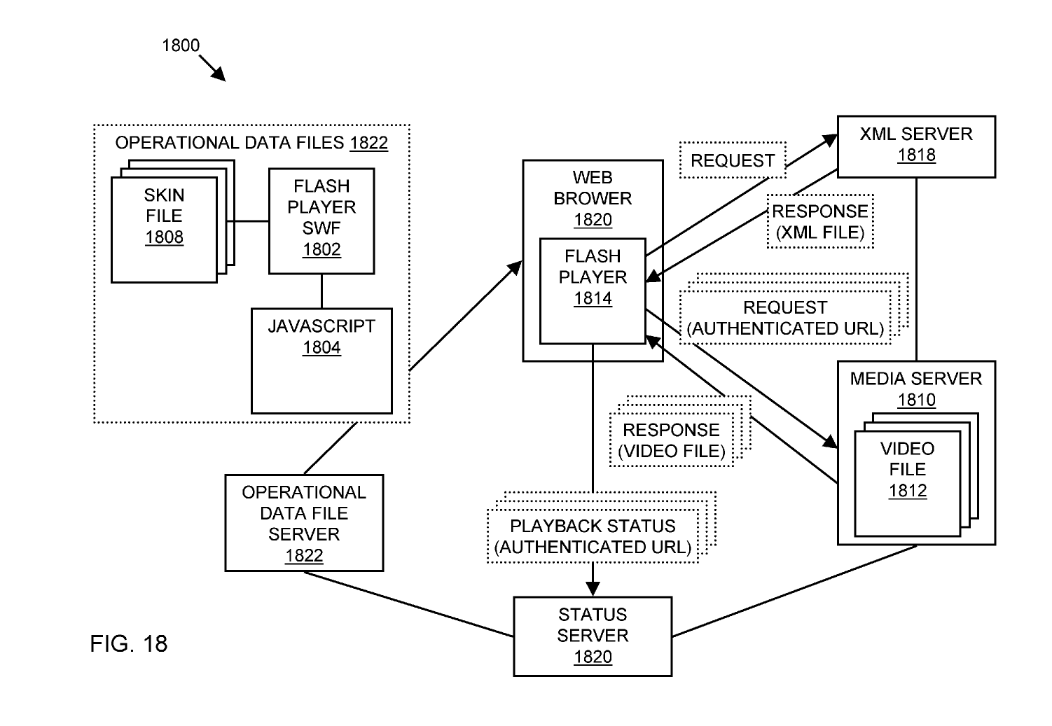

Referring now to FIG. 18, an aspect of the present invention may be directed at limiting such dissociations of the information from the content file and/or advertising files, so as to provide an improved performance of the revenue generation method. Embodiments of the present invention may include at least one Internet-connected server. This at least one server may embody an operational data file server 1822, a status server 1820, a media server 1810, an XML server 1818, and so on. The operational data file server 1822 may provide operational data files to a web browser 1820. The web browser 1820 may operate on a client computer of an end-user, who may without limitation be a consumer. The web browser 1820 and servers 1810, 1818, 1820, 1822 may be operatively coupled via the Internet or any other data network. It will become clear to those of ordinary skill in the art that the servers 1810, 1818, 1820, 1822 may be embodied in one or more physical servers, one or more software servers, and so on. Physical servers may, without limitation, include rack-mount servers, tower servers, or any and all other form of computing device. The client computer may, without limitation, comprise a personal computer, a laptop computer, a handheld computer, a cell phone, or any and all other form of computing device.

The data files 1812 may encompass a Flash player SWF 1802, a plurality of skin files 1808, and JavaScript 1804 (i.e. a file containing codes according to the JavaScript syntax). The Flash player SWF 1802 may be associated with the skin files 1808 and the JavaScript 1804. The web browser 1820 may be associated with a Flash player 1814, which may, from time to time, be embedded in it. The skin files 1808 may specify individual and/or functional aspects of how the embedded Flash player 1814 ought to be presented by the web browser 1820 to the end-user.

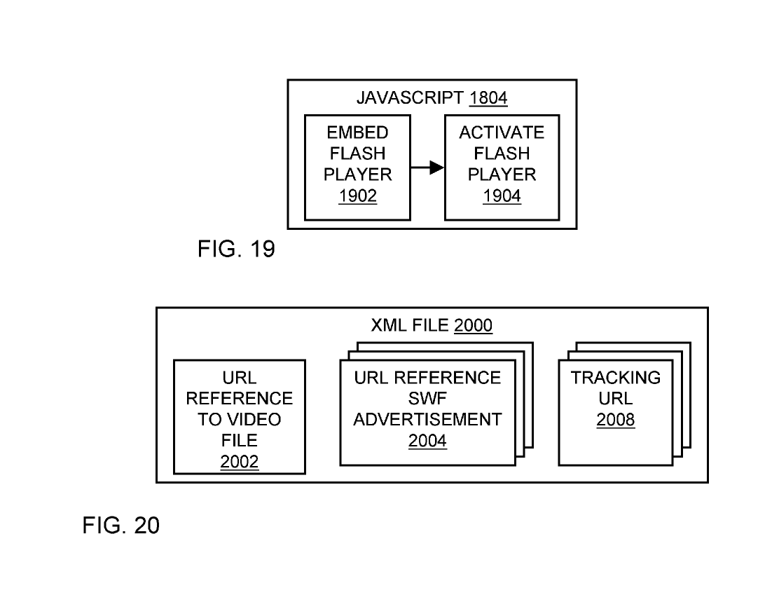

The web browser 1820 may receive the operational data files 1822 and may follow a process that is specified in the JavaScript 1804. Referring now to FIG. 19, the process may comprise two steps. First, the process may embed 1902 the Flash player 1814 in the web browser 1820. This embedding may comprise associating a visual rendition of the Flash player 1814 with a visual rendition of a designated webpage. In embodiments, without limitation, the webpage may be from Revver.com or one of its affiliate partners. Then, the process may activate 1904 the Flash player 1814 with information about desired media. This information may comprise an identification of the desired media; an optional identification of an affiliate that may share in advertising revenue that is associated with the desired media; an optional authentication string (or “shared secret”) for accessing private or protected media files; information for affecting a height, width, position, or other webpage layout associated with the Flash player 1814 and/or the skin files 1808; a indication of which of the skin files 1808 should be enabled; and so on. It will appreciated that the information about the desired media may be encoded into the JavaScript 1804 and/or may be dynamically retrieved from a server computing facility by the JavaScript 1804. The shared secret may be a function of an IP address (such as and without limitation an IP address that is associated with the Flash player 1814). The shared secret may expire after an amount of time. In embodiments, this amount of time may depend upon a configuration parameter that may be set and/or stored at the servers 1810, 1818, 1820, 1822.

The desired media may be specified by the end-user, such as and without limitation via an explicit selection. The desired media encompass a video file 1812. For example and without limitation, an end-user may visit a website at which he clicks on a thumbnail image of a frame of video file 1812. This action of clicking may constitute an explicit selection. In any case, the information about the desired media may include a URL or other resource location that is associated with or known to the XML server 1818.

In an alternate embodiment, the JavaScript 1804 may be absent. In this case, the process and the information about the desired media may be embedded in the Flash player SWF 1802. The Flash player SWF 1802 may be dynamically updated when the Flash player 1814 is activated. In all, the alternate embodiment may provide a JavaScript-free embed that lends itself to easily generating and/or or grabbing information from a server. Moreover, the alternate embodiment may allow for RSS media enclosures and yet still provide an implementation of the present invention. Many other such embodiments will be appreciated and all such embodiments are within the scope of the present disclosure.

Referring again to FIG. 18, once the Flash player 1814 has been activated, it may utilize the information about desired media to communicate with the XML server 1818. This communication may comprise the transmission of a request from the Flash player 1814 to the XML server 1818, wherein the request provides or is associated with a source IP address of the request (i.e. an IP address of the Flash player), the desired media, and so forth. Based upon and in response to the request, the XML server 1818 may transmit a response to the Flash player 1814, wherein the response may encompass an XML file. In embodiments, the XML server 1818 may use the shared secret to encrypt the XML file prior to transmitting it.

Referring now to FIG. 20, the XML file 2000 may encompass a URL reference to a video file 2002 (wherein the video file may comprise the media 102), a plurality of URL references to SWF-formatted advertisements 2004 (wherein the advertisements may comprise the ads 112), and a plurality of tracking URLs 308 (wherein the tracking URLs 2008 may encompass or be associated with the tags 104A, 104B). The URL reference to a video file 2002 may be associated with the media server 1810. Likewise, the URL references 2004 to the SWF-formatted advertisements 2004 may be associated with the media server 1810. The tracking URLs 2008 may be associated with the status server 1820. The URLs 2002, 2004, and 2008 may encode or be associated with a time-related value, such as and without limitation a time to live, a timeout, a valid time period, or the like. In embodiments, the time-related value may depend upon a configuration parameter, which may be set and/or stored at one or more of the servers 1810, 1818, 1820, 1822. In any case, the URLs 2002, 2004, and 2008 may encode or be associated with the source IP address.

The URLs 2002, 2004, and 2008 may contain an element that is encoded, such as and without limitation using a cryptographic method. The element may contain or be associated with the source IP address and/or the time-related value. The encoding may be directed at preventing the end-user and/or a third party from interpreting and/or modifying the source IP address and/or the time-related value. For example and without limitation, the cryptographic method may include the use of public-key cryptography and the encoded element of the URLs 2002, 2004, and 2008 may be encrypted.

Continuing now with the description of FIG. 18, the Flash player 1814 may receive the XML file 2000. Then, the Flash player 1814 may issue a request to the media server 1810 in accordance with the URLs 2002 and/or 2004. The media server 1810 may receive the request, which may comprise all or part of the URLs 2002 and/or 2004. The media server 1810 may decode any and all parts of the URLs 2002 and/or 2004 that it receives via the request. For example and without limitation, the media server 1810 may decrypt the parts. In any case, the media server 1810 may check to determine that the parts indicate that it is permissible to transmit a video file 1812, at this time, to the Flash player 1814 and/or web browser 1820 located at the source IP address. A positive indication may be associated with the IP address of the Flash player 1814 matching the source IP address that is encoded in the URLs 2002 and/or 2004, the time-related value that is encoded in the URLs 2002 and/or 2004 being consistent with the present time, and so on. The video file 1812 may encompass the content file and/or one of the advertising files. Regardless, if the result of this check is affirmative, the media server 1810 may transmit the video file 1812, to the flash player 1814 and/or web browser 1820, as a response to the request. However, if the result of the check is negative, the media server 1810 may respond with an error code, a video file 1812 that encodes an error message or a “try again” message, and so on.

Upon or after receiving the video file 1812, the Flash player 1814 may render the video file 1812. At one or more points in time that are associated with rendering the video file 1812, the Flash player 1814 may contact a resource that is identified by the tracking URL 2008. This resource may be the status server 1820. The status server 1820 may receive and decode all or part of the URL 2008. For example and without limitation, decoding may encompass decrypting. In any case, the status server 120 may check to determine that the parts of the URL 2008 that it receives indicate a valid playback event by the Flash player at the source IP address. The playback event may, without limitation, include a start of playback, end of playback, point in playback, and the like. The validity of the playback event may be associated with whether the IP address of the Flash player 1814 matches the source IP address that is encoded in the URL 2008, whether the time-related value that is encoded in the URL 2008 is consistent with the present time, and so on. The status server 1820 may record the result of this check, whether affirmative or negative. An aggregate of such results may be used to measure the playback status of one or more video files 1812. Alternatively or additionally, the aggregate may be used to calculate statistics related to the playback status of one or more video files 1812.

It will be appreciated that providing the video file 1812 only after verifying the source IP address of the Flash player 1812 and/or the time-related value limits the distribution of the video file 112 from the media server 1810. It will also be appreciated that the encoded portions of the URLs 2002, 2004, and 2008 may be automatically generated, may require automatic interpretation, and may be tamper-resistant. It will further be appreciated that the encoded portions of the URLs 2002, 2004, and 2008 may be encrypted, that a secret may be required to encrypt and decrypt the encoded portions, and that it may be possible to strictly control the distribution of the secret that is required to decrypt the encoded portions. Thus, it will be appreciated that only servers 1812, 1818, 1820, 1822 that are in possession of the secret may generate and/or be responsive to the URLs 302, 304, and 308. It follows that third-party servers or unauthorized servers, which do not possess the secret, will not be able to properly generate or respond to the URLs 2002, 2004, and 2008. Moreover, the servers 2812, 1818, 1820, 1822 may readily recognize as invalid a URL 2002, 2004, 2008 that contains an invalid time-related value (i.e. that has timed out), that is generated by a third-party server or unauthorized server, that is transmitted from an address other than the source IP address, and so on. In all, the systems and methods described herein control the process by which the Flash player 1814 may request, receive, and report on the playback of a video file 1812. This provides the operator of the servers 1812, 1818, 1820, 1822 with a level of control over the playback and measurement of playback of video files 1812 that would not otherwise be possible.

While it is conceivable that an actor may use a client computer to legitimately receive a video file 1812 and then illegitimately record the video file 1812 and redistribute it without association to the URLs 2002, 2004, and/or 2008, such acts are likely intentional and in violation of copyright law. While the systems and methods of the present invention may or may not be able to detect such illicit activity, such an actor may be readily classified by as a copyright infringer to whom legal remedies will apply. On the other hand, storing and/or redistributing the XML file 2000 and/or its URLs 2002, 2004, 2008—acts that very well may be an artifact of innocent search technologies and information delivery technologies—may result in invalid requests to the media server 1810 and/or invalid playback status reports to the status server 1820. Such requests may be readily detected and handled by the systems and methods of the present invention, which may gently ignore the invalid requests, provide end-users with pointers to a source of valid URLs, log the invalid requests, and so on. Furthermore, because the generation of URLs 2002, 2004, and/or 2008 is dynamic and a function of the source IP address, it becomes less likely that an innocent, automatic system will redistribute a video file 1812 that was originally intended for one source IP address to another.

An aspect of the present invention relates to a video distribution system where a user can post media (e.g. amateur, or professional videos) so that that can be dynamically associated with advertisements and interactions with the media/advertisement can be tracked. The tracking information may be used to share ad revenue amongst a set of video distribution participants (e.g. the media owner, the tracker, a first level distributor, another level distributor, etc.). In embodiments, a file, script, or the like may be sent to a client computing facility upon request of a media segment. For example, a user/viewer who wants to watch a video that has been posted may click on a thumbnail representation of the video, or other such reference, and once this request is received, a file or script (e.g. an XML script as described herein) may be transmitted to the user/viewer's client. The file may have embedded scripts or commands that provide all of the necessary information. The file may include information referencing the media/video itself, a related advertisement, and tracking information such that interactions with the media and/or advertisement can be tracked. In embodiments, there may be other events that are undertaken in response to the viewer's request to watch the video. For example, upon receipt of the viewer's request to view a video, the system may select an advertisement (e.g. as described herein elsewhere, such as through a bidding process, selection from an inventory, or selection from a prioritized inventory). Once the advertisement is selected, a reference to the advertisement may be generated for inclusion in the file that is sent to the viewer in response to his request for the video. In embodiments, this is a pre-processing step in advance of generating the file. In this embodiment, the file is dynamically generated in response to the viewer's request. In other embodiments, the file may already exist and be sent directly in response to the viewer's request. Another process that may be occurring is a server side tracking process. Once the file containing all of the necessary information is communicated to the viewer in response to his request, the server may await an indication of certain events pertaining to the media/video or the advertisement before performing an advertisement revenue sharing algorithm. For example, a reconciliation system may await an indication from the viewer's client that the media or advertisement has been interacted with or interacted with in a certain way (e.g. as described herein elsewhere, such as viewing the advertisement all the way through or substantially all the way through; or clicking on an advertisement, etc.). The indication that the system waits for may be based on a script included in the file that was communicated to the viewer's client. Once the indication is received, the reconciliation system may then divide the advertisement revenue amongst the participants in this particular transaction (e.g. as described elsewhere herein, such as by apportioning a piece of the advertisement revenue (or other revenue) to the media owner, the tracker, a first level distributor, another level distributor, etc.).

In embodiments, the systems and methods described herein may involve providing a web-based video posting service where a video owner can post a video to be dynamically associated with advertisements and distributed to a viewer's client at a viewer's request. The systems and methods may also involve providing a video playback frame, or other such feature, wherein the video playback frame is part of a computer generated video player (e.g. for example the frame or area in which the video is displayed). The systems and methods may also involve communicating the video to the client such that it can be played within the video playback frame (e.g. the video may be transmitted through a Flash or other format).

The systems and methods may involve selecting an advertisement to be dynamically associated with the video. In embodiments, the selection is based at least in part on an auction, a popularity of the video, a subject of the video, metadata associated with the video, a viewer parameter or other factor or parameter. The selection may be made in response to the viewer's request. It may be made in real time following the viewer's request. It may be made following the viewer's request and before the video playback can be completed or at some other point in time. The methods and systems may involve communicating the advertisement to the client such that it can be played within the video playback frame (e.g. as a video within the same playback frame or area as the video was played).

The methods and systems may involve providing instructions relating to the display of the video, display of the advertisement, advertising display parameters, tracking the interactions with the video and/or advertisement, user interaction instructions and the like. In embodiments, the instructions are formed dynamically in response to a viewer's request to see a video. For example, the media platform 100 may receive a request to stream media to a viewer and the platform may respond by selecting an advertisement (e.g. as described herein elsewhere) and then generate a file that includes instructions relating to accessing the video (e.g. a url reference to the video), instructions for accessing the advertisement (e.g. a url reference to the advertisement), tracking instructions (e.g. how and when tracking information should be communicated back to the media platform 100 from the viewer's client), interaction instructions (e.g. instructions relating to the reporting of user interactions with the video and/or the advertisement), or other instructions. This file, or other data structure, may then be communicated to the viewer such that the viewer's client will following the instructions in association with the video. In other embodiments, the instructions may be prepackaged. The instructions may be sent to the viewer in response to the viewer's request to view or otherwise interact with a video, or other media. ed to the video prior to sending.

By way of example, a set of instructions that may be included in an xml instruction file are presented below.

<?xml version=“1.0”?>
<results>

<collection>

<pack>

<poster src=“http://frame.revver.com/frame/x/299431.jpg”/>
<ad height=“360”

src=“http://flash.revver.com/download/ad/2196/1307/299431/42/f5ffef1366924703713d34f7327
67fe1/655cb3a4c812891a025c20eec93bb26efd8f7caf/ad.flv” timeout=“30000” type=“flv”
width=“480”>

<track

url=“http://flashtrack.revver.com/play/ad/2196/1307/299431/42/00000000000000000000000000
00000000000000/f5ffef1366924703713d34f732767fe1/655cb3a4c812891a025c20eec93bb26efd
8f7caf”/>

<track

url=“http://ad.doubleclick.net/ad/N3493.Revver/B2402397;sz=1x1;ord=[timestamp];ord=f5ffef1
366924703713d34f732767fe1”/>

</ad>
<video

src=“http://flash.revver.com/download/movie/299431/f5ffef1366924703713d34f732767fe1/f69a
fe4e7a348261c552e46ee3fc7fe74602d6b2/movie.flv”
track_play=“http://flashtrack.revver.com/play/movie/299431/f5ffef1366924703713d34f732767f
e1/f69afe4e7a348261c552e46ee3fc7fe74602d6b2”>

<author>demand</author>
<title>Bush is a Lame Ducky-Ducky</title>

</video>
<ad height=“360”

src=“http://flash.revver.com/download/ad/2052/1091/299431/42/f5ffef1366924703713d34f7327
67fe1/9958ae8028ded9da5b6d6e0cff7b08d8d5dc41d7/ad.swf” timeout=“3000”
track_click=“http://flashtrack.revver.com/click/ad/2052/1091/299431/42/f5ffef1366924703713d
34f732767fe1/9958ae8028ded9da5b6d6e0cff7b08d8d5dc41d7” type=“swf” width=“480”>

<track

url=“http://flashtrack.revver.com/play/ad/2052/1091/299431/42/00000000000000000000000000
00000000000000/f5ffef1366924703713d34f732767fe1/9958ae8028ded9da5b6d6e0cff7b08d8d5
dc41d7”/>

</ad>

</pack>

</collection>

</results>

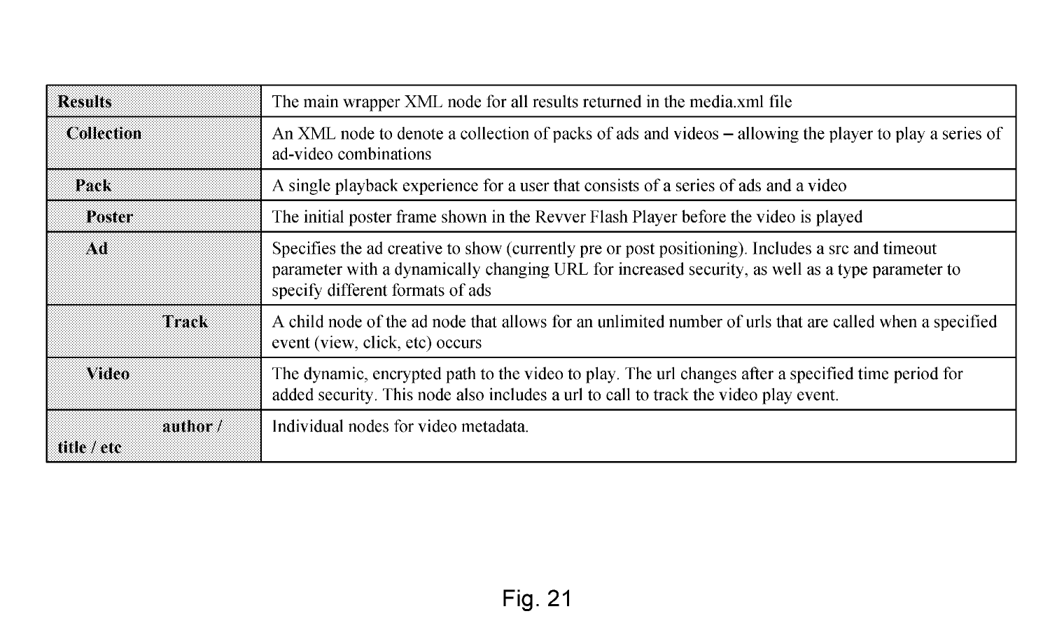

By way of example, a general structure of an instruction file is presented in FIG. 21.

The methods and systems may involve causing the client to interpret and execute the instructions in coordination with viewing the media. For example, the file may be transmitted to the client in response to a request to view media and the file may provide scripts that the client follows.

The methods and systems may involve tracking the fact that at least one of the video and the advertisement were played or otherwise interacted with. In embodiments, the tracking includes sending a report indication to a reconciliation server application, sending a report indication to a reconciliation server application from a client from which the viewer requested the video, tracking the fact that the video and the advertisement where communicated to be viewed by the viewer, sending periodic reports from the viewer's client, sending periodic reports from the viewer's play list, and the like.

The methods and systems may involve causing revenue, from an advertiser that requested the advertisement to be associated with the video (or other revenue), to be apportioned amongst a plurality of video distribution participants. The plurality of video distribution participants may include an owner of the video, a provider of the tracking information/reconciliation, and a distributor of the video. There may be several layers of distributors in the chain of distribution and the layers maybe treated differently with respect to the revenue apportionment.

The methods and systems may involve communicating the video from the viewer's client to a second client, wherein the instructions are sent with the video such that the instructions can be followed on the second client.

All of the elements of the media platform 100 and all of the elements of the systems and methods for providing media may be depicted throughout the figures with respect to logical boundaries between the elements. According to software or hardware engineering practices, the modules that are depicted may in fact be implemented as individual modules. However, the modules may also be implemented in a more monolithic fashion, with logical boundaries not so clearly defined in the source code, object code, hardware logic, or hardware modules that implement the modules. All such implementations are within the scope of the present invention.

It will be appreciated that the various steps identified and described above may be varied, and that the order of steps may be changed to suit particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

It will be appreciated that the above processes, and steps thereof, may be realized in hardware, software, or any combination of these suitable for a particular application. The hardware may include a general purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device that may be configured to process electronic signals. It will further be appreciated that the process may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across a camera system and/or a computer in a number of ways, or all of the functionality may be integrated into a dedicated, standalone image capture device or other hardware. All such permutations and combinations are intended to fall within the scope of the present disclosure.

It will also be appreciated that means for performing the steps associated with the processes described above may include any of the hardware and/or software described above. In another aspect, each process, including individual process steps described above and combinations thereof, may be embodied in computer executable code that, when executing on one or more computing devices, performs the steps thereof.

While the invention has been disclosed in connection with certain preferred embodiments, other embodiments will be recognized by those of ordinary skill in the art, and all such variations, modifications, and substitutions are intended to fall within the scope of this disclosure. Thus, the invention is to be understood in the broadest sense allowable by law.

All documents referenced herein are hereby incorporated by reference.

1. A method, comprising:
enabling content item generators to present content items for association of advertisements;
enabling an advertiser to request association of an advertisement with at least one of the presented content items; and
associating the content items with advertising, tracking, and user interaction instructions so that and upon a subsequent user interaction with the content advertising will be displayed and an action is automatically taken to facilitate payment of a share of revenue for the associated advertisement to an account of the content item generator.

2. A method according to claim 1, wherein the content item is video content.

3. A method according to claim 1, wherein the content item is audio content.

4. A method according to claim 1, wherein the content item is audiovisual content.

5. A method according to claim 1, wherein the content item is interactive content.

6. A method according to claim 1, wherein the content item is a webpage.

7. A method according to claim 1, wherein the content item is suitable for playing on the worldwide web.

8. A method according to claim 1, wherein a plurality of advertisements may be dynamically linked to a content item, thereby presenting different advertisements in the course of different user interactions with the content item.

9. A method according to claim 1, further comprising providing an interface whereby advertisers may bid for association of advertisements with content items.

10. A method according to claim 9, wherein the interface allows an advertiser to select a category of content item.

11. A method according to claim 9, wherein the bidding interface presents a price for associating with a content item and the price reflects the extent of past user interactions with the content item.

12. A method according to claim 1, wherein the subsequent user interaction is sending the content item to another user.

13. A method according to claim 1, wherein the subsequent user interaction is viewing a portion of the content item.

14. A method according to claim 1, wherein the subsequent user interaction is downloading the content item.

15. A method according to claim 1, wherein the subsequent user interaction is viewing a portion of the advertisement.

16. A method according to claim 1, wherein the subsequent user interaction is viewing all of the advertisement.

17. A method according to claim 1, wherein the subsequent user interaction is clicking on the advertisement.

18. A method according to claim 1, wherein the automatic action to facilitate payment of a share of revenue persists through a plurality of user interactions with the content item.

19. A method according to claim 1, wherein the automatic action to facilitate payment of a share of revenue persists through user interactions with the content item at a plurality of domains at which a user may interact with the content item.

20. A system, comprising:
a content item generator for presenting content items for association of advertisements;
a facility for accepting, from an advertiser, a request for association of an advertisement with at least one of the presented content items; and
a facility for tagging the content items so that upon a subsequent user interaction with a content item that has an associated advertisement, an action is automatically taken to facilitate payment of a share of revenue for the associated advertisement to an account of the content item generator.

21-76. (canceled)
